(19) United States
(12) Patent Application Publication
(10) Pub. No.: US 2020/0062877 A1
(43) Pub. Date: Feb. 27, 2020

(54) Curable and Solvent Soluble Formulations and Methods of Making and Using Therof

(71) Applicants: Ioana KNOPF, Melrose, MA (US); Paige OMURA, Boston, MA (US); POLY6 TECHNOLOGIES, INC., Boston, MA (US)

(72) Inventors: Ioana Knopf, Melrose, MA (US); Paige Omura, Boston, MA (US); Keith Hearon, Boston, MA (US); Anthony Tabet, Woburn, MA (US)

(21) Appl. No.: 16/488,071

(22) PCT Filed: Feb. 22, 2018
(86) PCT No.: PCT/US2018/019231

§ 371 Date: Aug. 22, 2019

Related U.S. Application Data
(60) Provisional application No. 62/462,208, filed on Feb. 22, 2017.
(60) Provisional application No. 62/468,826, filed on Mar. 8, 2017.
(60) Provisional application No. 62/469,172, filed on Mar. 9, 2017.
(60) Provisional application No. 62/539,922, filed on Aug. 1, 2017.

(51) Int. Cl. C08F 226/10; C08F 226/02; C08F 2/38; C08F 220/18; C08F 220/56; C08F 222/40

(52) U.S. Cl. CPC C08F 226/10; C08F 226/02; C08F 2/38; B33Y 10/00; C08F 220/56; C08F 222/40; C08F 220/18

(57) ABSTRACT

Curable formulations, cured formulations, and mixtures and composites thereof which are solvent and/or water soluble or solvent and/or water degradable are described, as well as methods of making and using the formulations, mixtures, and composites. Patterned structures formed from curable formulations, which are solvent soluble, are also described. Such curable formulations and the patterned structures formed therefrom can be used to manufacture articles or products.

### CROSS-REFERENCE TO RELATED APPLICATIONS

This application claims priority to U.S. Ser. No. 62/462,208, filed on Feb. 22, 2017, U.S. Ser. No. 62/468,826 filed Mar. 8, 2017, U.S. Ser. No. 62/469,172 filed Mar. 9, 2017, and U.S. Ser. No. 62/539,922 filed Aug. 1, 2017, which where permissible are incorporated by reference in their entirety.

### FIELD OF THE INVENTION

This invention is in the field of curable formulations suitable for use as thin films or coatings, as adhesion promoting surface modifiers, as corrosion resistant coatings and as patterns, molds, dies, etc. for use in investment casting and injection molding processes to form articles of manufacture

### BACKGROUND OF THE INVENTION

Current process materials engender production inefficiencies and limit engineering design capabilities for manufacturers. To overcome existing process inefficiencies and further engineering design capabilities, manufactures are increasingly adopting advanced manufacturing techniques. For certain manufacturing sectors, the integration of advanced manufacturing into long-established production processes can be challenging, and an unmet need currently exists for advanced manufacturing materials that exhibit material properties with increased suitability for use in established manufacturing processes. For established manufacturing processes such as investment casting and injection molding, a specific need exists for polymeric, composite and other materials that exhibit advanced processing capability, improved mechanical performance, unique stimuli-responsive behavior and process-compatible chemistries. Improved advanced manufacturing materials that are better suited for use in established manufacturing processes offer significant economic benefits for manufacturers from both process efficiency and engineering design capability standpoints.

Advanced manufacturing techniques such as additive manufacturing offer pathways to increased complexity and improved geometric resolution of components manufactured through traditional processes such as casting or injection molding. Advanced manufacturing materials used in traditional manufacturing processes can be used to form cores, molds, dies or other patterns, which can be laborious to produce by traditional processes and that may require feature sizes and shapes currently not achievable using existing manufacturing materials in industries including biotechnology, aerospace and automotive manufacturing.

Therefore, it is an object of the present invention to provide curable formulations with advanced processing capabilities, increased material performance, unique stimuli-responsive behavior and process-compatible chemistries.

It is a further object to provide new formulations, methods of making, manufacturing methods thereof and articles of manufacture made from such formulations having improved performance, tunable properties, processing, cost, and environmental benefits.

It is also an object of the present invention to provide curable formulations or mixtures thereof which are useful in manufacturing processes to afford articles of manufacture, such as medical devices.

It is yet another object of the present invention to provide curable formulations or mixtures which are used to form casts or molds which can be used to manufacture articles, such as aerospace and automotive engine components.

### SUMMARY OF THE INVENTION

Curable formulations which possess tunable chemical functionalities and physical properties enable the syntheses of new materials, composites, and articles of manufacture. Particular embodiments include: (1) Curable formulations which are formed from monomers, oligomers, and which can be cured, formed into blends or composites containing fillers and/or additives; (2) Methods of making such curable formulations, cured formulations thereof, and composites thereof; (3) Methods of using and manufacturing articles formed from such curable formulations, cured formulations thereof, and composites thereof; (4) Articles of manufacture formed from such compounds, materials, composites, and compositions thereof and (5) Additional formulations that, when added, blended with or otherwise combined with the curable formulations, the processes, the methods, the articles of manufacture or various combinations of these materials, enable unique, specially designed or otherwise desired chemical or material behavior to occur.

The precursors of the curable formulations can be prepared, for example, from mercapto, alkene, (meth)acrylate, organic salts, organometallic salts, anhydride, alkyne, amine, and epoxy functionalized monomeric and oligomeric constituents, or combinations thereof. Curable formulations can be prepared by reactions between constituents capable of underging stoichiometric reactions by varying precursor stoichiometric ratios from about 0.001:1.00 to about 1.00:0.001. In some embodiments, curable formulations formed from precursors have a more preferred stoichiometric variation ranging from about 0.05:0.95 to about 0.95:0.05. In some embodiments, a further preferred stoichiometric ratio for precursors is about 0.20:0.80 to about 0.80:0.20. In additional embodiments, a further preferred stoichiometric ratio for precursors is about 0.35:0.65 to about 0.65:0.35.

Curable formulations of monomeric and/or oligomeric precursors are formed via chemistries that enable desirable material performance and tunable physical and thermomechanical properties to be obtained. Desirable material performance and tunable physical and thermomechanical properties include, but are not limited to, high toughness, optical clarity, high tensile strength, good solvent resistance for certain formulations, tunable solvent dissolution or degradation times for certain formulations, good thermal resistance, tunable modulus, viscosity, tunable glass transition temperature, tunable cure time, and tunable surface adhesion. Materials, composites, and other compositions thereof can be formed from the curable formulations. Methods for making the curable formulations, cured formulations thereof, and other composites thereof are also described. In some embodiments, the methods of making are low waste methods which generally do not require any or any significant purification of the formulations, composites, or of reaction products therein. The curable or cured formulations, composites, and other compositions thereof formed from the precursors and as shown in the examples generally proceed in additive “one pot” steps. The curable formulations can be used in methods of manufacturing such as thin-film deposition, 3-D printing, and coating of substrates. Methods that are used to manufacture materials from the curable formulations may be influenced by material processing capability. Processing capability refers to a material's ability to be successfully and efficiently subjected to various methods of manufacture, such as sacrificial molding applications for investment casting and injection molding processes. For example, the investment casting process is relied upon to supply components including metal components at large volumes in many industry verticals with a high degree of reproducibility. In most casting processes, the initial phase requires the creation of a pattern or mold made from a polymeric, wax, or other material. In some select investment casting processes, a ceramic core is created before the wax pattern and the pattern is injected around the ceramic core. Once the pattern is fully fabricated, it is dipped into one or more slurries, often ceramic, repeatedly until a desired exterior wall thickness is reached. Subsequently, the polymeric or wax mold is removed from the ceramic coating to form a hollow shell that contains a negative cavity of the initial pattern or mold. Flowable, curable or molten material, including curable polymer resins, waxes, molten metals or other materials, are poured into this negative cavity and allowed to harden. Once hardened, the exterior shell, including ceramic shells, are removed, and a replica of the initial mold, core or die is extracted. After extraction, additional machining and cleaning to conducted to produce the final part can be used.

In another example, polymer, ceramic, metal or composite injection molding uses a mold, core, or die to fabricate a polymer or composite component. In certain injection molding processes, curable formulations are injected into and/or around a mold or die while in a flowable or molten state, sometimes at elevated temperatures and/or pressures, to form patterned geometries. In certain processes, sometimes called “reaction injection molding” processes, curable formulations after injection into and/or around a mold, core or die may harden to form solid articles of manufacture after undergoing chemical curing reactions. In other processes, more generally referred to as “injection molding,” molten, flowable material, including, but not limited to, polymeric, metal, ceramic or composite material, is injected into and/or around a mold, core or die, often at elevated temperature and pressure, and these injected flowable materials form solid articles of manufacture after injection and subsequent cooling below temperatures at which material flow is favorable. Injection molding processes are desirable for use in certain high throughput manufacturing processes and/or in certain low-volume, customized production processes to produce articles of manufacture such as specialty tooling components. Injection molding processes exhibit certain limitations in achievable geometric complexity, which includes any shape that, for a conventional split mold halves (or multiple pieces) tool, a parting line for the mold, or an acceptable pull plane cannot be defined or does not exist that would enable the mold to come apart without damaging or outright breaking the mold.

Thus, achieving the desired and requisite complexity of component designs within present-day investment casting processes and injection molding processes requires breaking molds, damaging finished parts or the inclusion of other undesirable steps that may be alleviated with the advent of new materials for advanced manufacturing processes. For aerospace engine applications, these limitations of current materials used in investment casting and injection molding processes are overcome, enabling the manufacture of articles with otherwise unachievable geometric designs and/or features, including, but not limited to, single crystal nickel and/or titanium-based superalloy gas turbine airfoils, compressor airfoils, turbine airfoils, high-pressure compressor blades, low-pressure compressor blades, high-pressure turbine blades, a low-pressure turbine blades, turbine vane segments, turbine vanes, nozzle guide vanes, turbine shrouds, turbine accessory gearbox components, jet engine components, molds, or casts and ceramic cores, dies and molds used to make single crystal nickel and/or titanium-based superalloy gas turbine airfoils, compressor airfoils, turbine airfoils, high-pressure compressor blades, low-pressure compressor blades, high-pressure turbine blades, a low-pressure turbine blades, turbine vane segments, turbine vanes, nozzle guide vanes, turbine shrouds, turbine accessory gearbox components, jet engine components, molds, and casts that cannot be manufactured with current materials and/or current processes.

The curable formulations also permit for their use in methods of manufacture to form articles of manufacture, including, but not limited to, microfluidic chips and microfluidics arrays, such as lab and organs on a chip. The formulations enable the manufacture of articles that include medical devices with unique or new geometric configurations, including geometries suitable for use in desirable biological or chemical experiments, including those used for cell culture, tissue engineering, drug screening, disease detection, proteomics, chemical synthesis, and other biomedical applications. The formulations and methods of making and use can achieve increased manufacturing efficiency and/or achievable geometric complexity and geometric resolution for the fabrication of hydrogels with internal through running vasculature, flow channels, porosity or other internal features is. Additionally, the formulations are suitable for 3D bioprinting, an advanced manufacturing technique for the development of organs and tissue constructs for tissue engineering, stem cell biology, disease modeling, cell culture, and other applications. To date, printed cell-laden structures produced using 3D bioprinting have generally been less than 1-2 cm thick and have exhibited limited suitable times for cell culture processes, including cell culture hydrogels, scaffolds, extracellular matrix or vascular walls for use in tissue regeneration, wound healing and/or drug toxicity, drug discovery or other drug screening processes. Such medical and/or biological articles of manufacture exhibit limitations in geometric design capabilities and achievable feature sizes and feature shapes that are difficult to achieve or not yet achievable using traditional materials and/or traditional manufacture techniques. Desirable attributes of sacrificial objects formed from curable compositions include sufficient mechanical and thermal stability, thermomechanical performance to withstand pressure, temperature, impact, and fatigue conditions of injection molding, investment casting overmolding processes, and other fabrication processes. Material properties such as strength, toughness and temperature dependent storage modulus influence the complexity and intricacy of sacrificial objects, including such objects that can be fabricated using additive manufacturing and/or used in investment casting, injection molding overmolding or other manufacturing processes. For example, toughness, which refers to the energy threshold to which a material can be subjected before breaking, is indicative of application-specific geometric limitations into which a material can be formed. For investment casting, injection molding or other processes that use sacrificial patterns or polymer molds, as patterned polymer geometric features become smaller and more complex, higher material toughness enables more complex sacrificial objects to be fabricated, as these objects can survive more strenuous injection molding and investment casting processes. The curable formulations form materials suitable for processing into sacrificial patterns, molds and dies via additive and other advanced manufacturing processes. These objects exhibit mechanical strength, toughness, moduli, and thermal stability suitable for use in injection molding, investment casting, overmolding and other manufacturing processes, which may include manufacturing process temperatures of 50° C., 75° C., 100° C., 125° C. or higher, pressures of 150 psi, 1500 psi, 15,000 psi, 30,000 psi, 43,500 psi or higher and injection media with viscosities ranging from 1 cP, 20 cP, 200 cP, 1000 cP, 10,000 cP, 30,000 cP or higher, including injection temperatures, pressures and viscosities of flowable ceramics that include silica and alumina-based compositions.

Desirable attributes of sacrificial objects formed from curable compositions include stimuli-responsive physical properties suitable for use in investment casting, injection molding, overmolding, selective masking and/or patterning and other manufacturing processes. In certain embodiments, curable compositions form materials processable into desired geometries suitable for use as sacrificial patterns, molds, dies, cores or other objects. Sacrificial objects can be removed from surrounding environments by techniques that include heat removal using temperatures of 200, 250, 300, 400, 500 C or greater, chemical processes that include exposure to acids, bases, corrosives or other chemically reactive environments, and/or solvent dissolution processes, that include subjection to solvents including organic solvents, supercritical fluids, water, or other solvents. The physical behavior of a sacrificial material as it is removed, whether in a burnout, chemical, solvent-based or other process, determines a material's suitability for use in such sacrificial processes. Stress, generated either by differential thermal expansion of a sacrificial object during heat removal, or by volvume change of a (swollen) sacrificial material vs the remaining material which may not absorb solvent, breaks or cracks the remaining geometry as soon as the so-call modulus of rupture (“MOR”) is surpassed. This MOR is especially low with green ceramics and above-cited stresses readily exceed the MOR of green ceramics, leading to molded part breakage. In certain embodiments, curable formulations can be manufactured into sacrificial objects that exhibit solvent soluble behavior suitable for use in investment casting, injection molding, or other manufacturing processes, in which sacrificial objects exhibit solvent dissolution with limited, minimal or extremely low swelling and consequently exhibit limited, minimal or extremely low stresses on surrounding environments during dissolution. These curable formulations may also exhibit mechanical integrity and toughness during portions of dissolution processes in which surface erosion behavior is observed. The formulations and methods of use thereof can improve upon other transitory molding materials removable by solubilization that are limited by: 1.) lack of good solvents that can remove patterns, molds or dies by simple dissolution, rather than chemical reactivity; 2.) Inability to easily dispose of, manage, re-use or recycle large volumes of spent dissolution solvent/liquor; 3.) Hazardous reagents present in reactive dissolution that require expensive/costly process vessels for dissolution, ventilation, and worker safety; 4.) Flammability and VOC emissions that may not comply with local codes or may require electrically-classified process environments, etc; 5.) Reagents or residues that are incompatible with the material being molded, certain incompatibilities which may lead to undesired phase behaviors, doping, reduction in glass viscosity, loss of dimensional tolerances, etc.

The curable formulations are suitable for use in stereolithographic (SLA), digital light projection (DLP), inkjet printing, direct write, and other additive manufacturing processes, including additive manufacturing processes in which ultraviolet or visible light is projected using a layer by layer process in which photopolymerization is selectively employed to form articles of manufacture of desired geometric patterns and after each projected layer is formed, each hardend layer is moved from the position in which it was hardened in a controlled or desired manner to allow for an additional layer to be hardened after light exposure, such that each hardened layer forms and adheres in a suiable manner to the previous layer formed. The curable formulations may be designed for use in SLA/DLP 3D printing (3DP) hardware/software/materials systems. In one embodiment, manufacturing systems integration is achieved for the curable formulations, for the SLA/DLP 3DP hardware used to manufacture these materials and for the software commands used to control SLA/DLP printing hardware. The curable formulations are successfully utilized in SLA/DLP manufacturing processes to form patterns or articles of manufacture of desired geometric configurations, surface features and mechanical attributes, and these successful manufacturing processes are controlled by engineered systems integration parameters for materials/hardware/software.

Curable formulations of monomeric and/or oligomeric precursors are formed via chemistries described below that enable desirable material performance and tunable physical and thermomechanical properties to be obtained. Desirable material performance and tunable physical and thermomechanical properties include high toughness (>0.5 MJ/m³ preferred, >2.5 MJ/m³ more preferred, >7.5 MJ/m³ further preferred, >12.5 MJ/M³ additionally preferred), optical clarity, high tensile strength (>5.0 MPa preferred, >10.0 MPa additionally preferred, >15.0 MPa additionally preferred, >20.0 MPa further preferred), good solvent or chemical resistance for certain compositions (>24 h in organic solvents or corrosive environments preferred, >1 week more preferred, 2 weeks further preferred), low swelling dissolution or degradation behavior in solvents times for certain formulations, tunable modulus, viscosity and glass transition temperatures (between about −50° C. and about 400° C.), tunable crystalline melt temperatures (between about −50° C. and about 400° C.), tunable cure time, and tunable surface adhesion. Materials, composites, and other compositions thereof can be formed from the curable formulations.

The curable formulations can be prepared using one-pot additive processes in which monomeric and/or oligomeric precursors and other reagents can be made to undergo chemical reactions prior to curing wherein new monomeric, oligomeric or polymeric precursors are formed that are suitable for forming materials with desirable stimuli-responsive, physical, thermomechanical or other performance. These precursors may contain one or more reactive functional groups, where the one or more reactive functional groups can vary from n=1 to n=1000, or greater, depending on the monomeric and/or oligomeric precursors. The curable formulations formed from monomeric and/or oligomeric precursors can be tuned, for example, by varying the degree of functionalization with one or more reactive functional groups used to prepare the precursors and formulations thereof. In some embodiments, the properties of the precursors can be tuned via the inclusion of one or more moieties, such as cyclic aliphatic linkages/linker groups for toughness, rigidity, UV resistance and thermal resistance; sterically hindered moieties and/or substituents, which can inhibit/control macromolecular alignment to afford amorphous materials, composites, and other compositions thereof upon polymerization and which can afford high optical clarity. In certain embodiments, the precursors of the formulation or mixture include moieties and/or substituents that can form or contain linkages, such as urethane, amide, thiourethane and dithiourethane groups which allow for inter-chain hydrogen bonding and can be used to impart increased toughness and rigidity. In yet other embodiments, the selective incorporation of ester, beta-aminoester, anhydride, carbonate, silyl ether linkages, ionic linkages, including various organometallic and organic (meth)acrylate and (meth)acrylamide salts, and various other linker groups in the precursors can be used to control solvent degradable, solvent soluble or other desired physical, thermal, thermomechanical or stimuli-responsive behavior, which can also be tuned by incorporating pendant hydrophilic or hydrophobic groups into material compositions.

The curable formulations may be solvent soluble or solvent degradable formulations and include solvent soluble or degradable polymers cured using charge transfer free radical polymerization and/or charge transfer/chain growth hybrid free radical polymerization and/or methods of polymerization to form alternating copolymers for which exemplary curable constituents can include: (a) electron-poor and (b) electron rich co-monomers and combinations thereof, optionally adding (c) (meth)acrylated co-monomers and optionally adding constituents such as photoinitiators (listed under heading A. below), light absorbing additives (listed under heading B. below), free radical inhibitors (listed under heading C. below), thermal free-radical initiators or amine catalysts (listed under heading D. below), fillers (listed under heading E. below), capping and/or chain transfer agents (listed under heading F. below), plasticizers (listed under heading G. below), catalysts/accelerators/additives (listed under heading H. below) and/or modifiers (listed under heading I. below).

The curable formulations may be solvent soluble or solvent degradable polymers which include polymers containing ionic linkages cured using radical chain growth polymerization, including the various water soluble or water degradable polymers disclosed herein, for which exemplary constituents include (d) combinations of ionic/salt containing monomers/crosslinkers, (e) co-monomers that form water soluble polymers upon polymerization, and optionally adding constituents such as photoinitiators (listed under heading A. below), light absorbing additives (listed under heading B. below), free radical inhibitors (listed under heading C. below), thermal free-radical initiators or amine catalysts (listed under heading D. below), fillers (listed under heading E. below), capping and/or chain transfer agents (listed under heading F. below), plasticizers (listed under heading G. below), catalysts/accelerators/additives (listed under heading H. below) and/or modifiers (listed under heading I. below). The curable formulations may be solvent soluble or degradable formulations and can be formed from thiol-ene/anhydride hybrid network poylmers comprised of (f) alkene or (g) polythiol co-monomer combinations with internal solvent degradable linkages, including water-degradable anhydride linkages and optionally adding constituents such as photoinitiators (listed under heading A. below), light absorbing additives (listed under heading B. below), free radical inhibitors (listed under heading C. below), thermal free-radical initiators or amine catalysts (listed under heading D. below), fillers (listed under heading E. below), capping and/or chain transfer agents (listed under heading F. below), plasticizers (listed under heading G. below), catalysts/accelerators/additives (listed under heading H. below) and/or modifiers (listed under heading I. below).

The precursors of the curable formulations can be prepared, for example, from mercapto, alkene, (meth)acrylate, organic salts, organometallic salts, anhydride, alkyne, amine, and epoxy functionalized monomeric and oligomeric constituents, or combinations thereof. Curable formulations can be prepared by reactions between constituents capable of underging stoichiometric reactions by varying precursor stoichiometric ratios from about 0.001:1.00 to about 1.00:0.001. In some embodiments, curable formulations formed from precursors have a more preferred stoichiometric variation ranging from about 0.05:0.95 to about 0.95:0.05. In some embodiments, a further preferred stoichiometric ratio for precursors is about 0.20:0.80 to about 0.80:0.20. In additional embodiments, a further preferred stoichiometric ratio for precursors is about 0.35:0.65 to about 0.65:0.35.

The curable formulations formed of monomeric and/or oligomeric precursors can be cured by applying ultraviolent (UV) light, electron beam irradiation, heat, acid/base or metal catalyzed curing processes, adding ionic species that result in crosslinking, including the addition of various salts, or combinations thereof. The cured formulations are then subjected to performance characterization analysis and can be utilized, for example, in known additive manufacturing processes, such as stereolithography additive applications, and for coatings applications.

Varying quantities of initiators or catalysts can be added to the formulations to catalyze chemical reactions between the monomeric and/or oligomeric precursors, prior to or during the application of an optional aging process in which heat, electromagnetic irradiation, pressure or other process parameters can be controlled to achieve desired reactions in precursor blends. Exemplary precursor reactions include, but are not limited to, free radical-initiated thiol-ene, base-catalyzed Michael Addition and base-catalyzed thiol-epoxy addition reactions. For curable formulations designed to be UV curable, a photoinitiator can also be added. Such curable formulations may form a two-part or higher-part curable system that afford block copolymers, semi-interpenetrating networks, and/or interpenetrating networks. These multi-part curable systems can contain come UV curable constituents and at least some thermally or catalytically curable constituents, and UV curing can occur at the same time or at a different time than the thermal/catalytic/other curable constituents.

In some embodiments, curable formulations, mixtures thereof, and composites thereof (which contain modifiers and/or fillers) are suitable for use in a variety of industrial process environments, including various 3D printing processes. Methods of printing curable formulations, such as 3D printing, are described below. In such embodiments, curable formulations may further comprise an initiator or catalyst that can be triggered by an external stimulus (i.e., light or heating) to induce curing. 3D printing processes may include stereolithographic printing (SLA) digital light projection (DLP) inkjet printing or a direct write processes. In inkjet deposition 3-D printing embodiments, curable formulations may be jetted as additively manufactured binders into one or more powders such as sand, silica, alumina or polymer powders, hydroxyapatite powders, or tungsten powders which then harden into powder-rich composite materials. Hardening time can be tuned by varying the amount of initiator or catalyst concentration in the formulation. In certain instances, it is possible to burn out one or more of cured polymer binders and firing the resulting powder-rich composites to fuse particles and form solid materials. Composite materials with geometric configurations patterned by inkjet deposition can also be cured around powder particles and then removed from the powder-containing glass trays. These patterned composites can then be built upon by further printing (for 3-D inkjet additive manufacturing process) if desired and/or subsequently utilized in a wide number of processing techniques.

Methods of preparing articles or products formed from patterned structures formed from curable formulations are described below. Such articles or products can include, but are not limited to, microfluidic device, a bioprinted device, a medical device, a drug eluting device, a reactor, a bioreactor, a valve, a microvalve, a pump, a micropump, a gas turbine airfoil, a compressor airfoil, a turbine airfoil, a high-pressure compressor blade, a low-pressure compressor blade, a high-pressure turbine blade, a low-pressure turbine blade, a turbine vane segment, a turbine vane, a nozzle guide vane, a turbine shroud, a turbine accessory gearbox component, a jet engine component, a heat exchanger, mold, or cast.

Sacrificial or non-sacrificial patterned structures formed from curable formulations are suitable for manufacturing ceramic, polymeric, metal or composite products or articles of manufacture for use in applications that include, but are not limited to, (a) microfluidics and 3D bioprinting; (b) medical and drug eluting device manufacturing; (c) investment casting processes; and (d) non-sacrificial molding processes.

The curable formulations are suitable for the manufacturing of sacrificial coatings, masking layers, coatings for selective removal, adhesion promoting layers between a substrate and outer coating, and corrosion resitant coatings. The curable formulations are suitable for use in coatings application processes that include spraying, roll to roll coating, photopolymeriztion-cured coatings processes and solvent-based coatings application processes, including coatings on the inner surfaces of flow channels, including polymeric, metal, composite and ceramics flow channels, including pipes used for crude oil transport.

### DETAILED DESCRIPTION OF THE INVENTION

### I. Definitions

As used herein, the term “analog” refers to a chemical compound with a structure similar to that of another (reference compound) but differing from it in respect to a particular component, functional group, atom, etc. As used herein, the term “derivative” refers to compounds which are formed from a parent compound by chemical reaction(s). These differences in suitable analogues and derivatives include, but are not limited to, replacement of one or more functional groups on the ring with one or more different functional groups or reacting one or more functional groups on the ring to introduce one or more substituents.

“Aryl”, as used herein, refers to 5-, 6- and 7-membered aromatic, heterocyclic, fused aromatic, fused heterocyclic, biaromatic, or biheterocyclic ring system, optionally substituted by halogens, alkyl-, alkenyl-, and alkynyl-groups. Broadly defined, “Ar”, as used herein, includes 5-, 6- and 7-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with such substituents as, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “Ar” also includes polycyclic ring systems having two or more cyclic rings in which two or more carbons are common to two adjoining rings (the rings are “fused rings”) where at least one of the rings is aromatic, e.g., the other cyclic rings can be cycloalkyls, cycloalkenyls, cycloalkynyls, aryls and/or heterocycles. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl.

“Alkyl”, as used herein, refers to the radical of saturated or unsaturated aliphatic groups, including straight-chain alkyl, alkenyl, or alkynyl groups, branched-chain alkyl, alkenyl, or alkynyl groups, cycloalkyl, cycloalkenyl, or cycloalkynyl (alicyclic) groups, alkyl substituted cycloalkyl, cycloalkenyl, or cycloalkynyl groups, and cycloalkyl substituted alkyl, alkenyl, or alkynyl groups. Unless otherwise indicated, a straight chain or branched chain alkyl has 30 or fewer carbon atoms in its backbone (e.g., C₁-C₃₀ for straight chain, C₃-C₃₀ for branched chain), and more preferably 20 or fewer. Likewise, preferred cycloalkyls have from 3-10 carbon atoms in their ring structure, and more preferably have 5, 6 or 7 carbons in the ring structure.

“Alkylaryl”, as used herein, refers to an alkyl group substituted with an aryl group (e.g., an aromatic or heteroaromatic group).

“Heterocycle” or “heterocyclic”, as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) where Y is absent or is H, O, (C₁₋₄)alkyl, phenyl or benzyl, and optionally containing 1-3 double bonds and optionally substituted with one or more substituents. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl.

“Heteroaryl”, as used herein, refers to a monocyclic aromatic ring containing five or six ring atoms consisting of carbon and 1, 2, 3, or 4 heteroatoms each selected from the group consisting of non-peroxide oxygen, sulfur, and N(Y) where Y is absent or is H, O, (C₁-C₈)alkyl, phenyl or benzyl. Non-limiting examples of heteroaryl groups include furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl, (or its N-oxide), thienyl, pyrimidinyl (or its N-oxide), indolyl, isoquinolyl (or its N-oxide), quinolyl (or its N-oxide) and the like. The term “heteroaryl” can include radicals of an ortho-fused bicyclic heterocycle of about eight to ten ring atoms derived therefrom, particularly a benz-derivative or one derived by fusing a propylene, trimethylene, or tetramethylene diradical thereto. Examples of heteroaryl can be furyl, imidazolyl, triazolyl, triazinyl, oxazoyl, isoxazoyl, thiazolyl, isothiazoyl, pyraxolyl, pyrrolyl, pyrazinyl, tetrazolyl, pyridyl (or its N-oxide), thientyl, pyrimidinyl (or its N-oxide), indolyl, isoquinolyl (or its N-oxide), quinolyl (or its N-oxide), and the like.

“Halogen”, as used herein, refers to fluorine, chlorine, bromine, or iodine.

The terms “alkenyl” and “alkynyl” refer to unsaturated aliphatic groups analogous in length and possible substitution to the alkyls described above, but that contain at least one double or triple bond respectively.

The terms ortho, meta and para apply to 1,2-, 1,3- and 1,4-disubstituted benzenes, respectively. For example, the names 1,2-dimethylbenzene and ortho-dimethylbenzene are synonymous.

“Substituted”, as used herein, means that the functional group contains one or more substituents attached thereon including, but not limited to, hydrogen, halogen, cyano, alkoxyl, alkyl, alkenyl, cycloalkyl, cycloalkenyl, aryl, heterocycloalkyl, heteroaryl, amine, hydroxyl, oxo, formyl, acyl, carboxylic acid (—COOH), —C(O)R′, —C(O)OR′, carboxylate (—COO—), primary amide (e.g., —CONH₂), secondary amide (e.g., —CONHR′), —C(O)NR′R″, —NR′R″, —NR′S(O)₂R″, —NR′C(O)R″, —S(O)₂R″, —SR′, and —S(O)₂NR′R″, sulfinyl group (e.g., —SOR′), and sulfonyl group (e.g., —SOOR′); where R′ and R″ may each independently be hydrogen, alkyl, alkenyl, alkynyl, cycloalkyl, aryl, heterocycloalkyl and heteroaryl; where each of R′ and R″ is optionally independently substituted with one or more substituents selected from the group consisting of halogen, hydroxyl, oxo, cyano, nitro, amino, alkylamino, dialkylamino, alkyl optionally substituted with one or more halogen or alkoxy or aryloxy, aryl optionally substituted with one or more halogen or alkoxy or alkyl or trihaloalkyl, heterocycloalkyl optionally substituted with aryl or heteroaryl or oxo or alkyl optionally substituted with hydroxyl, cycloalkyl optionally substituted with hydroxyl, heteroaryl optionally substituted with one or more halogen or alkoxy or alkyl or trihaloalkyl, haloalkyl, hydroxyalkyl, carboxy, alkoxy, aryloxy, alkoxycarbonyl, aminocarbonyl, alkylaminocarbonyl and dialkylaminocarbonyl, or combinations thereof. In some instances, “substituted” also refers to one or more substitutions of one or more of the carbon atoms in a carbon chain (i.e., alkyl, alkenyl, cycloalkyl, cycloalkenyl, and aryl groups) which can be substituted by a heteroatom, such as, but not limited to, a nitrogen or oxygen.

“Organometallic” refers to compounds, salts, materials, molecules, that have a hybrid character in that they contain both a “metal” component as well as an “organic” component. The nature of the linkage between the metal and organic components is not restricted. In this case, “metal” is defined as any element of the periodic table except carbon. “Organic” as used in this context means carbon-containing and can be any group, fragment, molecule, material that is comprised of at least one carbon atom.

“Rubber,” or “Elastomer,” as used herein, may refer to a crosslinked network polymer, which may exhibit elastomeric behavior in response to deformation at temperatures defined as being within the “rubbery regime.”

As used herein, the term “network” refers to a substance having oligomeric and/or polymeric strands interconnected to one another by crosslinks, including three-dimensional crosslinked networks.

As used herein, the term “prepolymer” refers to oligomeric or polymeric strands which have not undergone crosslinking to form a network.

As used herein, the term “crosslink” refers to a connection between two strands. A crosslink may be a covalent chemical bond, a physical chemical interaction such as a chain entanglement, interchain hydrogen bonding, chain alignment such as that seen in crystallization, a supramolecular interaction such as the self-complementary hydrogen bonding exhibited by ureidopyrimidinone (UPy) molecular moeties, ionic or ionomeric crosslinking, slide-ring crosslinking (freely movable crosslinks), semi-interpenetrating networks formed by dispersion and/or dissolution of one substituent in a second crosslinked phase, interpenetrating networks formed by crosslinking of multiple substituents in and throughout networks for separately by each substituents, liquid crystalline interactions, or other crosslinking interactions. The crosslink may be formed by reaction of a pendant group in one strand with the backbone of a different strand, or by reaction of one pendant group with another pendant group. Crosslinks may exist between separate strand molecules and may also exist between different points of the same strand.

“Curable,” as used herein, refers to monomeric, oligomeric or polymeric materials or compositions thereof capable of being toughened or hardened typically by cross-linking or linear polymerization of polymer and/or oligomer chains therein. “Curing,” as used herein refers to the process of applying an external stimulus, such as, but not limited to, light, radiation, electron beam irradiation, heat, chemical additives, including ionic additives, and combinations thereof which induce linear polymerization and/or crosslinking to produce toughening or hardening of the materials.

The term “biocompatible”, as used herein, is intended to describe materials that do not elicit a substantial detrimental response in vivo.

As used herein, “biodegradable” polymers are polymers that degrade to macromolecular, oligomeric and/or monomeric species under physiological or endosomal conditions. In various preferred embodiments, the polymers and polymer biodegradation byproducts are biocompatible. Biodegradable polymers are not necessarily hydrolytically degradable and may require enzymatic action to fully degrade.

“Solvent soluble” as used herein refers to polymer(s) that are capable of undergoing dissolution, degradation, dispersion, and/or swelling in the presence of common organic solvents. “Water soluble” polymer(s) are a type of solvent soluble polymer where the polymer is capable of undergoing dissolution, degradation, and/or dispersionin the presence of water and/or aqueous solvents.

“Solvent degradable” as used herein refers to polymers that undergo one or more chemical reactions that result in cleavage of ionic, covalent and/or hydrogen bonds and leads to eventual polymer degradation, completely or partially, in the presence of certain solvents (such as organic solvents, water, or aqueous solvents), chemical environments, or under certain reaction conditions. “Water degradable” polymers are a type of solvent degradable polymer that undergoes one or more chemical reactions that result in cleavage of ionic, covalent and/or hydrogen bonds and leads to eventual polymer degradation, completely or partially, in the presence of water or aqueous solvents.

“Catalysts” or “Catalytic centers,” as used herein, refer to a molecular species or component thereof which lowers the activation energy of chemical reactions and is generally not destroyed or consumed by the chemical reaction and is or can be regenerated. Catalysts are often used to increase rates or yields of chemical reactions and may offer significant economic, efficiency and energy advantages to individuals or businesses that carry out these reactions.

“Viscosity,” as used herein refers to the resistance of a substance (typically a liquid) to flow. Viscosity is related to the concept of shear force; it can be understood as the effect of different layers of the fluid exerting shearing force on each other, or on other surfaces, as they move against each other. There are several measures of viscosity. The units of viscosity are Ns/m², known as Pascal-seconds (Pa-s). Viscosity can be “kinematic” or “absolute”. Kinematic viscosity is a measure of the rate at which momentum is transferred through a fluid. It is measured in Stokes (St). The kinematic viscosity is a measure of the resistive flow of a fluid under the influence of gravity. When two fluids of equal volume and differing viscosity are placed in identical capillary viscometers and allowed to flow by gravity, the more viscous fluid takes longer than the less viscous fluid to flow through the capillary. If, for example, one fluid takes 200 s to complete its flow and another fluid takes 400 s, the second fluid is called twice as viscous as the first on a kinematic viscosity scale. The dimension of kinematic viscosity is length²/time. Commonly, kinematic viscosity is expressed in centiStokes (cSt). The SI unit of kinematic viscosity is mm²/s, which is equal to 1 cSt. The “absolute viscosity”, sometimes called “dynamic viscosity” or “simple viscosity”, is the product of kinematic viscosity and fluid density. Absolute viscosity is expressed in units of centipoise (cP). The SI unit of absolute viscosity is the milliPascal-second (mPa-s), where 1 cP=1 mPa-s. Viscosity may be measured by using, for example, a viscometer at a given shear rate. Additionally, viscosity may be measured by using, for example, a viscometer at multiple given shear rates. A “zero-shear” viscosity can then be extrapolated by creating a best fit line of the four highest-shear points on a plot of dynamic viscosity versus shear rate, and linearly extrapolating viscosity back to zero shear. Alternatively, for a Newtonian fluid, viscosity can be determined by averaging viscosity values at multiple shear rates. Viscosity can also be measured using a microfluidic viscometer at single or multiple shear rates (also called flow rates), wherein absolute viscosity is derived from a change in pressure as a liquid flows through a channel. Viscosity equals shear stress over shear rate. Viscosities measured with microfluidic viscometers can, in some embodiments, be directly compared to zero-shear viscosities, for example those extrapolated from viscosities measured at multiple shear rates using a cone and plate viscometer.

The term “jettable”, as generally used herein, refers suitability of the curable compositions described to be used in inkjet printing processes, including those used for three dimensional inkjet printing.

As used herein, the terms “oligomer” and “polymers” each refer to a compound of a repeating monomeric subunit. Generally speaking, an “oligomer” contains fewer monomeric units than a “polymer.” Those of skill in the art will appreciate that whether a particular compound is designated an oligomer or polymer is dependent on both the identity of the compound and the context in which it is used.

One of ordinary skill will appreciate that many oligomeric and polymeric compounds are composed of a plurality of compounds having differing numbers of monomers. Such mixtures are often designated by the average molecular weight of the oligomeric or polymeric compounds in the mixture. As used herein, the use of the singular “compound” in reference to an oligomeric or polymeric compound includes such mixtures.

As used herein, reference to any oligomeric or polymeric material without further modifiers includes oligomeric or polymeric material having any average molecular weight.

“Chain transfer,” as used herein, generally refers to chain transfer reactions which may occur during a polymerization reaction in which a chemical reaction occurs during a chain polymerization in which an active center is transferred from a growing macromolecule or oligomer molecule to another molecule or to another site on the same molecule, such as to limit the molecular weight of the growing macromolecule or oligomer molecule

“Chain transfer agent,” also known as control agents, modifiers, or regulators, refers to compounds which react with the free-radical site of a growing polymer chain (a chain carrier) and interrupt chain growth and which may result in the original chain becoming deactivated and a new growing chain being generated. Chain transfer agents may influence molecular weight distribution for polymers formed during polymerization processes and may influence polymer physical, mechanical and thermomechanical behavior. Chain transfer agents may include at least one chemical bond of sufficiently low bond energy to undergo chain transfer reactions, and chain transfer activity is reported in the form of chain transfer constants, which may vary from 0.001 up to >220,000. Representative chain transfer agents include, but are not limited to, halogen-containing compounds, aromatic hydrocarbons, and thiols (mercaptans).

“Free Radical Initiator,” as used herein, generally refers to organic and inorganic compounds capable of generating radicals that initiate polymerization. Exemplary initiators include, but are not limited to, peroxide and azo containing compounds.

“Photoinitiator,” as used herein, generally refers to a compound that undergoes a photoreaction on absorption of light, producing reactive species, such as radicals or cations capable of initiating polymerization reactions. Exemplary photoiniators may include, for example, radical photoiniators and cationic photoinitiators.

“Free Radical Inhibitor,” as used herein, generally refers to a compound which may be added during a free-radical polymerization which react with and can trap radicals present. Such trapping events act to inhibit the radical polymerization process.

“Supramolecular,” as used herein, generally refers to an assembly or assemblies of a plurality of molecular components, wherein the components are assembled through typically weak and often reversible forces such as, but not limited to, intermolecular forces, hydrogen bonding, metal coordination, hydrophobic forces, van der Waals forces, pi-pi interactions and electrostatic effects.

“Ionomeric,” as used herein, generally refers to polymer materials, which contain some ionic repeat units.

“Swelling,” as used herein, generally refers to the ability of crosslinked polymer to absorb at least a portion of solvent(s) when the polymer is placed into the solvent(s), as opposed to dissolving in the solvent(s). Swelling results from a solvent(s) ability to penentrate into the crosslinked polymer network.

“Plasticizer,” as used herein, generally refers to compounds (additives) that can interpose between polymer chains in order to decrease the transition temperatures, such as the glass transition, and/or decrease the viscosity of a polymer-based material. Exemplary plasticizers include classes of materials such as phthalates, dicarbonates, phosphates, and fatty acid esters, etc.

“Fillers,” as used herein, generally refers to materials (typically particulates) which can be added to a polymer formulation to lower cost and/or to improve resulting properties. Such materials can be in the form of a solid, liquid or gas and can be extender fillers which primarily occupy space and are mainly used to lower the formulation cost or functional fillers, such as, but not limited to, reinforcing fillers, rubbery fillers, and fibrous fillers.

“Stereolithography,” as used herein, generally refers to a form of 3-D printing technology used, for example, in creating models, prototypes, patterns, molds, dies, production parts or components, etc. via a layer-by-layer fashion typically using photopolymerization of a suitable formulation.

“Ceramic,” as used herein, generally refers to an inorganic compound, non-metallic, solid material comprising metal, non-metal or metalloid atoms primarily held in ionic and covalent bonds. Exemplary ceramics may include oxide, nitride or carbide materials.

“Single crystal alloys,” as used herein, generally refers to mixtures of metals that can be processed (solidified) such that the entire object essentially forms a single grain (i.e. one continuous crystal).

“Sacrificial mold,” as used herein, generally refers to a geometic pattern formed for the purpose of sacrificial removal or destruction in the process of forming another article of manufacture. Sacrificial polymeric materials include burnout materials and solvent soluble or degradable materials and may be formed into negative, positive or other images used in another article's fabrication.

“Ceramic core,” as used herein, generally refers to sacrificial ceramic structures primarily used for forming cavities within cast or molded articles of manufacture. Ceramic cores are typically manufactured using a ceramic material of various compositions, including silica, alumina, and zirconia.

“Cooling channel,” as used herein, generally refers to a channel wherein one or more liquids or gases may flow to facilitate heat transfer.

“Turbine blade,” as used herein, generally refers to a blade-like component which makes up the turbine section of a gas turbine or steam turbine.

“Flow channel,” as used herein, generally refers to a microscale channel wherein one or more liquids or gases may flow through.

“Mean particle size,” or “Average particle size,” as used herein, generally refers to the statistical mean particle size (diameter) of the particles in a population of particles. The diameter of an essentially spherical particle may be referred to as the physical or hydrodynamic diameter. The diameter of a non-spherical particle may refer preferentially to the hydrodynamic diameter. As used herein, the diameter of a non-spherical particle may refer to the largest linear distance between two points on the surface of the particle. Mean particle size can be measured using methods known in the art, such as dynamic light scattering.

Numerical ranges include ranges of temperatures, ranges of pressures, ranges of molecular weights, ranges of integers, ranges of force values, ranges of times, ranges of thicknesses, and ranges of gas flow rates. The disclosed ranges of any type, disclose individually each possible number that such a range could reasonably encompass, as well as any sub-ranges and combinations of sub-ranges encompassed therein. For example, disclosure of a temperature range, is intended to disclose individually every possible temperature value that such a range could encompass, consistent with the disclosure herein. In another example, the disclosure that an annealing step may be carried out for a period of time in the range of about 5 min to 30 min, also refers to time values that can be selected independently from about 5, 6, 7, 8, 9, 10, 11, 12, 13, 14, 15, 16, 17, 18, 19, 20, 21, 22, 23, 24, 25, 26, 27, 28, 29, and 30 minutes, as well as any range between these numbers (for example, 10 min to 20 min), and any possible combination of ranges between these time values.

The term “about” or “approximately” as used herein generally means within 20%, preferably within 10%, and more preferably within 5% of a given value or range. The term “about x” further includes x.

### II. Curable Formulations

Curable formulations of monomeric and/or oligomeric precursors are formed via chemistries that enable desirable material performance and tunable physical and thermomechanical properties to be obtained. Desirable material performance and tunable physical and thermomechanical properties include, but are not limited to, high toughness, optical clarity, high tensile strength, good solvent resistance for certain formulations, tunable solvent dissolution or degradation times for certain formulations, good thermal resistance, tunable modulus, viscosity, tunable glass transition temperatures (between about −50° C. and about 400° C., preferably between about −20° C. and about 300° C., more preferably between about 50° C. and about 250° C., most preferably between about 75° C. and about 250° C.) tunable crystalline melt temperatures (between about −50° C. and about 400° C., preferably between about −20° C. and about 300° C., most preferably between about 50° C. and about 250° C., most preferably between about 75° C. and about 250° C.), tunable cure time, and tunable surface adhesion.

The curable formulations include monomeric and/or oligomeric precursors. The monomeric and/or oligomeric precursors contain one or more reactive functional groups, where the one or more reactive functional groups can vary from n=1 to n=1000 or greater, depending on the monomeric and/or oligomeric precursors. The curable formulations formed from monomeric and/or oligomeric precursors can be tuned, for example, by varying the degree of functionalization with one or more reactive functional groups used to prepare the precursors and formulations thereof. In some instances, the number of reactive functional groups for monomeric or oligomeric precursors is between 1 to 100, 1 to 50, or 1 to 20.

In some embodiments, the properties of the precursors can be tuned via the inclusion of one or more moieties, such as cyclic aliphatic linkages/linker groups, for toughness, rigidity, UV resistance and thermal resistance; sterically hindered moieties and/or substituents, which can inhibit/control macromolecular alignment to afford amorphous materials, composites, and other compositions thereof upon polymerization and which can afford high optical clarity.

In certain embodiments, the precursors of the formulation or mixture include moieties and/or substituents that can form or contain linkages, such as, but not limited to, urethane, amide, thiourethane and dithiourethane groups which allow for inter-chain hydrogen bonding and can be used to impart increased toughness and rigidity. In yet other embodiments, the selective incorporation of ester, beta-aminoester, anhydride, carbonate, imine, acetal, hemiacetal, thioacetal, silyl ether linkages, ionic linkages, including various organometallic and organic (meth)acrylate and (meth)acrylamide salts, and various other linker groups in the precursors can be used to control environmental degradation time and solvent uptake, which can also be tuned by incorporating pendant hydrophilic or hydrophobic groups into material compositions.

The precursors of the curable formulations can be prepared, for example, from mercapto, alkene, (meth)acrylate, organic salts, inorganic or, organometallic salts, anhydride, alkyne, amine, and epoxy functionalized monomeric and oligomeric constituents, or combinations thereof. The stoichiometric ratios of monomeric and/or oligomeric precursors present in the curable formulations can range from about 1.00:4.00, about 1.00:3.00, about 1.00:2.20, about 1.00:2.00, about 1.00:1.00, about 1.00:0.97, about 1.00:0.95, about 1.00:0.90, about 1.00:0.50, about 1.00:0.33, about 1.00:0.25, about 1.00:0.20, about 1.00:0.10, and about 1.00:0.01. In certain instances, the monomeric and/or oligomeric precursors formulation ratios of the curable formulations may be tuned to control structure-property relationships including, but not limited to, macromolecular physical, mechanical, thermomechanical, functional or other such behaviors, and the effects of monomer concentration on material behavior and properties vary based on what attribute is being tuned to a desired behavior and/or being assessed. In a non-limiting example, tuning glass transition in amorphous polymeric systems formed from chain growth polymerization, the Flory-Fox equation is sometimes a useful predictor of glass transition of a comonomer blend if the glass transitions of each individual monomer are known. For assessing the effect of plasticizer concentration on polymer glass transition and mechanical integrity, plasticizers are often used in industry in 5% to 30% concentrations, and reliance on established industrial standards can be be used. In some instances, free radical photoinitiator concentrations range from about 0.01 to about 5.0 wt %, free radical inhibitor concentrations may range from about 0.01 to about 2.0 wt %. In some instances, when highly tough polymeric systems are being formulated, incorporation of hydrogen bonding moieties that can, for example, facilitiate intermacromolecular interactions can be helpful for maintaining an average molecular weight between crosslinking sites, preferably >700 Da. Crosslinker chemistries, if high glass transition temperature are not a main goal or desired, can include the use of flexible crosslinker chemistries capable of undergoing conformational changes to dissipate energy prior to breaking covalent bonds. As an example, hydrophilic side chain monomers can increase glass transition temperatures, and which can in certain instances also increase brittle behavior, when used at aconcentration range of about 5 wt % to about 45 wt %, or from about 5 wt % to about 15 wt % and/or about 20 wt % to about 40 wt %.

The aforementioned curable formulations formed of monomeric and/or oligomeric precursors can be cured by subjecting the curable formulations to ultraviolent (UV) light, visible light, heat, acid or base catalyzed curing processes, by adding organic, inorganic, organometallic, or ionic species that result in crosslinking, catalytically or stoichiometrically, including the addition of various salts, or combinations thereof. For UV curing processes, wavelengths suitable for curing the formulations range from about 200 nm to about 400 nm, preferably between about 330 and about 400 nm. For visible light curing processes, wavelengths range from about 401 nm to to about 650 nm, preferably around 405 nm. Thermal curing can be performed between about 0° C. to about 250° C., preferably between about 20° C. and about 150° C. Base-catalyzed curing processes may be induced by chemistries including, but not limited to, primary, secondary, and tertiary amines, hydroxyl compounds and photobase compounds. Ionic species that induce curing/crosslinking may include divalent, trivalent, or tetravalent anions or cations.

Varying quantities of initiators or catalysts can be added to the formulations to mediate and/or control addition reactions, between the monomeric and/or oligomeric precursors, prior to or during the application of an optional thermal aging process. Exemplary addition reactions include, but are not limited to, free radical, base catalyzed Michael Addition and base catalyzed thiol-epoxy addition reactions. The type and quantity of initiator or catalyst used controls the rate of reaction and type of reaction that proceeds. For example, mixtures of acrylate-containing monomers and thiol-containing monomers undergo radical polymerization in the presence of radicals generated from initiators. In the presence of a base catalyst these same monomers may undergo Michael Addition reactions. By changing/varying the catalyst/initiator, for example in a given thiol-acrylate formulation, molecular weight, crosslinking, cure time, solvent dissolution, and solvent degradability can be tuned/controlled. In some non-limiting examples, preferred ranges for base catalyst concentration in thiol-epoxy reactions are about 0.01 to about 3.0 wt %, in thiol-acrylate reactions are about 0.01 to about 5.0%, in acrylate-amine reactions are about 0.01 to about 5%, in amine-epoxy reactions are about 0.01 to about 5%. In some other non-limiting examples, preferred stoichiometric ratios between thiols and amines/epoxies, as described above, depend on desired end group functionalization of reaction products. The stoichiometric ratios, for example, can generally range from 0.10:0.90 to 0.90:0.10. For radical thiol-ene or thiol-acrylate reactions, free radical initiatior concentrations of about 0.01 to 5.0 about wt % can be used.

In some embodiments, silanes, including, but not limited to, vinylsilanes, mercaptosilanes, aminosilanes, methacrylosilanes can be added in a range of about 0.01 to about 50.0 mole % equivalents to formulations described herein. Specific products which may be added include, but are not limited to, allyltriphenylsilane, (5-bicyclo[2.2.1]hept-2-enyl) dimethylethoxysilane, 4,4′-bis(dimethylsilyl)biphenyl, (cyclopentenyloxy)trimethyl silane, diphenylmethylsilane, diphenylsilane, diphenylsiloxane dimethyl siloxane copolymer, 100 cSt, hexaphenyldisilane, (methacryloxymethyl) phenyldimethylsilane, methacryloxypropyldimethylmethoxysilane, methacryloxypropyl tris(vinyl dimethylsiloxy)silane, octaphenylcyclotetrasiloxane, 4-(phenoxyphenyl) phenyldimethoxysilane, 1,1,2,2-tetraphenyldisilane, 1,3,5-trisilacyclohexane, vinyldiphenylethoxysilane, EVONIK® Dynasylan MTMO, AMMO, VTMO and EVONIK® (meth)acrylated silanes.

A. For curable formulations designed to be UV curable, exemplary photoinitiators include, but are not limited to, Acetophenone, Anisoin, Anthraquinone, Anthraquinone-2-sulfonic acid sodium salt monohydrate, (Benzene) tricarbonylchromium, Benzil, Benzoin, Benzoin ethyl ether, Benzoin isobutyl ether, Benzoin methyl ether, Benzophenone, Benzophenone/1-Hydroxycyclohexyl phenyl ketone blend, 3,3′,4,4′-Benzophenonetetracarboxylic dianhydride, 4-Benzoylbiphenyl, 2-Benzyl-2-(dimethylamino)-4′-morpholinobutyrophenone, 4,4′-Bis(diethylamino)benzophenone, 4,4′-Bis(dimethylamino)benzophenone, Bis(2,4,6-trimethylbenzoyl)phenylphosphine oxide, Camphorquinone, 2-Chlorothioxanthen-9-one, (Cumene)cyclopentadienyliron(II) hexafluorophosphate, Dibenzosuberenone, 2,2-Diethoxyacetophenone, 2,4-Diethyl-9H-thioxanthen-9-one, 4,4′-Dihydroxybenzophenone, 2,2-Dimethoxy-2-phenylacetophenone, 4-(Dimethylamino)benzophenone, 4,4′-Dimethylbenzil, 2,5-Dimethylbenzophenone, 3,4-Dimethylbenzophenone, Diphenyl(2,4,6-trimethylbenzoyl)phosphine oxide, Diphenyl(2,4,6-trimethylbenzoyl)phosphine oxide/2-Hydroxy-2-methylpropiophenone blend, 4′-Ethoxyacetophenone, 2-Ethylanthraquinone, Ethyl phenyl(2,4,6-Trimethylbenzoyl) phosphinate Ferrocene, 3′-Hydroxyacetophenone, 4′-Hydroxyacetophenone, 3-Hydroxybenzophenone, 4-Hydroxybenzophenone, 1-Hydroxycyclohexyl phenyl ketone, 2-Hydroxy-2-methylpropiophenone, 2-Methylbenzophenone, 3-Methylbenzophenone, Methybenzoylformate, 2-Methyl-4′-(methylthio)-2-morpholinopropiophenone, Phenanthrenequinone, 4′-Phenoxyacetophenone, Thioxanthen-9-one, Triarylsulfonium hexafluoroantimonate salts, Triarylsulfonium hexafluorophosphate salts, Isopropylthioxanthone, cationic photoinitiators absorbing in the range of 200 to 600 nm, photobase initiators absorbing in the range of 200 to 600 nm, radical initiators absorbing in the range of 200 to 600 nm. The amount of photoinitiator which can be added to UV curable formulations can range from about 0.001 wt % to 10 wt %. In some embodiments, the amount of photoinitiator added to the curable formulations can be about 0.10 wt %, about 0.20 wt %, about 0.30 wt %, about 0.40 wt %, about 0.50 wt %, about 1.00 wt %, about 1.50 wt %, about 2.00 wt %, about 2.50 wt %, about 3.00 wt %, about 3.50 wt %, about 4.00 wt %, about 4.50 wt %, and about 5.00 wt %, preferably between about 0.10 wt % and about 5.00 wt %, between about 0.30 wt % and about 2.00 wt %, and even more preferably between about 0.50 wt % and about 1.00 wt %.

B. In some embodiments, light absorbing additives can be added to UV curable formulations. These additives can be organic compounds/dyes that absorb in the range of 200 nm to 800 nm, or they can be inorganic or organometallic compounds that absorb in the range of 200 nm to 800 nm. Such additives preferably absorb in the wavelength range of 200 to 800 nm, 300 to 600 nm, 400 to 700 nm. Exemplary light absorbing additives include, but are not limited to, Aniline Yellow, Bismarck Brown Y, Crocin, Crystal Violet, Disperse Black 9, Disperse Orange 3, Disperse Red 1, Disperse Red 19, Ethyl Green, Ethyl Violet, Indigo Carmine, Metanil Yellow, Methyl Red, Napththol Blue Black, Oil Red O, Phenol Red, Reactive Orange 16, Solvent Green 3, Solvent Red 3, Sudan I, Tartrazine, aluminum(III) acetylacetonate, cadmium acetylacetonate, cobalt(III) acetylacetonate, copper(II) acetylacetonate, gallium acetylacetonate, iron(III) acetylacetonate, lithium acetylacetonate, manganese(II) acetylacetonate, manganese(III) acetylacetonate, zinc acetylacetonate hydrate, ammonium cobalt(II) sulfate hexahydrate, bis(acetylacetonato) dioxomolybdenum, cobalt(II) acetate tetrahydrate, copper(II) ethylacetoacetate, magnesium acetylacetonate dihydrate, tetrabutyl orthotitanate, tetraethylammonium tetrachlorocobaltate, tetraethylammonium toluene sulfonate, tetrabutylammonium dichromate, titanium diisopropoxide bis(acetylacetonate), titanium(IV) isopropoxide, tetrabutylammonium hydrogensulfate, tetrabutyl orthotitanate, tetraethylammonium tetrachlorocobaltate, tetraethylammonium toluene sulfonate, tetrabutylammonium dichromate, potassium permanganate, cobalt(II) sulfate and hydrated forms, iron(II) chloride, iron(III) chloride, chromium(III) chloride and hydrated forms, copper(II) chloride and any hydrated forms, nickel(II) chloride and any hydrated forms thereof, Tris(bipyridine)ruthenium(II) chloride, 2,2′-(2,5-thiophenediyl)bis(5-tert-butylbenzoxazole), 1-(Phenyldiazenyl)naphthalen-2-ol, 1-Methyl-4-[(3-methyl-2(3H)-benzothiazolylidene)methyl]quinolinium p-tosylate, 4,4′-(m-Phenylenebisazo)bis-m-phenylenediamine dihydrochloride, [4-[[4-(diethylamino)phenyl]-phenylmethylene]-1-cyclohexa-2,5-dienylidene]-diethylammonium; hydrogen sulfate, 1-naphthalenol, 4-[(4-ethoxyphenyl)azo], 4,4′-(m-Phenylenebisazo)bis-m-phenylenediamine dihydrochloride, 1-(p-Nitrophenylazo)-2-naphthol, 1-(4-Nitrophenylazo)-2-naphthol, 3,6-Bis(dimethylamino)acridine hydrochloride zinc chloride double salt, azophloxine, disodium 6-acetamido-4-hydroxy-3-[[4-[[2-(sulphonatooxy)ethyl]sulphonyl]phenyl]azo]naphthalene-2-sulphonate, 2,2′-(1,2-ethenediyl)bis(4,1-phenylene)bisbenzoxazole, 2,2′-(2,5-thiophenediyl)bis(5-tert-butylbenzoxazole), 4,4′-diamino-2,2′-stilbenedisulfonic acid, and 4,4′-diamino-2,2′-stilbenedisulfonic acid. Organic additives, such as dyes, include commercially available red dyes, orange dyes, yellow dyes, blue dyes, green dyes, purple dyes, brown dyes, and combinations thereof. Other light absorbing additives include pigments, such as commercially available pigments, including, but not limited to, pigments based on iron oxides, titanium oxides, zinc oxides, magnetite, hematite, cobalt oxides, chromium oxides, aluminum oxides, carbon and combinations thereof. Examplary of pigments can include, but are not limited to, Ultramarine violet, Han Purple, Cobalt Violet, Manganese Violet, Ultramarine, Cobalt Blue, Cerulean Blue, Egyptian Blue, Han Blue, Prussian Blue, Cadmium Green, Cadmium Yellow, Viridian, Chrome Green, Paris Green, Scheele's Green, Arsenic Sulfide, Chrome Yellow, Cobalt Yellow, Yellow Ochre, Naples Yellow, Titanium Yellow, Stannic sulfide, Cadmium Orange, Chrome Orange, Cadmium Red, Sanguine, Caput Mortuum, Venetian Red, Oxide Red, Red Ochre, Burnt Sienna, Red Lead, Vermilion, Raw Umber, Burnt Umber, Raw Sienna, Carbon Black, Ivory Black, Vine Black, Lamp Black, Iron black, Titanium Black, Antimony White, Barium sulfate, White Lead, Titanium White, and Zinc White.

C. In some embodiments, free radical inhibitors (which include, but are not limited to, 2,6-Di-tert-butyl-4-methylphenol, 4-Methoxyphenol, 1,4-Hydroquinone, 1,4-Benzoquinone, (2,2,6,6-Tetramethylpiperidin-l-1)oxyl, Isoeugenol, α-Tocopherol, 4-tert-Butylcatechol, 1,2,3-Trihydroxybenzene, 3,4,5-Trihydroxybenzoic acid, Lauryl Gallate (Dodecyl Gallate), Triphenyl Phosphite, Phenylphosphonic acid, tris(2,4-Di(tert-butyl)-phenyl)phosphite, N-Nitroso-N-phenylhydroxylamine Aluminum Salt) can be added to the curable formulations to a concentration in a range from 0.01 to 30,000 ppm. In some embodiments, the concentration of free radical inhibitors added can be about 500 ppm, about 1000 ppm, about 1500 ppm, about 2000 ppm, about 4000 ppm, about 6000 ppm, about 8000 ppm. For example, a free radical inhibitor can be added to acrylate containing formulations and select thiol-ene formulations.

D. For curable formulations designed to be thermally curable, such as thiol-epoxy-based formulations, thermal free-radical initiators or amine catalysts can be added to catalyze curing. Exemplary thermal free-radical initiators include, but are not limited to, tert-Amyl peroxybenzoate, 4,4-Azobis(4-cyanovaleric acid), 1,1′-Azobis(cyclohexanecarbonitrile), 2,2′-Azobisisobutyronitrile (AIBN), Benzoyl peroxide (BPO), 2,2-Bis(tert-butylperoxy)butane, 1,1-Bis(tert-butylperoxy)cyclohexane, 2,5-Bis(tert-butylperoxy)-2,5-dimethylhexane, 2,5-Bis(tert-Butylperoxy)-2,5-dimethyl-3-hexyne, Bis(1-(tert-butylperoxy)-1-methylethyl)benzene, 1,1-Bis(tert-butylperoxy)-3,3,5-trimethylcyclohexane, tert-Butyl hydroperoxide, tert-Butyl peracetate, tert-Butyl peroxide, tert-Butyl peroxybenzoate, tert-Butylperoxy isopropyl carbonate, Cumene hydroperoxide, Cyclohexanone peroxide, Dicumyl peroxide, Lauroyl peroxide, 2,4-Pentanedione peroxide, Peracetic acid, Potassium persulfate. Thermal free radical initiators are used to initiate radical addition reactions, such as during a thermal aging process, and the amounts added to the curable formulations can range from about 0.001 wt % to 10 wt %. In some embodiments, the amount of thermal free radical initiator added to the curable formulations can be about 0.10 wt %, 0.20 wt %, 0.30 wt %, 0.40 wt %, 0.50 wt %, 1.00 wt %, 1.50 wt %, 2.00 wt %, 2.50 wt %, 3.00 wt %, 3.50 wt %, 4.00 wt %, 4.50 wt %, or 5.00 wt %. Amine base catalysts can be used catalyze, for example, Michael Addition and/or thiol-epoxy reactions or related reactions, during thermal aging. The amounts of amine base catalyst(s) which can be added to the curable formulations can range from about 0.01 wt % to 10 wt %. In some embodiments, the amount of amine base catalyst(s) which can be added to the curable formulations can be about 0.10 wt %, 0.20 wt %, 0.30 wt %, 0.40 wt %, 0.50 wt %, 1.00 wt %, 1.50 wt %, 2.00 wt %, 2.50 wt %, 3.00 wt %, 3.50 wt %, 4.00 wt %, 4.50 wt %, or 5.00 wt %.

Curing reactions can be used to fully cure or a substantially cure the formulations, wherein substantially refers to a percentage of functional group conversion of at least about 20%, 30%, 40%, 50%, 60%, 70%, 80%, 85%, 90%, 91%, 92%, 93%, 94%, 95%, 96%, 97%, 98%, 99%, or 99.9%. Preferably the percentage of functional group conversion ranges from 70% to 99% or >99%.

In certain embodiments, the curable formulations are designed to be chemically curable wherein one or more chemical catalysts, such as acid or base catalysts act to cure the curable formulation over a period of time, with preferred cure times ranging from about 1 second to about 24 hours, with further preference for cure times ranging from about 1 second to about 6 hours, with further preference for cure times ranging from about 1 second to about 2 hours. In certain embodiments, multiple catalysts can be employed that catalyze reactions between different functional groups. For example, base catalysts such as amines can be added in 0.01 to 3% to certain UV curable methacrylate formulations that contain approximately 10-20% epoxy and hydroxyl monomers, and these majority methacrylate compositions can be made to undergo photopolymerization in the presence of a photoinitiator and UV irradiation. After photopolymerization, residual epoxy and hydroxyl groups in this formulation can be further polymerized by heating in the presence of an amine catalyst to afford an interpenetrating network with increased glass transition and network rigidity at elevated temperatures. Preferred ranges for one or more chemical catalysts are about 0.01 wt %, 0.10 wt %, 0.20 wt %, 0.30 wt %, 0.40 wt %, 0.50 wt %, 1.00 wt %, 1.50 wt %, 2.00 wt %, 2.50 wt %, 3.00 wt %, 3.50 wt %, 4.00 wt %, 4.50 wt %, or 5.00 wt %. The time needed to achieve full curing will be dependent on the concentration of catalyst added and the nature of the crosslinking reaction chemistries occurring in the formulation on standing. In certain instances, such processes can be driven by applying heat to the formulation. In certain non-limiting examples, selection criteria for which chemical processes are used for polymerization or curing processes can include consideration and selection of material processing requirements for geometric processing resolution, desired production scale, environmental sensitivity of various monomers including moisture sensitivity, physical properties of monomers including boiling boint, and comonomer compatibility or miscibility. Heating monomers to facilitate miscibility and then subjecting newly miscible curable compositions to an additional polymerization process, such as photopolymerization, for example, is an effective approach when immisible comonomers are desired for use in photopolymerization.

E. Fillers may be included in the formulations described, including, but not limited to, fumed silica, boron carbide, molybdenum disulfide, tungsten carbide, alumina, carbon black, carbon fiber, carbon nanotubes, boron carbide, graphene, graphene oxide, reduced graphene oxide, partially reduced graphene oxide, and other fillers can be added to formulations if modification of properties is desired. In some embodiments, the amount of ceramic filler(s) added can be in the range of about 0.001 to 20.00 wt %. In some embodiments, the amount of filler(s) added is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, or 10.00 wt %. Exemplary fumed silica additives include silica additives having an average particle size in the range of about 5 to 500 m²/g. In some embodiments, the fumed silica additives have an average particle size of about 50 m²/g, 75 m²/g, 100 m²/g, 120 m²/g, 150 m²/g, 200 m²/g, 250 m²/g, 300 m²/g, or 350 m²/g. Examples include CABOT® CAB-O-SIL TS-720, TS-610, TS-622, TS-530, EVONIK® AEROSIL R8200, R106, R812S, R202, R208, R972, R974, R812S.

In some embodiments, siloxanes can be added in a range of about 0.01 to 15 mole % equivalents to the formulations described herein. Exemplary functionalized siloxanes include, but are not limited to, α-monovinyl-monophenyl-Ω-monohydride terminated polydimethylsiloxane, 20 cSt, (bicycloheptenyl)ethyl terminated polydimethylsiloxane, 1300-1800 cSt, (3-glycidoxypropyl)heptamethyl cyclotetrasiloxane, heptamethylcyclotetrasiloxane, hexamethylcyclotrisiloxane, hexamethyldisiloxane, hexaphenylcyclotrisiloxane, hydride terminated polydimethylsiloxane, 2-3 cSt, [2-3% (mercaptopropyl)methyl siloxane]-dimethylsiloxane copolymer, 120-180 cSt, methacryloxypropyl terminated polydimethylsiloxane, 125-250 cSt, methacryloxypropyl terminated polydimethylsiloxane, 4-6 cSt, (45-50% methylhydrosiloxane)-phenylmethylsiloxane copolymer, hydride terminated, 75-110 cSt, monovinyl functional polydimethylsiloxane, tetrahydrofufuryloxypropyl terminated-symmetric, 30-40 cSt, octamethylcyclotetrasiloxane, platinum-cyclovinylmethyl-siloxane complex, poly(phenylsilsesquioxane) (100% phenyl), tetrakis[(epoxycyclohexyl) ethyl] tetramethyl cyclo tetrasiloxane.

F. In some embodiments, capping and/or chain transfer agents can be added to UV curable formulations. Exemplary capping and/or chain transfer agents include, but are not limited to, thiols such as isooctyl 3-mercaptopropionate, dodecyl 3-mercaptopropionate, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, monofunctional aliphatic linear and branched thiols with n=2 to 40 carbons, 1,8-dimercapto-3,6-dioxaoctane, n-dodecyl mercaptan, n-octyl mercaptan, pentaerythritol tetrakis(3-mercaptobutylate), 1,4-bis (3-mercaptobutylyloxy) butane, 1,3,5-Tris(3-mercaptobutyloxethyl)-1,3,5-triazine-2,4,6(1H,3H,5H)-trione, tertiarydodecyl mercaptan, ethyl mercaptan, isopropyl mercaptan, dipentene dimercaptan, methyl mercaptan, n-propyl mercaptan, sec-butyl mercaptan, tert-nonyl mercaptan, tert-dodecyl mercaptan, tertiary mercaptan blends, tert-butyl mercaptan, grapefruit mercaptan, thioglycolic acid, thiolactic acid, 3-mercaptopropionic acid, ammonium thioglycolate, monoethanolamine thioglycolate, sodium thioglycolate, potassium thioglycolate, 2-ethylhexyl thioglycolate, isooctyl thioglycolate, iso-tridecyl thioglycolate, glyceryl thioglycolate, glyceryl dimercaptoacetate, pentaerythritol tetramercaptoacetate, butyl-3-mercaptopropionate, 2-ethylhexyl-3-mercaptopropionate, iso-tridecyl-3-mercaptopropionate, octadecyl 3-mercaptopropionate, ethoxylated trimethylolpropane tris(3-mercaptopropionate) with n=1 to 10,000 ethylene oxide repeat units, monoethanolamine thiolactate, thiodiglycolic acid, diammonium dithioglycolate, di(2-ethylhexyl) thiodiglycolate, methylene bis(butylthioglycolate), thiodipropionic acid, dithiobis(stearylpropionate), thioglycerol, dithioglycerol. Other exemplary capping and/or chain transfer agents include, but are not limited to, silanes such as triphenylsilane, triethylsilane, triisopropylsilane, tributylsilane, triisobutylsilane, trioctylsilane, tert-butyldimethylsilane. Other exemplary capping and/or chain transfer agents include, but are not limited to, halogen-containing compounds such as tetrabromomethane, tetrachloromethane, bromotrichloromethane, bromotrifluoromethane, dichloromethane, chloroform, bromoform, iodoform, iodine, 1,1,2,2-tetrachloroethane, trichloroethylene, tetrachloroethylene, trichlorotrifluoroethane, hexachloroethane, chlorocyclohexane, chlorocyclopentane, butylchloride, 1,4-dichlorobutane. Other exemplary capping and/or chain transfer agents include, but are not limited to, aromatic compounds such as toluene, diphenylmethane, diphenylmethanol, bis(diphenylmethyl) ether, diphenylmethyl benzoate, 1,1-diphenylacetone, 2,2-diphenylethanol, diphenylacetic acid, triphenylmethane, 9,10-dihydroanthracene, xanthene, fluorene, fluorene-9-carboxylic acid, 9-phenyl-9-H-fluorene. In some embodiments, the amount of capping and/or chain transfer agent(s) added is about 0.001 wt % to about 30 wt %, preferably between about 0.01 wt % to about 10 wt %, more preferably between about 0.1 wt % to about 5 wt %.

G. In some embodiments, plasticizers can be added to the UV curable formulations in order to modify physical properties of the uncured formulations and the physical and/or thermomechanical properties of cured formulations thereof. Examples of plasticizers include, but are not limited to, Bis(2-ethylhexyl) phthalate, Bis(2-propylheptyl) phthalate, Diisononyl phthalate, Di-n-butyl phthalate, Diisooctyl phthalate, Diisobutyl phthalate, Tricresyl phosphate, Tributyl phosphate, Triethyl citrate, Acetyl triethyl citrate, Tributyl citrate, Acetyl tributyl citrate, Trioctyl citrate, Acetyl trioctyl citrate, Trihexyl citrate, Acetyl trihexyl citrate, Butyryl trihexyl citrate, Trimethyl citrate, water, isopropanol, ethylene glycol, glycerol, Polyethylene Glycol (average Mₙ between 100 and 100,000), O-(2-Carboxyethyl)polyethylene glycol (average Mₙ between 100 and 100,000), Poly(ethylene glycol) bis(carboxymethyl) ether (average Mₙ between 100 and 100,000), Polypropylene Glycol (average Mₙ between 100 and 100,000), Castor Oil, Diacetylated Monoglycerides, Sorbitol, Sorbitan, Sorbitan monostearate, Sorbitan tristearate, polysorbates, Dioctyl adipate, Dibutyl Sebacate, Sebacic Acid, Triacetin, Trimethylolpropane ethoxylate (average Mn between 150 and 100,000), Glycolic acid ethoxylate lauryl ether (average Mₙ between 200 and 200,000). In some embodiments, the amount of plasticizer(s) added is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, 10.00 wt %, 12.50 wt %, 15.00 wt %, 17.50 wt %. 20.00 wt %, 25.00 wt %, 30.00 wt %, 35.00 wt % or 40.0 wt %. Preferably, the amount of plasticizer added is between 2 wt % and 20 wt %. In some embodiments, the plasticizer is made through thermal ageing within the monomer mixture. In these embodiments monomers may thermally react to form dimers, trimers, tetramers, oligomers or polymers thereof. These reaction products may result from Michael Addition and/or thiol-epoxy reactions or related reactions, during thermal aging. These reaction products may comprise about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, 10.00 wt %, 12.50 wt %, 15.00 wt %, 17.50 wt %. 20.00 wt %, 25.00 wt %, 30.00 wt %, 35.00 wt % or 40.0 wt %. Preferably, the amount of reaction product is between 2 wt % and 20 wt %. This reaction product may seve as a plasticizer in the cured formulation.

H. Catalysts, accelerators, and/or additives can optionally be added to the UV curable formulations in order to modify physical properties and/or curing profiles of the uncured formulations, as well as the physical or thermomechanical properties of cured formulations thereof. Exemplary catalysts, accelerators, or additives include, but are not limited to, aluminum(III) acetylacetonate, ammonium cobalt(II) sulfate hexahydrate, bis(acetylacetonato) dioxomolybdenum, cadmium acetylacetonate, cobalt(II) acetate tetrahydrate, cobalt(III) acetylacetonate, copper(II) acetylacetonate, iron(III) acetylacetonate, manganese(III) acetylacetonate, tetrabutyl orthotitanate, tetraethylammonium tetrachlorocobaltate, tetrabutylammonium dichromate, magnesium acetylacetonate dihydrate, zinc acetylacetonate hydrate, gallium acetylacetonate, titanium diisopropoxide bis(acetylacetonate), titanium(IV) isopropoxide, tributylborate, triethylborate, triethylphosphite, N-dodecyl-N,N-dimethyl-3-ammonium-1-propanesulfonate, 3-mercapto-1-propanesulfonic acid, sodium salt, 3-pyridinio-1-propanesulfonate, citric acid, triethylene diamine, piperazine, tetrabutylammonium hydrogensulfate, tetraethylammonium toluene sulfonate, tetrabutylammonium bromide, tetraethylammonium bromide, lithium acetylacetonate, lithium iodide, lithium perchlorate, lithium tetraphenylborate. In some embodiments, the amount of catalyst(s) added is about 0.001 wt % to about 1 wt %. In some embodiments, the amount of total accelerator(s), added is about 0.001 wt % to about 5 wt %. In some embodiments, the amount of total additive(s) added is about 0.001 wt % to about 30 wt %, preferably between about 0.01 wt % to about 10 wt %.

I. Modifiers can be added to the curable formulations before or after applying a curing and/or thermal aging processing step in order to modify physical properties and/or curing profiles of the uncured formulations, as well as the physical or thermomechanical properties of cured formulations thereof. Exemplary modifiers include, but are not limited to, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, 2-hydroxyethylacrylate, 2-carboxyethylacrylate, acrylic acid, thioglycolic acid, iso-tridecyl 3-mercaptopropionate, sodium thioglycolate, butyl glycidyl ether, 2-ethylhexyl glycidyl ether, limonene oxide, limonene dioxide, dicyclopentadiene dioxide, castor oil glycidyl ether, 2-amino-2-methyl-1-propanol, vinyl cyclohexene oxide, allyl isothiocyanate, isophorone diisocyanate, hexamethylene diisocyanate, trimethylhexamethylene diisocyanate, allyl isocyanate, 2-isocyanato acrylate, 2-isocyanate methacrylate, dicyclohexylmethane diisocyanate, tolylene diisocynate, diphenylmethane diisocyanate, bisphenol A ethoxylate diacrylate, bisphenol A ethoxylate diglycidyl ether, ethoxylated trimethylolpropane tris(3-mercaptopropionate), pentaerithritol tetrakis(polycaprolactone, mercaptopropionate terminated), polydimethylsiloxane, diglycidyl ether terminated, Mₙ 800, glycerol diacrylate, glycerol triacrylate, and allyl glycidyl ether. In some embodiments, modifiers include sand, polymer powders, hydroxyapatite nanopowder, tungsten powder, metal powders, ceramic powders.

In some embodiments, the amount of modifier(s) added is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, or 10.00 wt %.

In some embodiments, following a thermal aging step the formulations can be stored without degradation or without substantial degradation (i.e., less than about 20%, 15%, 10%, 9%, 8%, 7%, 6%, 5%, 4%, 3%, 2%, or 1% change in the any one or more properties of the material, as determined by known testing methods) over a period of time of about 1 day, to 5 days, to 10 days, to 20 days, to 30 days, to two months, three months, four months, five months, six months, one year, two years, three years, four years, five years, or longer.

In some embodiments, during or following a thermal aging step the formulations can be mixed with one or more other curable formulations as. In yet some other embodiments, during or following a thermal aging step the formulations can be mixed with one or more modifiers as described herein.

In some embodiments, combinations of one or more curable formulations with a cured material can be used to afford tunable viscosity, toughness, good biocompatibility, tunable biodegradation time in multiple environments, unique and differentiating adhesion capabilities to selected substrate surfaces, advanced material capabilities, including but not limited to, shape memory, and UV resistance.

In certain embodiments, the curable formulations have a viscosity between about 1.0 and 300.0 cP at about 20-25° C. In certain embodiments, the cured formulations alone or as composites further containing one or more modifiers have a viscosity between about 10 and 300.0 cP at about 20-25° C. In other embodiments, the cured formulations alone or as composites may have viscosities of 1000.0 cP, 5000.0 cP, or higher.

In certain embodiments, the cured formulations alone, or as composites thereof, demonstrate stable viscosities that do not increase after about 10 minutes, 1 hour, 1 day, 5 days, 10 days, 20 days, 30 days, 40 days, 60 days, 70 days, 80 days, 90 days, 100 days, or longer when stored at or near room temperature, optionally in light free conditions. In certain other embodiments, the cured formulations alone or as composites thereof demonstrate stable viscosities that do not increase when exposed to elevated temperatures of about 30° C. to 50° C., 30° C. to 60° C., 30° C. to 70° C., 30° C. to 80° C., 30° C. to 90° C., 30° C. to 100° C., or 30° C. to 150° C. for periods of time of between 0.1 hours to 100 hours.

In certain embodiments, the curable formulations or cured formulations therefrom, alone, as mixtures with other formulations, or containing one or more modifiers, are characterized by a Young's modulus between about 0.1 and about 4000 MPa, between about 10 and about 3000 MPa, between about 500 and about 2000 MPa, between about 1000 and about 2000 MPa, and between about 1500 and about 2000 MPa at around 20° C. The Young's modulus can be evaluated through mechanical testing such as compressive or tensile testing. The Young's modulus can be evaluated using a quasi-static load frame in tensile mode with uniaxial loading, testing a cast necked or dog-bone shaped sample. The Young's modulus is evaluated by calculating the slope of the linear region of the Stress-Strain graph, where Young's modulus E=G/c.

In certain embodiments, the material, formed from the curable formulations or cured formulations, is characterized by a covalent crosslinking density between about 15 and about 1000 mol/m³. The crosslinking density of a dynamic network material may be determined by using the formula n=E/3RT, where E is the Young's Modulus evaluated from the tensile test performed above the glass transition temperature, R is the ideal gas constant and T is temperature of the tensile test. In certain preferred embodiments, the material formed is characterized by a covalent crosslinking density between about 20-200 mol/m³, preferably, between about 30-150 mol/m³, and even more preferably between about 50-100 mol/m³. In other embodiments, the covalent crosslinking density is between about 1000-10000 mol/m³, preferably between about 3000-7000 mol/m³, and especially preferably between about 4000-6000 mol/m³. In other embodiments, the covalent crosslinking density is below about 15 mol/m³, preferably between about 0-10 mol/m³, even more preferably between about 0-5 mol/m³ and especially preferably between about 0-2 mol/m³. In certain embodiments, physical chemical interactions, such as a chain entanglement, interchain hydrogen bonding, chain alignment such as that seen in crystallization, supramolecular interaction such as the self-complementary hydrogen bonding exhibited by ureidopyrimidinone (UPy) or other molecular moeties, ionic or ionomeric crosslinking, slide-ring crosslinking (freely movable crosslinks), semi-interpenetrating networks formed by dispersion and/or dissolution of one substituent in a second crosslinked phase, or other crosslinking interactions are added in addition to or instead of covalent crosslinks. The crosslink may be formed by reaction of a pendant group in one strand with the backbone of a different strand, or by reaction of one pendant group with another pendant group. Crosslinks may exist between separate strand molecules and may also exist between different points of the same strand.

In some embodiments, the curable formulation may contain polymer chains with branches, loops, and other non-linear chain topologies. In some embodiments these chain topologies are formed through the inclusion of monofunctional and difunctional acrylics in a ratio of about 98:2, about 99:1, about 99.5:0.5, about 99.75:0.25, about 99.90:0.10, or about 99.95:0.05. In other embodiments these chain topologies are formed through the polymerization of monomers containing thiol functional groups and monomers containing alkene functional groups with an average monomer functionality of about 2.3, 2.2, 2.1, 2.05, 2.025, or 2.01. Average monomer functionality is determined by calculating the molar weighted average of the functionality of each monomer in a curable composition In some embodiments, the monomeric and/or oligomeric precursors include polythiols which are formed, at least in part, from a reaction between C═C— containing compound(s) and SH-containing compounds. Such reactions are often U V catalyzed but can also proceed under elevated temperature conditions, are highly efficient, tolerant of many functional groups, and capable of proceeding under mild conditions.

For example, the curable formulations can include one or more polythiol constituents obtained from mercaptan-containing terpenes (such as D-Limonene and/or L-Limonene, and/or derivatives or analogs thereof) and/or terpenoids. Exemplary polythiols derived from terpenes or terpenoids include, but are not limited to dipentene dimercaptan, isoprene dimercaptan, farnesene dimercaptan, farnesene trimercaptan, farnesene tetramercaptan, myrcene dimercaptan, myrcene trimercaptan, bisabolene dimercaptan, bisabolene trimercaptan, linalool dimercaptan, terpinolene dimercaptan, terpinene dimercaptan, geraniol dimercapan, citral dimercaptan, retinol dimercaptan, retinol trimercaptan, retinol tetramercaptan, beta-carotene polymercaptans, or combinations thereof. In some embodiments, the polythiols are derived from trimethylolpropane trithiol, pentaerithritiol trithiol, pentaerithritol tetrathiol, inositol di-, tri-, tetra-, penta- and hexathiols.

In yet other embodiments, the curable formulations can include one or more include polythiol constituents obtained from mercaptan-containing cyclic, polycyclic, or linear aliphatic polyalkenes or alkynes. Exemplary polythiols derived from these groups include, but are not limited to trivinyicyclohexene dimercaptan, trivinylcyclohexene trimercaptan, dicyclopentadiene dimercaptan, vinylcyclohexene dimercaptan, triallylisocyanurate dimercaptan, triallyl isocyanurate trimercaptan, phenylhepta-1,3,5-triyne polmercaptans, 2-butyne-1,4-diol dimercaptan, propargyl alcohol dimercaptan, dipropargyl sulfide polymercaptans, dipropargyl ether polymercaptans, propargylamine dimercaptan, dipropargylamine polymercaptans, tripropargylamine polymercaptans, tripropargyl isocyanurate polymercaptans, tripropargyl cyanurate polymercaptans.

In other embodiments, the curable formulations or cured formulation thereof can include one or more polythiol constituents obtained from mercaptan-containing, disulfide, unsaturated fatty acids or unsaturated fatty esters. Exemplary polythiols derived from these groups include, but are not limited to arachidonic acid dimercaptan, arachidonic acid trimercaptan, arachidonic acid tetramercaptan, eleostearic acid dimercaptan, eleostearic acid trimercaptan, linoleic acid dimercaptan, linolenic acid dimercaptan, linolenic acid trimercaptan, mercaptanized linseed oil, mercaptanized tung oil, mercaptanized soybean oil, mercaptanized peanut oil, mercaptanized walnut oil, mercaptanized avocado oil, mercaptanized sunflower oil, mercaptanized corn oil, mercaptanized cottonseed oil. In some embodiments, the amount of polythiol constituents in the curable formulations is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, 10.00 wt %, 12.50 wt %, 15.00 wt %, 17.50 wt %. 20.00 wt %, 25.00 wt %, 30.00 wt %, 35.00 wt % or 40.0 wt %.

In the embodiments, the curable formulations also include one or more alkene constituents such as, but not limited to, terpenes, terpenoids, dimerized terpenes or terpenoids, trimerized terpenes or terpenoids, oligomeric terpenes or terpenoids, polymerized terpenes or terpenoids, limonene, D-limonene, L-limonene, poly(limonene) having “n” repeat units wherein “n” is greater than n=2 and less than 500,000, farnesene, myrcene, bisabolene, linalool, terpinolene, terpinene, geraniol, citral, retinol, beta-carotene, triallyl isocyanurate, 1,2,4-trivinyl cyclohexane, poly(ethylene oxide) diallyl ether, norbomene functionalized poly(terpene) oligomers, norbornne-functionalized polydimethylsiloxane, norbornene-functionalized poly(butadiene), norbornene-functionalized polyisoprene oligomers, poly(isoprene) with having “n” repeat units wherein “n” is 2 or more and less than 500,000, poly(butadiene) having “n” repeat units wherein “n” is 2 or more and less than 500,000, divinyl ether, triallylamine, diallylamine, diallyl bisphenol A, cyclohexanedimethanol diallyl ether, pentaerithritol tetraallyl ether, trimethylolpropane triallyl ether, 2,4,6-Triallyloxy-1,3,5-triazine, inositoi diallyl ether, inositol triallyl ether, inositol tetraallyl ether, inositol pentaallyl ether, inositol hexaallyl ether, inositol divinyl ether, inositol trivinyl ether, inositol tetravinyl ether, inositol pentavinyl ether, inositol hexavinyl ether, triallyl citrate, trivinyl citrate, 1,5-cyclooctadiene, 1,3-cyclooxtadiene, 1,4-cyclooctadiene, 1,3-6 cyclooctatriene, cyclohexane diallyl ether, cyclohexane triallyl ether, cyclohexane tetraallyl ether, cyclohexane pentaallyl ether, cyclohexane hexaallyl ether, cyclohexane divinyl ether, cyciohexane trivinyl ether, cyclohexane tetravinyl ether, cyclohexane pentavinyl ether, cyclohexane hexavinyl ether, diclyclopentadiene, tricyclodecane dimethanol divinyl ether, tricyclodecane dirnethanol diallyl ether, tricyclodecane dimethanol, norbornene capped, bicyclo[2.2.1]hepta-2,5-diene, 1,2-bis(trimethylsiloxy)cyclo butene, norbornene-functionlized polyamide oligomers having “n” repeat units wherein “n” is 2 or more polyamide repeat units and less than 100,000 repeat units, allyl ether-functionlized polyamide oligomers having “n” repeat units wherein “n” is 2 or more polyamide repeat units and less than 100,000 repeat units, vinyl ether-functionalized polyamide oligomers having “n” repeat units wherein “n” is 2 or more polyarnide repeat units and less than 100,000 repeat units, norbornene-functionlized polydimethylsiloxane having “n” repeat units wherein “n” is 2 or repeat units and less than 100,000 repeat units, allyl ether-functionlized polydimethylsiloxane having “n” repeat units wherein “n” is 2 or repeat units and less than 100,000 repeat units, vinyl ether-functionlized polydimethylsiloxane having “n” repeat units wherein “n” is 2 or repeat units and less than 100,000 repeat units, allyloxy(polyethylene oxide), resorcinol diallyl ether, resorcinol divinyl ether, diallylamine, triallylamine, or allylamine. In some embodiments, the amount of alkene constituents in the curable formulations is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, 10.00 wt %, 12.50 wt %, 15.00 wt %, 17.50 wt %. 20.00 wt %, 25.00 wt %, 30.00 wt %, 35.00 wt % or 40.0 wt %.

The curable formulations can also include one or more acrylate or methacrylate-based constituents such as, but not limited to, neopentyl glycol diacrylate, glycerol diacrylate, glycerol triacrylate, ethylene glycol diacrylate, tetraethylene glycol diacrylate, trimethylolpropane triacrylate, tris[2-(acryloyloxy)ethyl] isocyanurate, pentaerithritol tetraacrylate, pentaerithritol triacrylate, ethoxylated trimethylolpropane triacrylate, ethyoxylated pentaerithritol triacrylate, ethoxylated pentaerithritol tetraacrylate, poly(dimethylsiloxane) diacrylate having “n” repeat units wherein “n” is 2 or more repeat units and less than 500,000 repeat units, poly(isoprene) diacrylate having “n” repeat units wherein “n” is 2 or more repeat units and less than 500,000 repeat units, poly(butadiene-co-nitrile) diacrylate having “n” repeat units wherein “n” is 2 or more butadiene repeat units and 2 or more nitrile repeat units and less than 500,000 butadiene repeat units and less than 500,000 nitrile repeat units, polyethyleneglycol diacrylate having “n” repeat units wherein “n” is greater than 2 repeat units and less than 500,000 repeat units, tricyclodecantedimethanol diacrylate, bisphenol A diacrylate, ethoxylated bisphenol A diacrylate having “n” repeat units wherein “n” is greater than 2 repeat units and less than 500,000 repeat units, and methacrylated equivalents thereof of the above listed constituents. In some embodiments, the amount of acrylate or methacrylate constituents in the curable formulations is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, 10.00 wt %, 12.50 wt %, 15.00 wt %, 17.50 wt %. 20.00 wt %, 25.00 wt %, 30.00 wt %, 35.00 wt % or 40.0 wt %.

The curable formulations can also include one or more epoxy-based constituents such as, but not limited to, epoxidized terpenes or terpenoids, epoxidized dimerized terpenes or terpenoids, epoxidized trimerized terpenes or terpenoids, epoxidized oligomeric terpenes or terpenoids or polymerized terpenes or terpenoids, limonene oxide, limonene dioxide, poly(limonene oxide) having “n” repeat units wherein “n” is 2 or more repeat units and less than 500,000 repeat units, poly(isoprene oxide)-co-polyisoprene copolymers having “n” repeat units wherein “n” is 2 or more repeat units and less than 500,000 repeat units, poly(butadiene oxide)-co-polybutadiene copolymers having “n” repeat units wherein “n” is 2 or more repeat units and less than 500,000 repeat units, epoxidized farnesene, epoxidized farnesene, epoxidized myrcene, epoxidized bisabolene, epoxidized linalool, epoxidized terpinolene, epoxidized terpinene, epoxidized geraniol, epoxidized citral, epoxidized retinol, epoxidized beta-carotene, epoxidized arachidonic acid, epoxidized eleostearic acid epoxidized linoleic acid, epoxidized linolenic acid, epoxidized linseed oil, epoxidized tung oil, epoxidized soybean oil, epozidized peanut oil, epozidized walnut oil, epoxidized avocado oil, epoxidized sunflower oil, epoxidized corn oil, epoxidized cottonseed oil, epoxidized palm oil, epoxidized glycerol, including glycerol diglycidyl ether and glycerol triglycidyl ether, epoxidized sorbitol, including sorbitol diglycidyl ether, sorbitol triglycidyl ether, sorbitol tetraglycidyl ether, sorbitol pentaglycidyl ether and sorbitol hexaglycidyl ether, cyclohexanedimethanol diglycidyl ether, resorcinol diglycidyl ether, bisphenol A diglycidyl ether, hydrogenated bisphenol A diglycidyl ether, neopentyl glycol diglycidyl ether, ethylene glycol diglycidyl ether, 1,4-butanediol diglycidyl ether, tetraethylene glycol diglycidyl ether, polydimethylsiloxane diglycidyl ether, epoxidized butadiene oligomers, epoxidized butadiene-co-polynitrile oligomers, epoxidized grapefruit mercaptan, ethoxylated bisphenol A diglycidyl ether having “n” repeat units wherein “n” is 2 or more repeat units and less than 500,000 repeat units, ethoxylated hydrogenated bisphenol A diglycidyl ether having “n” repeat units wherein “n” is 2 or more repeat units and less than 500,000 repeat units, ethoxylated cyclohexanedimethanol diglycidyl ether having “n” repeat units wherein “n” is 2 or more repeat units and less than 500,000 repeat units. In some embodiments, the amount of epoxy constituents in the curable formulations is about 0.50 wt %, 1.00 wt %, 1.50 wt %, 2.00 wt %, 2.50 wt %, 3.00 wt %, 3.50 wt %, 4.00 wt %, 4.50 wt %, 5.00 wt %, 6.00 wt %, 7.00 wt %, 8.00 wt %, 9.00 wt %, 10.00 wt %, 12.50 wt %, 15.00 wt %, 17.50 wt %. 20.00 wt %, 25.00 wt %, 30.00 wt %, 35.00 wt % or 40.0 wt %.

The curable formulations can also include one or more alkyne-based constituents such as, but not limited to, acetylene, propargyl alcohol, 2-butyne-1,4-diol, phenylhepta-1,3,5-triyne, dipropargyl sulfide, dipropargyl ether, propargylamine, dipropargylamine, tripropargylamine, tripropargyl isocyanurate, tripropargyl cyanurate, propargyl inositol, dipropargyl inositol, tripropargyl inositol, tetrapropargyl inositol, pentapropargyl inositol, hexapropargyl inositol, dipropargylpiperazine, dipropargyl citrate, tripropargyl citrate, cyclohexanedimethanol propargyl ether, cyclohexanedimethanol dipropargyl ether, quinic acid lactone propargyl ether, quinic acid lactone dipropargyl ether, quinic acid lactone tripropargyl ether, tricyclodecanedimethanol propargyl ether, tricyclodecanedimethanol dipropargyl ether, bisphenol A bis(propargyl ether), hydrogenated bisphenol A bis(propargyl ether), cyclohexane dipropargyl ether, cyclohexane tripropargyl ether, cyclohexane tetrapropargyl ether, cyclohexane pentapropargyl ether, cyclohexane hexapropargyl ether, propargyl resorcinol, dipropargyl resorcinol.

In certain embodiments, the curable formulations once cured can have unreacted, partially reacted, or fully reacted functional groups/substituents present therein. Exemplary functional groups include, but are not limited to, thiol, alkene, alkyne, hydroxyl, carboxylic acid, acrylate, isocyanate, isothiocyanate, amine, epoxy, diene/dienophile, alkyl halide, carboxylic acid anhydride, aldehyde and phenol groups.

In certain other embodiments, stable UV curable formulations with thiol/vinyl siloxane and thiol/vinyl silazane constituents are disclosed. Exemplary constituents of such formulations can include polythiol monomers and alkene monomers. For UV curable formulations with thiol/vinyl siloxane and thiol/vinyl silazane constituents, thermal stability of mixtures of polythiol and polyalkene monomers disclosed herein was assessed, and cured materials were subjected to thermomechanical and toughness assessments. The curable formulations disclosed herein exhibit superior thermal stability than other well-known thiol-ene formulations and also exhibit comparable or more rapid cure kinetics. Once cured, these materials can exhibit high toughness and excellent optical clarity. Thiol/vinyl siloxane polymer formulations, for example, can be cast into 1 mm thick film samples, and after photopolymerization were demonstrated to be able to be cut using common office scissors without chattering, a capabilitiy indicative of toughness and strain capacity greater than that of many analog commercially available photopolymers. The optical clarity of these thiol/vinyl siloxane and thiol/vinyl silazane photopolymers was observed to be superior to that of thiol-ene polymers made from commercially known thiol-ene monomers, which are used industrially in some cases as optical adhesives.

Exemplary polythiol monomers suitable for polymerization with vinyl silane, vinyl silazine, and other exemplary alkene monomers include, but are not limited to, linalool dimercaptan, terpinolene dimercaptan, terpinene dimercaptan, geraniol dimercapan, citral dimercaptan, dicyclopentadiene dimercaptan, norbornadiene dimercaptan, retinol dimercaptan, retinol trimercaptan, retinol tetramercaptan, beta-carotene polymercaptans, and combinations thereof, mercaptan-containing cyclic alkenes, tertiary mercaptans, including di- tri- tetra and polyfunctional tertiary mercaptans or mixed secondary and tertiary mercaptans, cycloaliphatic di- tri- tetra and polyfunctional tertiary mercaptans or mixed secondary and tertiary mercaptans, mercaptan-containing secondary cycloaliphatic alkenes, mercaptan containing polycyclic alkenes, or aliphatic alkenes selected from a group including trivinylcyclohexene dimercaptan, trivinylcyclohexene trimercaptan, cyclooctatetraene, cyclododecahexaene polymercaptans including tri- tetra- penta- and hexamercaptas, cyclic aliphatic hydrocarbons or other cyclic compounds containing n=1 to 100 mercaptan groups including cyclic aliphatic hydrocarbons containings secondary cycloaliphatic mercaptans, vinylcyclohexene dimercaptan, triallylisocyanurate dimercaptan, triallyl isocyanurate trimercaptan, dipentene dimercaptan, 1,5-cyclooctadiene dimercaptan, cyclooctyl, cycodecyl- and cyclooctadodecyl polymercaptans and combinations thereof. The mercaptan-containing alkyne can be phenylhepta-1,3,5-triyne polymercaptans, 2-butyne-1,4-diol dimercaptan, propargyl alcohol dimercaptan, dipropargyl sulfide polymercaptans, dipropargyl ether polymercaptans, propargylamine dimercaptan, dipropargylamine polymercaptans, tripropargylamine polymercaptans, tripropargyl isocyanurate polymercaptans, tripropargyl cyanurate polymercaptans, and combinations thereof. Mercaptan-containing fatty acids or fatty acid esters can be arachidonic acid dimercaptan, arachidonic acid trimercaptan, arachidonic acid tetramercaptan, eleostearic acid dimercaptan, eleostearic acid trimercaptan, linoleic acid dimercaptan, linolenic acid dimercaptan, linolenic acid trimercaptan, mercaptanized linseed oil, mercaptanized tung oil, mercaptanized soybean oil, mercaptanized peanut oil, mercaptanized walnut oil, mercaptanized avocado oil, mercaptanized sunflower oil, mercaptanized corn oil, mercaptanized cottonseed oil, and combinations thereof. Additional polythiols can be trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, Pentaerythritol tetrakis(3-mercaptobutylate), 1,4-bis (3-mercaptobutylyloxy) butane, 1,3,5-Tris(3-mercaptobutyloxethyl)-1,3,5-triazine-2,4,6(1H,3H,5H)-trione, ethylene glycol bis(3-mercaptoethyl ether), poly(ethylene glycol) dithiols with n=2 to 20,000 ethylene oxide repeat units, poly-amide-ester, carbonate, -urethane, -thioether, -imide -ether, -urea, -an hydride, olefininc and other-dithiols with n=2 to 20,000 ethylene oxide repeat units.

Exemplary alkene monomers can include, but are not limited to, pentavinylpentamethyl-cyclopentasiloxane, tetravinyltetramethylcyclotetrasiloxane, 1,3,5-trivinyl-1,3,5-trimethylcyclotrisilazane, vinylmethylsolozane oligomers, Mn=200 to 100,000, 1,3,5-trivinyl-1,3,5-trimethylcyclotrisoloxane, hexavinylhexamethylcyclohexasiloxane, octavinyloctamethylcyclooctasiloxane, octavintl-T8-silsesquioxane, triallyl isocyanurate, 2,4,6-triallyloxy-1,3,5-triazine, terpenes, terpenoids, dimerized terpene, dimerized terpenoids, trimerized terpenes, trimerized terpenoids, oligomeric terpenes or terpenoids, polymerized terpenes, polymerized terpenoids, limonene, D-limonene, L-limonene, poly(limonene), farnesene, myrcene, bisabolene, linalool, terpinolene, terpinene, geraniol, citral, retinol, beta-carotene, triallyl isocyanurate, 1,2,4-trivinyl cyclohexane, norbornene functionalized poly(terpene) oligomers, norbornene-functionalized polydimethylsiloxane, norbornene-functionalized poly(butadiene), norbornene-functionalized polyisoprene oligomers, poly(isoprene), divinyl ether, triallylamine, diallylamine, diallyl bisphenol A, cyclohexanedimethanol diallyl ether, pentaerithritol tetraallyl ether, trimethylolpropane triallyl ether, 2,4,6-triallyloxy-1,3,5-triazine, inositol diallyl ether, inositol triallyl ether, inositol tetraallyl ether, inositol pentaallyl ether, inositol hexaallyl ether, inositol divinyl ether, inositol trivinyl ether, inositol tetravinyl ether, inositol pentavinyl ether, inositol hexavinyl ether, triallyl citrate, trivinyl citrate, 1,5-cyclooctadiene, 1,3-cyclooxtadiene, 1,4-cyclooctadiene, 1,3-6 cyclooctatriene, cyclohexane diallyl ether, cyclohexane triallyl ether, cyclohexane tetraallyl ether, cyclohexane pentaallyl ether, cyclohexane hexaallyl ether, cyclohexane divinyl ether, cyclohexane trivinyl ether, cyclohexane tetravinyl ether, cyclohexane pentavinyl ether, cyclohexane hexavinyl ether, diclyclopentadiene, tricyclodecane dimethanol divinyl ether, tricyclodecane dimethanol diallyl ether, tricyclodecane dimethanol, norbornene capped, bicyclo[2.2.1]hepta-2,5-diene, norbornene-functionlized polyamide oligomers, allyl ether-functionlized polyamide oligomers, vinyl ether-functionalized polyamide oligomers, norbornene-functionlized polydimethylsiloxane, allyl ether-functionlized polydimethylsiloxane, vinyl ether-functionlized polydimethylsiloxane, resorcinol diallyl ether, resorcinol divinyl ether, diallylamine, triallylamine, allylamine, and combinations thereof. Neopentyl glycol diacrylate, glycerol diacrylate, glycerol triacrylate, ethylene glycol diacrylate, tetraethylene glycol diacrylate, trimethylolpropane triacrylate, tris[2-(acryloyloxy)ethyl]isocyanurate, pentaerithritol tetraacrylate, pentaerithritol triacrylate, ethoxylated trimethylolpropane triacrylate, ethyoxylated pentaerithritol triacrylate, ethoxylated pentaerithritol tetraacrylate, poly(dimethylsiloxane) diacrylate, poly(isoprene) diacrylate, poly(butadiene-co-nitrile) diacrylate, polyethyleneglycol diacrylate, tricyclodecantedimethanol diacrylate, bisphenol A diacrylate, ethoxylated bisphenol A diacrylate, and methacrylated equivalents thereof. Acetylene, propargyl alcohol, 2-butyne-1,4-diol, phenylhepta-1,3,5-triyne, dipropargyl sulfide, dipropargyl ether, propargylamine, dipropargylamine, tripropargylamine, tripropargyl isocyanurate, tripropargyl cyanurate, propargyl inositol, dipropargyl inositol, tripropargyl inositol, tetrapropargyl inositol, pentapropargyl inositol, hexapropargyl inositol, dipropargylpiperazine, dipropargyl citrate, tripropargyl citrate, cyclohexanedimethanol propargyl ether, cyclohexanedimethanol dipropargyl ether, quinic acid lactone propargyl ether, quinic acid lactone dipropargyl ether, quinic acid lactone tripropargyl ether, tricyclodecanedimethanol propargyl ether, tricyclodecanedimethanol dipropargyl ether, bisphenol A bis(propargyl ether), hydrogenated bisphenol A bis(propargyl ether), cyclohexane dipropargyl ether, cyclohexane tripropargyl ether, cyclohexane tetrapropargyl ether, cyclohexane pentapropargyl ether, cyclohexane hexapropargyl ether, propargyl resorcinol, dipropargyl resorcinol, and combinations thereof.

Built around the renewable chemistry of naturally-derived dipentene dimercaptan (DPDM), dicyclopentadiene, dicyclopentadiene dimercaptan, and other monomers, the compositions are stable, rapidly curing thiol-ene compositions. The observed low-reactivity in thiol-ene reactions of the endo secondary cycloaliphatic thiol of dipentene dimercaptan, dicyclopentadiene or other constituents in comparison with that of thiol chemistries found in previously reported thiol-ene studies is shown to be thermally stable in the presence of vinyl silane, vinyl siloxane and vinyl silazane chemical functionalities (and in in the presence of vinyl ether, allyl ether, and numerous other alkene chemistries) while also exhibiting sufficient UV polymerization kinetics to be processed using advanced manufacturing techniques such as DLP and SLA 3D printing when polymerized with vinyl silane, vinyl siloxane and vinyl silazane groups. Many commercially available polythiol monomers are highly reactive in the presence of alkene co-monomers and may be generally unsuitable for copolymerization with vinyl silane/siloxane/silazane co-monomers because of a lack of stability.

For UV curable formulations with thiol/vinyl siloxane and thiol/vinyl silazane constituents, representative formulations include approximately 50-99.99% stoichiometric thiol/ene comonomer mixtures with C═C:SH stoichiometric ratios varying from 5.00 to 0.10, 0.01 to 10.0% photoinitiator, 0.001 to 2.0% UV blocker or UV blocker blends and 0.01 to 1.0% free radical inhibitor.

In certain embodiments, the curable formulations, once cured, become polymers that exhibit solvent soluble or solvent degradable behavior. In certain embodiments, the curable formulations disclosed herein, once cured, become polymers that exhibit water soluble or water degradable behavior. In certain embodiments, the solvent soluble or solvent degradable formulations, once cured, become polymers that lack covalent crosslinking and have an average molecular weight in the range of about 5000 to about 5,000,000 g/mol. In other embodiments, the curable formulations become polymers with covalent crosslinks that degrade in solvent to yield polymers with an average molecular weight in the range of about 5000 to about 5,000,000 g/mol.

In certain embodiments, cured formulations will exhibit low swelling behavior when dissolving or degrading in a solvent, such as, but not limited to, water or organic solvents. The low swelling behavior is characterized by an increase in volume of the polymer during dissolution or degradation that is less than about 200% by volume, preferably less than about 50% by volume, more preferably less than about 10% by volume.

Solvent soluble or solvent degradable formulations include solvent soluble or degradable polymers cured using charge transfer free radical polymerization and/or charge transfer/chain growth hybrid free radical polymerization and/or methods of polymerization to form alternating copolymers for which exemplary curable constituents can include: (a) electron-poor and (b) electron rich co-monomers and combinations thereof, optionally adding (c) (meth)acrylated co-monomers and optionally adding constituents such as photoinitiators (listed under heading A.), light absorbing additives (listed under heading B.), free radical inhibitors (listed under heading C.), thermal free-radical initiators or amine catalysts (listed under heading D.), fillers (listed under heading E.), capping and/or chain transfer agents (listed under heading F.), plasticizers (listed under heading G.), catalysts/accelerators/additives (listed under heading H.) and/or modifiers (listed under heading I.).

(a) Electron Poor Monomers:

Exemplary electron poor monomers include, but are not limited to, maleimide, N-ethylmaleimide, N-methylmaleimide, N-phenylmaleimide, N-butanoic acid maleimide, other maleimides, maleic anhydride, dimethylmaleate, dimethylfumarate, 1,2-dicyanoethylene, vinylphosphonic acid, vinylsulfonic acid.

(b) Electron Rich Monomers:

Exemplary electron rich monomers include, but are not limited to, N-vinylformamide, N-vinyl pyrrolidone, N-methyl-N-vinylacetamide, N-vinylacetamide, N-vinylcaprolactam, N-vinylpthalimide, N-vinylimidazole, butyl vinyl ether, 2,3-dihydrofuran, 3,4-Dihydro-2H-pyran, and other vinyl ethers, vinyl acetate, benzofuran, indole, 1-Methylindole, styrene and styrene derivitaves, including 4-hydroxystyrene, stilbene and stilbene derivatives including hydroxylated stilbene compounds, 1-Pyrrolidino-1-cyclohexene, 1-Pyrrolidino-1-cyclopentene, 1-(Trimethylsilyloxy)cyclopentane, Vinylidene carbonate, 1-Morpholinocyclohexene, 1-Morpholinocyclopentene, 1-Pyrrolidino-1-cyclohexene, Phenyl vinyl sulfide, 9-Vinylcarbazole, and Trimethyl(vinyloxy)silane.

(c) (Meth)Acrylated Co-Monomers:

Exemplary (meth)acrylated co-monomers include, but are not limited to, acrylic acid, methacrylic acid, 2-carboxyethylacrylate, 2-hydroxyethylacrylate, 2-hydroxyethyl methacrylate, acrylamide, dimethylacrylamide, 2-hydroxyethyl acrylamide, 2-acrylamido-2-methyl-1-propanesulfonic acid, diacetone acrylamide, N-[3-(dimethylamino) propyl]methacrylamide, N-(isobutoxymethyl)acrylamide, N-(3-methoxypropyl)acrylamide, N-(3-ethoxypropyl)acrylamide, N-(3-ethoxypropyl)acrylamide, tetrahydrofuryl acrylate, 2-[[(butylamino)carbonyl]oxy]ethyl acrylate, poly(propylene glycol) acrylate, poly(ethylene glycol) methyl ether acrylate, 2-carboxyethyl acrylate oligomers, hydroxypropyl acrylate, 4-acryloylmorpholine, 3-sulfopropyl acrylate potassium salt, methoxymethyl acrylamide, methoxyethyl acrylamide, methoxybutyl acrylamide, ethoxyethyl acrylamide, ethoxymethyl acrylamide, ethoxypropyl acrylamide, propoxymethyl acrylamide, propoxyethyl acrylamide, diethyl acrylamide, dimethyl acrylamide, alkyl acrylamides, and tert-butyl acrylamide. These co-monomers can also include, but not be limited to, neopentyl glycol diacrylate, glycerol diacrylate, glycerol triacrylate, ethylene glycol diacrylate, tetraethylene glycol diacrylate, trimethylolpropane triacrylate, tris[2-(acryloyloxy)ethyl] isocyanurate, pentaerithritol tetraacrylate, pentaerithritol triacrylate, ethoxylated trimethylolpropane triacrylate, ethyoxylated pentaerithritol triacrylate, ethoxylated pentaerithritol tetraacrylate, poly(dimethylsiloxane) diacrylate, poly(isoprene) diacrylate, poly(butadiene-co-nitrile) diacrylate, polyethyleneglycol diacrylate, tricyclodecantedimethanol diacrylate, bisphenol A diacrylate, ethoxylated bisphenol A diacrylate, and methacrylated equivalents thereof.

For charge-transfer type linear polymers designed to form alternating copolymers in the presence of free radical initiators, representative formulations include 1:1 stoichiometric mixtures of electron-rich and electron poor co-monomers, an additional 1.1:1 to 10:1 stoichiometric excess of electron rich or electron poor monomer or co-monomers, 0.01 to 10 wt % photoinitiator, 0.01 to 2.0% a free radical inhibitor (see exemplary inhibitors listed elsewhere), and other additives in similar concentrations to those use in ionic crosslinker containing formulations or anhydride containing formulations.

In certain embodiments, solvent soluble or solvent degradable polymers can also include polymers containing ionic linkages cured using radical chain growth polymerization, including the various water soluble or water degradable polymers disclosed herein, for which exemplary constituents include (d) combinations of ionic/salt containing monomers/crosslinkers, (e) co-monomers that form water soluble polymers upon polymerization, and optionally adding constituents such as photoinitiators (listed under heading A.), light absorbing additives (listed under heading B.), free radical inhibitors (listed under heading C.), thermal free-radical initiators or amine catalysts (listed under heading D.), fillers (listed under heading E.), capping and/or chain transfer agents (listed under heading F.), plasticizers (listed under heading G.), catalysts/accelerators/additives (listed under heading H.) and/or modifiers (listed under heading I.).

(d) Combinations of Ionic/Salt Containing Monomers/Crosslinkers:

Exemplary ionic/salt-containing monomers and co-monomers include, but are not limited to, sodium acrylate, sodium methacrylate, and its hemihydrate, potassium acrylate, potassium methacrylate, and its hemihydrate, silver (I) methacrylate, lithium acrylate, lithium methacrylate, 3-sulfopropyl acrylate potassium salt, [2-(acryloyloxy) ethyl]trimethylammonium chloride, 2-acrylamido-2-methyl-1-propanesulfonic acid sodium salt, and 3-acrylamidopropyl trimethylammonium chloride.

Polyfunctional crosslinkers containing non-covalent internal linkages that exhibit chain growth polymerization cure kinetics generally consistent with those exhibited by covalent, polyfunctional chain growth monomers, include polyfunctional monomers tethered via metal coordination complexes and polyfunctional monomers tethered through ionic linkages formed via in situ acid/base reactions, or other associations.

Exemplary metal-containing monomers can include, but are not limited to, nickel(II) acrylate, hafnium(IV) acrylate, zinc(II) acrylate, zirconium(IV) carboxyethyl acrylate, zirconium(IV) acrylate, zirconium(IV) methacrylate, copper(II) acrylate, barium(II) acrylate, aluminum(III) acrylate, iron(III) acrylate, strontium(II) acrylate hydrate, magnesium(II) acrylate, calcium(II) acrylate, hafnium(IV) carboxyethyl acrylate, zirconium bromonorbornanelactone carboxylate triacrylate, zirconium methacrylate, zinc(II) methacrylate, zirconium(IV) oxo hydroxy methacrylate, lead(II) methacrylate, calcium methacrylate, neodymium methacrylate trihydrate, barium methacrylate, copper(II) methacrylate, copper(II) methacrylate monohydrate, europium(III) methacrylate, yttrium(III) methacrylate, iron(III) methacrylate, chromium(III) dichloride hydroxide-methacrylic acid aqua complex, magnesium methacrylate, copper(II) methacryloxyethylacetoacetonate, and aluminum(III) methacrylate.

Exemplary monofunctional monomers that possess acidic or basic functional groups and can become ionic/part of an ion pair as a result of protonation or deprotonation in an acid/base reaction, which can occur either by treatment with a different monomer or with an acid or a base additive, can include, but are not limited to N-vinylimidizole, acrylic acid, vinylphosphonic acid, vinylsulfonic acid, 2-acrylamido-2-methyl-1-propanesulfonic acid, 2-carboxyethyl acrylate oligomers, methacrylic acid, 2-carboxyethylacrylate, N-[3-(dimethylamino) propyl]acrylamide, N-[3-(dimethylamino) propyl]methacrylamide, 2-(dimethylamino)ethyl acrylate, 2-(dieethylamino)ethyl acrylate, and 4-vinylpyridine.
(e) Co-Monomers that Form Water Soluble Polymers Upon Polymerization, Such as by Radical Polymerization Processes:

Exemplary co-monomers can include, but are not limited to, acrylic acid, methacrylic acid, itaconic acid, itaconic anhydride, citraconic anhydride, maleic acid, fumaric acid, maleic anhydride, 1,2,3,6-Tetrahydrophthalic anhydride, 2-carboxyethylacrylate, 2-hydroxyethyl acrylate, 2-hydroxyethyl methacrylate, acrylamide, dimethylacrylamide, 2-hydroxyethyl acrylamide, 2-hydroxypropyl acrylamide, 2-hydroxypropyl methacrylamide, 2-acrylamido-2-methyl-1-propanesulfonic acid, diacetone acrylamide, 2-(methacryloyloxy)ethyl acetoacetate, mono-2-(acryloyloxy)ethyl succinate, mono-2-(methacryloyloxy)ethyl succinate, N-[3-(dimethylamino) propyl]acrylamide, 2-(dimethylamino)ethyl acrylate, N-[3-(dimethylamino)propyl]methacrylamide, N-(butoxymethyl)acrylamide, N-(isobutoxymethyl)acrylamide, N-(3-methoxypropyl)acrylamide, N-(3-ethoxypropyl)acrylamide, 2-(diethylamino)ethyl acrylate, hydroxy propyl acrylate, hydroxypropyl methacrylate, 2-hydroxy-3-phenoxypropyl acrylate, ethylene glycol phenyl ether acrylate, di(ethylene glycol) ethyl ether acrylate, di(ethylene glycol) 2-ethylhexyl ether acrylate, tetrahydrofurfuryl acrylate, 2-[[(butylamino)carbonyl]oxy]ethyl acrylate, poly(propylene glycol) acrylate, poly(ethylene glycol) methyl ether acrylate, dodecyl acrylate, 2-carboxyethyl acrylate oligomers, hydroxypropyl acrylate, 2-ethylhexyl acrylate, isobornyl acrylate, N-isopropylacrylamide, N-vinylformamide, N-vinyl pyrrolidone, N-methyl-N-vinylacetamide, N-vinylacetamide, 4-vinylpyridine, 4-acryloylmorpholine, N-vinylcaprolactam, N-vinylpthalimide, N-vinylimidazole, 3-sulfopropyl acrylate potassium salt, methoxymethyl acrylamide, methoxyethyl acrylamide, methoxybutyl acrylamide, ethoxyethyl acrylamide, ethoxymethyl acrylamide, ethoxypropyl acrylamide, propoxymethyl acrylamide, propoxyethyl acrylamide, N,N-diethyl acrylamide, dimethyl acrylamide, alkyl acrylamides, tert-butyl acrylamide, 2-(methacryloyloxy)ethyl acetoacetate, di(ethylene glycol) methyl ether methacrylate, 2-N-morpholinoethyl methacrylate, cyclohexyl methacrylate, ureido methacrylate, N-succinimidyl methacrylate, butyl methacrylate, isobutyl methacrylate, tert-butyl methacrylate, sec-butyl methacrylate, 2-(tert-butylamino)ethyl methacrylate, 2-(diethylamino)ethyl methacrylate, ethylene glycol methyl ether methacrylate and triethylene glycol methyl ether methacrylate, as well as monomers derived from the reaction of hydroxylated acrylates or methacrylates (such as, but not limited to, 2-hydroxyethyl acrylate, 2-hydroxyethyl methacrylate, 2-hydroxyethyl acrylamide, 2-hydroxypropyl acrylamide, 2-hydroxypropyl methacrylamide) with organic anhydrides (such as, but not limited to, cis-4-Cyclohexene-1,2-dicarboxylic anhydride, citraconic anhydride, cyclohexane-1,2-dicarboxylic anhydride, glutaric anhydride, itaconic anhydride, phthalic anhydride, succinic anhydride, trimellitic anhydride).

For solvent soluble UV curable formulations having ionic/salt monomers/crosslinkers, non-limiting representative formulations can, for example, include approximately 10.0 to 90.0% monofunctional acrylate or acrylamide monomers or co-monomer blends thereof, approximately 2.0 to 80.0% polyfunctional acrylate or acrylamide monomer or blends thereof, approximately 0.01 to 10.0% of a photoinitiator, approximately 0.001 to 2.0% of a light absorbing additive or light absorbing additive blends, approximately 0.01 to 1.0% of a free radical inhibitor and approximately 0.01 to 10% chain transfer/capping agent.

In certain embodiments, solvent degradable formulations can further include thiol-ene/anhydride hybrid network poylmers comprised of (f) alkene or (g) polythiol co-monomer combinations with internal solvent degradable linkages, including water-degradable anhydride linkages and optionally adding constituents such as photoinitiators (listed under heading A.), light absorbing additives (listed under heading B.), free radical inhibitors (listed under heading C.), thermal free-radical initiators or amine catalysts (listed under heading D.), fillers (listed under heading E.), capping and/or chain transfer agents (listed under heading F.), plasticizers (listed under heading G.), catalysts/accelerators/additives (listed under heading H.) and/or modifiers (listed under heading I.).

(f) Solvent-Degradable Alkene Monomers for Thiol-Ene Polymerization:

Exemplary alkene monomers include, but are not limited to, crotonic anhydride, methacrylic anhydride.

(g) Polythiol Monomers:

Exemplary polythiol co-monomers include, but are not limited to, Linalool dimercaptan, terpinolene dimercaptan, terpinene dimercaptan, geraniol dimercapan, citral dimercaptan, retinol dimercaptan, retinol trimercaptan, retinol tetramercaptan, beta-carotene polymercaptans, and combinations thereof. Mercaptan-containing cyclic alkenes, mercaptan-containing polycyclic alkene, or linear aliphatic alkene is selected from the group consisting of trivinylcyclohexene dimercaptan, cyclooctatetraene, cyclododecahexaene, trivinylcyclohexene trimercaptan, dicyclopentadiene dimercaptan, vinylcyclohexene dimercaptan, triallylisocyanurate dimercaptan, triallyl isocyanurate trimercaptan, dipentene dimercaptan, 1,5-cyclooctadiene dimercaptan, cyclooctyl, cycodecyl- and cyclooctadodecyl polymercaptans and combinations thereof, other mercaptans referenced herein. Mercaptan-containing alkyne is selected from the group consisting of phenylhepta-1,3,5-triyne polymercaptans, 2-butyne-1,4-diol dimercaptan, propargyl alcohol dimercaptan, dipropargyl sulfide polymercaptans, dipropargyl ether polymercaptans, propargylamine dimercaptan, dipropargylamine polymercaptans, tripropargylamine polymercaptans, tripropargyl isocyanurate polymercaptans, tripropargyl cyanurate polymercaptans, and combinations thereof. Mercaptan-containing fatty acids or fatty acid esters can be arachidonic acid dimercaptan, arachidonic acid trimercaptan, arachidonic acid tetramercaptan, eleostearic acid dimercaptan, eleostearic acid trimercaptan, linoleic acid dimercaptan, linolenic acid dimercaptan, linolenic acid trimercaptan, mercaptanized linseed oil, mercaptanized tung oil, mercaptanized soybean oil, mercaptanized peanut oil, mercaptanized walnut oil, mercaptanized avocado oil, mercaptanized sunflower oil, mercaptanized corn oil, mercaptanized cottonseed oil, and combinations thereof. Additional polythiols can be trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, Pentaerythritol tetrakis (3-mercaptobutylate), 1,4-bis (3-mercaptobutylyloxy) butane, and 1,3,5-Tris(3-melcaptobutyloxethyl)-1,3,5-triazine-2,4,6(1H,3H,5H)-trione.

In certain embodiments, solvent degradable formulations, including water degradable formulations, can also include materials prepared by radical polymerization processes from curable formulations including (h) solvent degradable organic anhydride crosslinkers, (i) co-monomers that form or react to form water soluble polymers upon polymerization and optionally adding constituents such as photoinitiators (listed under heading A.), light absorbing additives (listed under heading B.), free radical inhibitors (listed under heading C.), thermal free-radical initiators or amine catalysts (listed under heading D.), fillers (listed under heading E.), capping and/or chain transfer agents (listed under heading F.), plasticizers (listed under heading G.), catalysts/accelerators/additives (listed under heading H.) and/or modifiers (listed under heading I.).

(h) Solvent Degradable Organic Anhydride Crosslinkers:

Exemplary solvent degradable organic anhydride crosslinkers include, but are not limited to, crotonic anhydride, methacrylic anhydride.

(i) Co-Monomers that Form or React to Form Water Soluble Polymers Upon Polymerization:

Exemplary co-monomers that form or react to form water soluble polymers or increasingly water disperable polymers upon polymerization include, but are not limited to, those previously listed in section (e).

For hydrolysable chain growth network polymers made with internal anhydride linkages, representative formulations can include 20-90 wt % monofunctional chain growth monomer, 10 to 90% anhydride-containing crosslinker, 1.01 to 10.0, 0.01 to 10 wt % photoinitiator, 0.01 to 1.0% free radical inhibitor, and other additives in similar concentrations to those use in ionic crosslinker containing formulations. For hydrolysable step growth network polymers made with internal solvent degradable linkages, representative formulations can include 20-90 wt % solvent degradable monomer, 10 to 40% solvent degradable monomer, 1.01 to 10.0, 0.01 to 10 wt % photoinitiator, 0.01 to 1.0% free radical inhibitor, and other additives in similar concentrations to those use in ionic crosslinker containing formulations. In some embodiments the solvent degradable linkages may include ester, beta-aminoester, anhydride, carbonate, or silyl ether linkages.

In certain embodiments, solvent degradable formulations, including water degradable formulations, can also include materials prepared by radical polymerization processes from curable formulations including (j) solvent degradable boron-based crosslinkers, (k) co-monomers that form or react to form water soluble polymers upon polymerization, and optionally adding constituents such as photoinitiators (listed under heading A.), light absorbing additives (listed under heading B.), free radical inhibitors (listed under heading C.), thermal free-radical initiators or amine catalysts (listed under heading D.), fillers (listed under heading E.), capping and/or chain transfer agents (listed under heading F.), plasticizers (listed under heading G.), catalysts/accelerators/additives (listed under heading H.) and/or modifiers (listed under heading I.).

(j) Solvent Degradable Boron-Based Crosslinkers:

Exemplary solvent degradable boron-based crosslinkers include, but are not limited to:

(j.1) borate esters of the form B(OR)₃, where the B—O bonds constitute hydrolysable linkages and R is any substituent containing C═C functional groups capable of participating in free radical polymerization. Examples of such borate esters include, but are not limited to, (boranetriyltris(oxy))tris(ethane-2,1-diyl) triacrylate, tris(2-acrylamidoethyl) borate, tris(acrylamidomethyl) borate, (boranetriyltris(oxy))tris(methylene) triacrylate, (boranetriyltris(oxy))tris(propane-3,1-diyl) triacrylate, tris(3-acrylamidopropyl) borate, (boranetriyltris(oxy))tris(propane-3,1-diyl) tris(2-methylacrylate), (boranetriyltris(oxy))tris(ethane-2,1-diyl) tris(2-methylacrylate), (boranetriyltris(oxy))tris(methylene) tris(2-methylacrylate). Further examples include borate esters obtained via condensation of boric acid with 3 equivalents of alcohol that also contains a C═C functionality such as, but not limited to, geraniol, terpineol, linalool, retinol, propargyl alcohol.

(j.2) Boronate esters of the form R′—B(OR)₂, where the B—O bonds constitute hydrolysable linkages, R′ can be any alkyl, aryl, heteroaryl, alkylaryl, or heterocyclic substituent, and R is any substituent containing C═C functional groups capable of participating in free radical polymerization. Such boronate esters include, but are not limited to, the compounds produced via condensation of one molecule of boronic acid R′—B(OH)₂, where R′ can be any alkyl, aryl, heteroaryl, alkylaryl, or heterocyclic substituent, with 2 equivalents of alcohol (ROH) that also contains a C═C functionality such as, but not limited to, geraniol, terpineol, linalool, retinol, propargyl alcohol, 2-hydroxyethylacrylate, 2-hydroxymethylacrylate, 2-hydroxypropylacrylate, 2-hydroxyethylmethacrylate, 2-hydroxymethylmethacrylate, 2-hydroxypropylmethacrylate, 2-hydroxyethylacrylamide, 2-hydroxymethylacrylamide, 2-hydroxypropylacrylamide.

(j.3) Boroxines or boronic anhydrides of the form (R—BO)₃, where the B—O bonds constitute hydrolysable linkages and R can be any alkyl, aryl, heteroaryl, alkylaryl, or heterocyclic substituent containing C═C functional groups capable of participating in free radical polymerization. These boroxines may be derived by condensation of the corresponding boronic acids R—B(OH)₂ or through other means. Examples of boroxines include, but are not limited to, those derived from the following boronic acids: trans-2-Chloromethylvinylboronic acid, cis-1-Propen-1-ylboronic acid, trans-1-Propen-1-ylboronic acid, 2,2-dimethylethenylboronic acid, But-3-enylboronic acid, cyclopenten-1-ylboronic acid, 1-Pentenylboronic acid, 3-Methyl-2-buten-2-ylboronic acid, 4-Pentenylboronic acid, Vinylboronic acid, 1-cyclohexen-1-yl-boronic acid, 4-Methyl-1-pentenylboronic acid, 5-Hexenylboronic acid, 1-cyclohepten-1-ylboronic acid, 4-methyl-1-cyclohexen-1-ylboronic acid, trans-1-Heptenylboronic acid, trans-2-(4-Chlorophenyl)vinylboronic acid, trans-2-(3-Fluorophenyl)vinylboronic acid, trans-2-(4-Fluorophenyl)vinylboronic acid, 1-Phenylvinylboronic acid, trans-2-Phenylvinylboronic acid, 4,4-dimethylcyclohexen-1-ylboronic acid, trans-(2-Cyclohexylvinyl)boronic acid, trans-1-Octen-1-ylboronic acid, trans-2-[4-(Trifluoromethyl)phenyl]vinylboronic acid, trans-2-(4-Methylphenyl)vinylboronic acid, trans-3-Phenyl-1-propen-1-ylboronic acid, trans-2-(4-Methoxyphenyl)vinylboronic acid, (1S)-1,7,7-trimethylbicyclo[2.2.1]hept-2-en-2-ylboronic acid, 4-tert-Butylcyclohexen-1-ylboronic acid, trans-2-(4-Biphenyl)vinylboronic acid, 4,4-(dimethylcyclohex-2-en-1-one)-2-boronic acid, 4-(2-Nitrovinyl)phenylboronic acid, 2-Vinylphenylboronic acid Aldrich, 3-Vinylphenylboronic acid, 4-Vinylphenylboronic acid, 4-(trans-2-Carboxyvinyl)phenylboronic acid, 3-(Acrylamido)phenylboronic acid.

(k) Co-Monomers that Form or React to Form Solvent Soluble Polymers Upon Polymerization:

Exemplary co-monomers that form or react to form solvent soluble polymers upon polymerization solvent degradable crosslinkers include, but are not limited to those previously listed in section (e).

In certain embodiments, solvent degradable formulations, including water degradable formulations, can also include materials prepared by radical polymerization processes from curable formulations including (1) solvent degradable organic crosslinkers, (m) co-monomers that form or react to form water soluble polymers upon polymerization, and optionally adding constituents such as photoinitiators (listed under heading A.), light absorbing additives (listed under heading B.), free radical inhibitors (listed under heading C.), thermal free-radical initiators or amine catalysts (listed under heading D.), fillers (listed under heading E.), capping and/or chain transfer agents (listed under heading F.), plasticizers (listed under heading G.), catalysts/accelerators/additives (listed under heading H.) and/or modifiers (listed under heading I.).
(l) Solvent Degradable Organic Crosslinkers:

Exemplary solvent degradable organic crosslinkers include, but are not limited to:

(l.1) Acetals and hemiacetals, which can be isolated or formed in situ when preparing curable formulations through the reaction of monomers containing aldehyde or ketone functionalities with diols or polyols (polyfunctional alcohols), or the reaction of alcohol containing monomers with di or polyfunctional aldehydes or ketones, or the reaction of alchohol containing monomers with vinyl ethers. Examples of constituents that can participate in the formation of acetal or hemiacetal based crosslinkers include, but are not limited to 2-hydroxyethylacrylate, 2-hydroxymethylacrylate, 2-hydroxypropylacrylate, 2-hydroxyethylmethacrylate, 2-hydroxymethylmethacrylate, 2-hydroxypropylmethacrylate, 2-hydroxyethylacrylamide, 2-hydroxymethylacrylamide, 2-hydroxypropylacrylamide, diacetone acrylamide, crocetin dialdehyde, 2,5-furandicarboxaldehyde, 4-formylcynnamic acid, 2-formylcynnamic acid, methyl 4-formylcynnamate, Glyoxal, Malondialdehyde, Succindialdehyde, Glutaraldehyde, Phthalaldehyde, 1,4-Butanediol divinyl ether, 1,4-Cyclohexanedimethanol divinyl ether, Di(ethylene glycol) divinyl ether, Tri(ethylene glycol) divinyl ether, Poly(ethylene glycol) divinyl ether (Mn from about 200 to 5000), inositol divinyl ether, inositol trivinyl ether, inositol tetravinyl ether, cyclohexane divinyl ether, cyclohexane trivinyl ether, cyclohexane tetravinyl ether, tricyclodecane dimethanol divinyl ether, resorcinol divinyl ether, ethylene glycol, resorcinol, glycerol, sorbitol, polyethylene glycol (Mn from about 200 to 10,000).

(l.2) Thioacetals and thiohemiacetals, which can be isolated or formed in situ when preparing curable formulations through the reaction of monomers containing aldehyde or ketone functionalities with dithiols or polythiols. Examples of constituents that can participate in the formation of thioacetal or hemithioacetal based crosslinkers include, but are not limited to, diacetone acrylamide, crocetin dialdehyde, 2,5-furandicarboxaldehyde, 4-formylcynnamic acid, 2-formylcynnamic acid, methyl 4-formylcynnamate, 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), Pentaerythritol tetrakis (3-mercaptobutylate), 1,4-bis (3-mercaptobutylyloxy) butane, and 1,3,5-Tris(3-mercaptobutyloxethyl)-1,3,5-triazine-2,4,6(1H,3H,5H)-trione.
(m) Co-Monomers that Form or React to Form Water Soluble Polymers Upon Polymerization:

Exemplary co-monomers that form or react to form water soluble polymers upon polymerization include, but are not limited to those previously listed in section (e).

Kits

The curable formulations described above may be sold as part of a kit which includes instructions on how to use the curable formulation for a given application (see below). Preferably the curable formulations of a kit are contained in containers that protect the formulations from light and moisture until time of use. In some embodiments of the kit, the instructions include details on how to handle/store the formulation(s), 3-D print the formulation(s), cast molds or films of the formulation(s), cure the formulation(s), and how to dissolve the formulation(s) in a particular solvent or water or mixtures thereof. In some embodiments the kit may contain one or more additives (as described above) and/or initiators or inhibitors (as described above) which are in separate containers from the formulation(s) and which may be mixed into the curable formulation(s) prior to use/application/printing.

In some embodiments, the kits can also include hardware, software (such as software code that controls hardware), material systems integration systems, to form articles of manufacture made from the curable compositions.

### III. Methods of Making Curable and Cured Formulations

In some embodiments, the methods of making the aforementioned are low waste methods that generally do not require any or any significant purification of the formulations, composites, or of reaction products therein. The curable or cured formulations, composites, and other compositions thereof formed from the precursors as described above and as shown in the examples generally proceed in additive “one pot” steps. In some embodiments, these methods do not require the presence of any added solvents. In certain other embodiments, the methods of making the formulations, described below, include use of one or more aqueous or organic solvents, or combinations thereof which can be removed, as needed.

In certain embodiments of the methods, a variety of building block precursors, as described above and in the examples, can be derived from renewable feedstocks. These building blocks have reactive groups, such as, but not limited to, thiols, amines, that allow them to undergo addition reactions with reactive groups, such as C═C, present in other building blocks under appropriate reaction conditions. Such chemistries include, but are not limited to, thiol-ene/thiol-yne/thiol-acrylate thermally induced free radical addition chemistry, that can be used to build molecular weight between thiol- and alkene/acrylate/alkyne-functionalized and epoxy-containing constituents. In certain embodiments, the reactions can include an initiator, such as, but not limited to, a thermal free radical initiator, such as AIBN, or a photoinitiator such as DMPA or TPO, which can be used in the presence of heat/UV to produce monomers, oligomers or polymers which will not or are not cured products and will remain stable until additional reagents are added to induce curing. Curing reactions can be used to form a fully crosslinked network polymer or a substantially crosslinked network polymer, wherein substantially refers to a percentage of functional group conversion of at least about 60%, 80%, 90%, 91%, 92%, 93%, 94%, 95%, 96%, 97%, 98%, or 99% or >99%. In other embodiments, base catalyzed thiol-epoxy, thiol-acrylate, amine-epoxy and other similar reactions can afford alternative routes to constructing monomers/oligomers/polymers as. Other chemistries which can also be used to construct monomers/oligomers/polymers before curing include, but are not limited to, acrylate-amine and thiol-acrylate Michael Additions and isocyanate and isothiocyanate reactions with hydroxyl, thiol, amine, and other related groups.

A non-limiting exemplary method of making a curable formulation includes the steps of:

(a) mixing a polythiol constituent; an alkene-containing and/or alkyne-containing constituent; and an epoxy-containing constituent, wherein the polythiol comprises at least three thiol groups; and

(b) thermally aging the mixture.

In some other embodiments, the method of making the curable formulation further comprises the addition of one or more modifiers (see subsection J. above) to the mixture of step (a) prior to step (b) or during step (b), where the one or more modifiers can be sand, polymer powders, hydroxyapatite nanopowder, tungsten powder, metal powders, ceramic powders, and combinations thereof. In some embodiments, ceramic powders used may include silicon carbide, silicon oxide, silicon oxycarbide, silicon nitride, silicon oxynitride, aluminum oxide, hydroxyapatite, boron nitride, boron carbide, aluminum carbine, tungsten carbide, zirconium oxide, zirconium carbide

In non-limiting embodiments, the thermal aging step (step (b)) includes the application of heat to the mixture at a temperature within a range between about 0° C. to about 150° C., 10° C. to about 100° C., 20° C. to about 100° C., and 20° C. to about 75° C. The thermal aging step can be applied for a suitable period of time of between about 0.01 hours to about 72 hours, about 0.01 hours to about 20 hours, about 0.01 hours to about 15 hours, about 0.01 hours to about 10 hours, about 0.01 hours to about 5 hours, about 0.01 hours to about 3 hours, about 0.01 hours to about 2 hours, or about 0.01 hours to about 1 hour. In certain instances, the thermal aging step includes the application of agitation to the mixture during all of step (b) or at least some portion of step (b). In certain embodiments, prior to or during the thermal aging step one can optionally include the addition of plasticizer(s), as described above, which remain in the final cured compositions.

In certain embodiments, following the thermal aging step, the resulting curable formulation can be stored and remain stable under storage conditions, such as storage in the dark around 20° C., in the dark around 4° C., or in the dark around −20° C., for periods of time up to about 6 hours −12 months, up to about 1, 2, 3, 4, 5 years or longer. Preferably, the curable formulation can be stored for at least 1 day in the dark around 20° C.

For certain embodiments, the curable formulations are uncured as synthesized and additional chemicals can be added to allow or promote curing and an additional step of curing (step (c)) is performed. In some embodiments, the mixture of step (a) further includes free radical initiators, catalysts, or additives that can controllably (i.e., by exposure to an external stimulus) induce or promote curing of the formulation. Exemplary curing processes include, but are not limited to, UV curing, electron beam curing, thermal curing capability, acid and base catalyzed curing and polycondensation reactions. Curing reactions can be used to fully cure or a substantially cure the formulations, wherein substantially refers to a percentage of functional group conversion of at least about 20%, 30%, 40%, 50%, 60%, 70%, 80%, 85%, 90%, 91%, 92%, 93%, 94%, 95%, 96%, 97%, 98%, 99%, or 99.9%. Such processes can generally proceed in additive one-pot steps and do not require any purification or any significant purification after reaction completion. Exemplary reactions which may occur during curing such as thiol-ene/thiol-yne/thiol-acrylate, allyl, vinyl and other chemistries allow for reactions to occur under UV, e-beam, and thermally driven reaction conditions, thiol-epoxy, thiol-acrylate, amine-epoxy, as well as other base-catalyzed reactions that can be processed with or without heating, Michael additions that include acrylate-amine and thiol-acrylate reactions, isocyanate and isothiocyanate reactions with hydroxyl, thiol, amine and other groups. In a UV-based curing step, irradiation energies ranging from 0.15 mJ/cm² to 100 J/cm² for a period of time in the range of 0.01 seconds to 1 hour can be applied to the curable formulations or mixtures thereof containing a suitable photoinitiator.

For other embodiments, the curable formulations are uncured as synthesized and additional chemicals can be added to allow or promote curing upon standing for a period of time. It is believed that the addition of chemical agents, such as acid or base catalysts, can promote crosslinking chemistries that result in a cured material over time. As will be appreciated by one skilled in the art, the time required to achieve complete or high degree of curing (such as more than 90% curing) will depend on the amount of chemical agents added and the nature of the reaction chemistries which occur in the formulation.

In certain embodiments, solvent or water soluble formulations are prepared according to various methods. For example:

In one embodiment, to prepare curable blends of water soluble UV curable polymers, monofunctional chain growth co-monomers, free radical inhibitor and polyfunctional ionic acrylate crosslinkers (or acid/base monofunctional constituents capable of assembling in situ to form polyfunctional crosslinkers) were massed in a container, such as in sealable polypropylene FlackTek mixing cups, and mixed, for example using a FlackTek DAC150 centrifugal speed mixer at about 100 to 5000 RPM, 100 to 4000 RPM, 100 to 3500 RPM, 100 to 3000 RPM, 100 to 2000 RPM, 100 to 1000 RPM, or at least about 5000 RPM, 4000 RPM, 3500 RPM, 3000 RPM, 2000 RPM, or 1000 RPM, for at least about 0.1 to 30 minutes, 0.1 to 20 minutes, 0.1 to 10 minutes, 0.1 to 5 minutes, and more preferably at least about 3 minutes. The mixtures were then placed an oven pre-heated to a temperature in the range of between about 20° C. to 120° C.; or to a temperature of at least about 50° C., 60° C., 70° C., 80° C., or 90° C. The mixtures can be shaken or stirred at 1 to 50, 1 to 40, 1 to 30, 1 to 20, 1 to 15, 1 to 10, or 1 to 5 RPM for at least about 0.1 to 30 minutes, 0.1 to 20 minutes, 0.1 to 10 minutes, 0.1 to 5 minutes, and more preferably at least about 5 minutes. In a non-limiting example, mixing in a FlackTek speed mixer at 3000 RPM plus heating at 80° C. for 5-15 min is considered one “Mixing Cycle.” The mixing speed of a mixing cycle can be within a range of 100 to 5000 RPM, 100 to 4000 RPM, 100 to 3000 RPM, 100 to 2000 RPM, 100 to 1000 RPM, or, more preferably, at least 3000 RPM, 2000 RPM, or 1000 RPM. The mixing time of a mixing cycle can be for at least about 0.1 to 30 minutes, 0.1 to 20 minutes, 0.1 to 15 minutes, 0.1 to 10 minutes, 0.1 to 5 minutes, and more preferably at least about 15 minutes, 10 minutes, or 5 minutes. The mixing cycle temperature to which the mixture is heated to or the pre-heated temperature of an oven into which a mixture can be placed into can be a temperature in the range of between about 50° C. to 120° C.; or to a temperature of at least about 50° C., 60° C., 70° C., 80° C., 90° C. Generally, 2-50, 2-40, 2-30, 2-20, 2-10, or 2-5 Mixing Cycles are carried out to dissolve the inhibitor, polyfunctional ionic acrylates and/or acid/base monofunctional constituents. After dissolution of ionic constituents and free radical inhibitor, light absorbing additives can be added and dissolved using approximately 4-10 Mixing Cycles. After dissolution of light absorbing additives, photoinitiator can be added and dissolved using approximately 3 mixing cycles. After dissolution of photoinitiator, chain transfer/capping agents can be added in a final step and mixed at 100 to 5000 RPM, preferably at least 3000 RPM, for at least about 0.1 to 30 minutes, 0.1 to 20 minutes, 0.1 to 10 minutes, 0.1 to 5 minutes, and more preferably at least about 3 minutes optionally without subsequent heating. The Final Prepared mixtures can be referred to as “Resins.”

In other embodiments, curable blends of water soluble UV curable polymers, monofunctional chain growth co-monomers, free radical inhibitor and polyfunctional ionic crosslinkers (or acid/base monofunctional constituents capable of assembling in situ to form polyfunctional crosslinkers) sre massed in a container, such as a glass reaction vessel, and stirred using an appropriate mixing method, such as using a magnetic stir bar and stir plate, or using an overhead mechanical mixer, for example, a Scilogix LED Digital Overhead Stirrer equipped with a PTFE Coated Impeller with a 3.5″ Blade Diameter. The consituents are mixed at a rate between 200 rpm and 3000 rpm, preferably at least 500 rpm, more preferably at least 1500 rpm. The mixing is done at a temperature between 0° C. and 150° C., preferably between 10° C. and 80° C., more preferably between 20° C. and 40° C. Mixing times vary between 10 minutes and 48 hours, preferably between 1 hour and 12 hours. Once these consituents form a homogeneous mixture, other constituents such as light absorbing additives, photoinitiators and capping/chain transfer agents are added to the main container, either all in one step or stepwise, allowing for additional mixing time between additions. The formulation is mixed at a rate between 200 rpm and 3000 rpm, preferably at least 500 rpm, more preferably at least 1500 rpm, and at a temperature between 0° C. and 150° C., preferably between 10° C. and 80° C., more preferably between 20° C. and 40° C. Mixing times vary between 10 minutes and 48 hours, preferably between 1 hour and 12 hours. The Final Prepared mixtures can be referred to as “Resins.”

In other embodiments, UV curable solvent (such as water) soluble linear polymers are prepared from monomers capable of undergoing charge transfer polymerization, or other polymerization processes that form alternating copolymers in which electron rich and electron poor consituents alternate in macromolecular chain segments, solid (often electron poor) monomers can be dissolved in 1.0 stoichiometric equivalents of liquid (often electron rich) co-monomers, with additional electron rich co-monomers being added to facilitate dissolution of the solid constituents. Free radical inhibitor, photoinitiator and light absorbing additives can be added to liquid electron rich co-monomers in the same addition step as the solid electron-poor constituents, and the solids are dissolved using 2-10 mixing cycles. After dissolution of solids, homogeneous mixtures can be stored in dark, moisture free environments.

In other embodiments, in order to prepare hydrolysable thiol-ene network polymers made with internal anhydride linkages, photoinitiator, free radical inhibitor and light absorbing additives are dissolved in polythiol co-monomers using 2-4 Mixing Cycles (see above) in optionally flame dried amber glassware. These solutions can be cooled to ambient temperature, after which alkene co-monomers can be added, and the thiol-ene mixtures can be stored in light-free environments under desiccation.

In other embodiments, hydrolysable covalently crosslinked chain growth polymers made with internal anhydride linkages, photoinitiator, free radical inhibitor, thermoplastic additives and light absorbing additives can be dissolved in chain growth monofunctional monomers using 2-4 Mixing Cycles (see above), optionally flame dried amber colored glassware. These solutions can be cooled to ambient temperature, after which anhydride crosslinkers can be added, and the thiol-ene mixtures can be stored in light-free environments under desiccation.

In other embodiments, curable thiol/vinyl siloxane and thiol/vinyl silazane compositions described are prepared such that all solids in each composition can be first dissolved in polythiol constituents, after which vinyl siloxane or vinyl silazane constituents can be added.

In certain instances, the curable formulations are prepared in the absence of any external heat application. The curable formulations can be prepared as “neat” curable formulations (i.e., from the constituents of the formulation alone) or as substantially solvent-free curable formulations (i.e., where the curable formulation is prepared and contains less than 10%, 9%, 8%, 7%, 6%, 5%, 4%, 3%, 2%, 1% by weight of solvent(s) which are not constituents of the curable formulation).

### IV. Methods of Using Curable Formulations and Articles of Manufacture Thereof

The curable formulations permit for their use in methods of manufacture. Methods are used to manufacture materials from the curable formulations are significantly influenced by material processing capability, and processing capability often refers to a material's ability to be successfully and efficiently subjected to various methods of manufacture.

The curable formulations and cured formulations thereof can also be used in processes for fabricating articles from these compositions, and articles fabricated from these compositions.

In some embodiments, the curable formulations can be used to form films and/or slabs on substrates using known techniques. In a non-limiting embodiment, a thermally or chemically curable formulation or mixture thereof can be deposited into a mold and cured at a temperature in the range of about 10° C. to about 150° C., 20° C. to about 130° C., 20° C. to about 120° C., 20° C. to about 100° C., 20° C. to about 75° C., 20° C. to about 50° C. The curing time applied may be from about 10 seconds to 10 days, 10 seconds to 5 days, 10 seconds to 3 days, 10 seconds to 2 days, 10 seconds to 1 day, 10 seconds to 10 hours, 10 seconds to 5 hours, 10 seconds to 1 hours, 10 seconds to 50 minutes, 10 seconds to 40 minutes, 10 seconds to 30 minutes, 10 seconds to 20 minutes, 10 seconds to 10 minutes, 10 seconds to 5 minutes, 10 seconds to 4 minutes, 10 seconds to 3 minutes, 10 seconds to 2 minutes, or 10 seconds to 1 minute.

In some embodiments, composites can be formed from the curable formulations by addition of modifiers and/or fillers as described above. In a non-limiting embodiment, a curable formulation or mixture thereof can be mixed with a modifier and/or filler (e.g. fumed silica) to produce a mixture or dispersion which is then cured under appropriate conditions as described herein. The mixtures can also be used as inks for printing processes as described below.

Curable formulations, mixtures thereof, and composites thereof (which contain modifiers and/or fillers) can be used as inks for a variety of printing applications, such as 3-D printing. In one embodiment, a printing method can include the steps of:

(a) printing a curable formulation; and

(b) curing the printed formulation

wherein the curing step can be performed simultaneously with the printing of the curable formulation of step (a).

In such embodiments, the curable formulation further comprises an initiator or catalyst which can be decomposed by an external stimulus (i.e., light or heating) to induce curing. In such embodiments, the printing can be performed using known techniques such as, but not limited to, stereolithographic additive printing, digital light processing printing, an inkjet printing apparatus, a photojet printing, or a direct write process.

In certain 3-D printing embodiments, the printing step of the method includes jetting the curable formulation into one or more powders such as sand, polymer powders, hydroxyapatite powders, and tungsten powders which then harden into powder-rich composite materials. Hardening time can be tuned by varying the amount of initiator or catalyst concentration in the formulation. Composite materials with geometric configurations patterned by inkjet deposition can also be cured around powder particles and then removed from the powder-containing glass trays. These patterned composites could then be built upon by further printing (for 3D inkjet additive manufacturing process) if desired and/or subsequently utilized in a wide number of processing techniques.

Advantages of the jettable formulations are the lower toxicities of uncured formulations, as compared to analogous resins like furan-based resins and certain phenolic resins, the excellent wetting to a number of substrates after jetting (wetting is believed to be in part facilitated by sulfur constituency), tunable cure time based on catalyst concentration for powder/catalyst blends onto which resins are jetted, and superior stability in comparison with other epoxy based resins (for example, an epoxy-amine control resin comprised of neopentyl glycol diglycidyl ether and xylylene diamine underwent a substantial viscosity increase at 20° C. only 1-2 h after mixing of epoxy and amine constituents and was consequently shown to be unsuitable for inkjet processing). Additional polythiol monomers that could be used for the formulation of low viscosity, epoxy-stable, jettable thiol-epoxy resins include pentaerithritol tetrathiol, farnesene tetrathiol, 1,2,4-trivinylcyclohexanetrimercaptan, linalool dimercaptan, and inositol hexathiol.

In yet other embodiments, curable formulations or mixtures thereof, neat, or dissolved or dispersed in water and/or organic solvent, can be applied to a substrate material including, but not limited to, materials made of wood, wire, glass, aluminum, steel, zinc, iron, other metals, metal alloys, ceramics, or combinations thereof, as one or more coatings. The one or more coatings alone or together may be applied to afford a thickness varying from about 0.01 micron to 500 microns, about 0.01 micron to 300 microns, or about 0.01 micron to 100 microns. Exemplary methods include, but are not limited to, roll coating, spray coating, brush coating and hot melt coating techniques. For solvent/water dissolved/dispersed coatings, a drying time can be applied which is between 0.1 min and 5 days. For 100% solids UV curable coatings, full or partial curing can be induced by exposure to irradiation energies ranging from 0.15 mJ/cm² to 5.0 J/cm² for a period of time in the range of 0.01 seconds to 1 hour.

In certain embodiments, cured formulations, including those cured by techniques such as stereolithographic additive printing or digital light projection printing, can be subsequently utilized in a wide number of processing techniques, including the following exemplary processes:
(a) Polymer Powder Sintering: Heating above polymer powder T_{g} or Tₘ or subjection to solvent fumes to fuse polymer particles.
(b) Casting: Pouring hardening liquid (e.g., investment) around patterned composite, allowing poured liquid to harden and then burning out or dissolving out polymer or polymer composite pattern to afford a mold with a negative image of original inkjet patterned geometry, which can be used to manufacture ceramics, metals, or urethane (e.g., investment casting, foundry production, etc.).
(c) Ceramic/Metal Sintering: Heating patterned composites to sufficient temperatures to fuse ceramic or metal particles and burn out cured polymeric binder constituents, including, for example, thiol-epoxy polymeric binder constituents.
(d) Injection Molding: If patterned composite is a die, the process of injecting a suitable material (such as a ceramic) at sufficient temperature into the die cavity to form a mold that is a positive of the cavity. Subsequently, the die is melted or leached off. If the patterned composite is a mold, the process of injecting ceramic material around the mold at sufficient temperature to encompass the mold apart from pre-designed channels. Once the mold is sufficiently surrounded with suitable material, the mold is melted, dissolved, or leached off through pre-designed channels. In both processes of injection molding referenced the parts after removal of the patterned composite can be optionally sintered.

In certain embodiments, the curable formulations disclosed herein once cured exhibit solvent soluble behavior. Several chemical approaches to achieving UV cure kinetics suitable for material processing by advanced manufacturing techniques, which include but are not limited to digital light projection (DLP), laser stereolithography (SLA) and inkjet 3D printing, while also enabling water solubility of cured materials are disclosed in the Examples below. Each of these chemical approaches offers a unique alternative to covalent polyfunctional acrylic crosslinkers and provides comparable or superior performance in areas such as processing and mechanical strength while also enabling water solubility. Commercial advantages of the water soluble, UV curable polymers reported include rapid prototyping of high precision parts used in sacrificial molding processes. These formulations also offer holistic benefits associated with environmental degradation capabilities of performance materials.

In certain embodiments, blends or mixtures of the curable formulations described can be cured under conditions wherein the formulations form an interpenetrating or semi-interpenetrating network. In some instances, one of the cured formulations may be selectively removed under appropriate conditions, such as exposure to a stimulus (i.e., solvent) which dissolves or degrades (substantially or fully) one of the cured formulations but does not dissolve or degrade the other. The articles or products of manufacture formed from such blends or mixtures may be formed from such interpenetrating or semi-interpenetrating networks.

The curable formulations may exhibit unique and improved thermal stability in comparison with other curable materials, including thiol-ene materials and exhibit cure kinetics suitable for use in photoprocessing industrial techniques.

i. Forming Processes using the Curable Formulations

The curable formulations are suitable for manufacturing processes in which the formulations are cured, hardened, or otherwise formed into articles of manufacture by exposure to conditions or stimuli including, but not limited to, non-ionizing and ionizing electromagnetic radiation, visible light, ultraviolet light, infrared, microwave and X-ray irradiation, electron beam irradiation, ultrasound exposure, thermal, and combinations thereof. Processes for curing, hardening, or forming articles from the curable formulations can include, but are not limited to, stereolithography, digital light projection, direct ink writing 3D printing, inkjet printing, at room temperature or at about 20° C. and higher temperatures (i.e., within a range of about 20° C. up to about 100° C., about 20° C. up to about 200° C., about 20° C. up to about 300° C., about 20° C. up to about 400° C., or about 20° C. up to about 500° C.).

Exemplary manufacturing processes for which the curable formulations described are suitable, include, but are not limited to, photopolymerization, stereolithographic manufacturing processes, stereolithographic 3D printing processes and digital light projection 3D printing processes, direct write 3D printing, polyjet 3D printing, inkjet printing, UV 3D printing, e-beam cure, two-photon 3D printing or other two-photon processes, and processes that utilize optically-triggerable chemical, thermal or physical changes in the curable formulations (specifically including processes in which the formulations comprising thermally curable constituents and, for example, light-absorbing dye constituents are subjected to visible, UV and/or other laser irradiation that causes a temperature increase that results in thermal curing of compositions) or any combination thereof.

Formulations can be suitable for use in manufacturing processes in which compositions can be triggered (upon exposure to suitable condition(s) or stimuli, such as those disclosed above) to undergo changes in covalent bonding, ionic bonding, supramolecular bonding, intramolecular bonding, or intermolecular bonding, resulting in changes to macromolecular architecture, physical state, rheological behavior, thermomechanical behavior, reaction kinetics, optical behavior, or morphology of the formulation following exposure to the trigger conditions. Such triggerable changes enable the formulations for use in the manufacturing processes.

ii. Articles and Products of Manufacture and Processes for Producing Articles of Manufacture including the use of Patterned Structures formed from Curable Formulations

The curable formulations or mixtures thereof are suitable for use in manufacturing processes, including manufacturing processes in which the curable formulations or mixtures thereof undergo triggerable or triggered changes in physical, chemical or energy states.

The curable formulations or mixtures thereof may be cured/hardened to form thermoplastic, supramolecular, physically or covalently crosslinked polymers or composites using manufacturing processes. In certain instances, the curable formulations or mixtures thereof are used to form positive or negative molds (denoted “patterned structures”) used to form articles, of manufacture (or products). Patterned structures are suitable for use in the manufacture of products formed of polymers, metals, ceramics, composites, or any combination thereof. Exemplary products can be formed of silicone elastomers, urethanes, metal alloys and superalloys (including nickel, cobalt and titanium superalloys and nickel, cobalt, and titanium single crystal superalloys). The patterned structures are also suitable for forming ceramic cores or molds used in investment casting of metal superalloys, ceramic products and thermosetting composites

The curable formulations can be formed into patterned structures suitable for use as positive or negative molds or mold components to form articles of manufacture. In general, patterned structures are formed by 3D printing curable formulations or mixtures thereof as. The patterned structures are formed from curable formulations which are cured, hardened, or otherwise formed into suitable patterned structures by exposure to trigger conditions in manufacturing processes, as described above.

In one non-limiting method of fabrication of a patterned structure, the method comprises the steps of:
(a) printing the curable formulation; and
(b) curing the printed curable formulation;

wherein the curing step is performed simultaneously or following the printing of the curable formulation of step (a).

In one embodiment, the patterned structures formed from a cured curable formulation are sacrificial patterned structures which can exhibit partial dissolution or degradation (i.e., less than 90%, 80%, 70%, 60%, 50% dissolution), substantial dissolution or degradation (i.e., greater than 90%, 95%, 96%, 97%, 98%, or 99% dissolution), or total dissolution or degradation in aqueous solutions, pure water, or organic solvents. In other instances, the patterned structures formed from a cured formulation are sacrificial patterned structures which can be burned out (i.e., completely or substantially degraded or destroyed) by heating to afford thermal decomposition of the patterned structure.

Solvents suitable for dissolving or degrading patterned structures formed of cured curable compositions include, but are not limited to, water or aqueous solvents of varying pHs, including pH values in the range of about 1.0 to 14.0. In some instances, the pH of the water or aqueous solvents is about 1.0, 2.0, 3.0, 4.0, 5.0, 5.5, 6.0, 7.0, 8.0, 8.5, 9.0, 10.0, 11.0, 12.0, 13.0, or 14.0. In some embodiments, the pH is preferably between about 3.0 to about 7.0, and more preferably between about pH 5.0 and about 7.0. In other embodiments, the pH is preferably between about 7.0 and about 14.0, and more preferably between about 8.5 to about 14.0. Suitable organic solvents include, but are not limited to, primary and secondary alcohols such as methanol, ethanol, propanol, isopropanol, and other organic solvents such as ethyl acetate, dioxane, methyl acetate, acetone, tert-butyl methyl ether, D-limonene, terpineol, geraniol, acetonitrile, dichloromethane, chloroform, chlorobenzene, difluorobenzene, tetrahydrofuran, dimethyl sulfoxide, dimethyl formamide. In certain embodiments, suitable solvents include molten salts, such as, but not limited to, sodium chloride, potassium chloride, sodium nitrate, potassium nitrate, as well as ionic liquids, such as, but not limited to, 1-Ethyl-3-methylimidazolium chloride, 1-Ethyl-3-methylimidazolium bromide, 1-Ethyl-3-methylimidazolium dicyanamide, 1-butyl-3,5-dimethylpyridinium bromide, ethylammonium nitrate; chloride, bromide, tetrafluoroborate, hexafluorophosphate, and hexafluoroantimonate salts of 1-alkyl-3-methylimidazolium, 1-alkylpyridinium, N-methyl-N-alkylpyrrolidinium. The dissolution or degradation of patterned structures typically occur upon exposure to solvents with a period of 48 hours, 24 hours, 18 hours, 12 hours, 6 hours, 1 hour. Dissolution or degradation of the patterned structures may be controlled by the optional application of heat or by cooling. Dissolution or degradation of the patterned structures may also involve the application of stirring, shaking, vortexing, and/or sonication during exposure of the patterned structure to the solvent(s). Dissolution or degradation of the patterned structures may also involve the use of flow systems that enable continuous or localized flow of water or organic solvents around or directed to specific sections of the pattened structures at flow rates varying from 1 mL to 2000 L per second.

In another embodiment, the patterned structures formed from a cured curable formulation are non-sacrificial patterned structures which are suitable for use as positive or negative molds or mold components used to form articles of manufacture in molding processes that include molding processes carried out at temperatures within the ranges of from about 25° C. to 500° C., 25° C. to 400° C., 25° C. to 300° C., 25° C. to 200° C., or 25° C. to 100° C.

The patterns of the patterned structures can be formed by a method which involves the steps of (1) 3D printing the patterned structures from a curable formulation; (2) subjecting the patterned structure to a post-print processing and/or post-cure step.

The patterned structure can be used as a sacrificial and dissolvable/degradable negative mold and positive pattern in the manufacturing of articles made from another material (see below), which may be cured or hardened. For example, the patterned structure may be embedded in another material and then can be removed to afford a hollow form of the patterned structure embedded within the embedding material.

In one non-limiting example of a method of manufacturing an article or product, an article or product may be formed by a method including the steps of:
(1) embedding the 3D printed patterned structure in a curable or hardenable material;
(2) curing or hardening the material; and
(3) dissolving and/or degrading the embedded 3D printed patterned structure.

In another non-limiting example, the article or product may be formed by a method including the steps of:
(1) backfilling and/or injecting the 3D printed patterned structure with a curable or hardenable material;
(2) curing or hardening the material; and
(3) dissolving and/or degrading the 3D printed patterned structure.

Blends of curable formulations and other materials, such as thermoplastics, hydrogels, or cell-laden materials may be co-printed to afford articles or products. Such articles or products may be formed by a co-printing method including the steps of:
(a) forming a mixture of the curable formulation and the one or more thermoplastics;
(b) printing the mixture to form an article; and
(c) curing the printed mixture;
   wherein the curing step can be performed simultaneously or following step (b). In another example, articles of products may be formed by a co-printing method including the steps of:
(a) forming a mixture of the curable formulation and the precursors for one or more hydrogels and/or cell-laden materials;
(b) printing the mixture to form an article; and
(c) curing the printed mixture;
   wherein the curing step is performed simultaneously or following step (b).

In some instances, the patterned structures formed are sacrificial and dissolvable/degradable positive molds with negative internal pattern and can be used in the manufacturing of articles made, for example, from polymeric products including elastomeric silicone products and thermosetting urethane, epoxy, carbon fiber epoxy composities, ceramics and ceramics used for manufacture of metal alloys/superalloys and single crystal superalloys including nickel, cobalt and titanium single crystal superalloy. For example, the patterned structure may be backfilled with another material (see below), which may be cured or hardened, and then the patterned structure can be removed to leave a product or article in the shape of the internal pattern of the sacrificial structure.

The 3D printed dissolvable/degradable patterned structures comprised of cured forms of curable formulations may have any suitable complex structure with geometries and features which can form cavities, complex internal features, flow channels, reservoirs, inlets, outlets, hierarchical meshes, or other structures or combinations thereof.

The sacrificial patterned structures are suitable for manufacturing products or articles that are formed from thermoplastics and thermosetting polymers, photopolymers, metals, ceramics and composites, including carbon fiber epoxy composites used in aerospace and automotive applications. Polymeric materials suitable for manufacturing products or articles from using patterns and compositions include, but are not limited to, poly(dimethylsiloxane), poly(lactic acid), poly(acrylonitrile-butadiene-styrene), poly(ethylene), poly(propylene), poly(caprolactone), poly(tetrafluoroethylene), poly(methyl methacrylate), polyether ether ketone (PEEK), poly(glycolic acid), poly(lactic-co-glycolic acid), poly(carbonate), poly(vinyl chloride), nylon, perfluoropolyethers, poly(urethane), poly(styrene), cyclic olefin copolymers, alginate, hyaluronic acid, cellulose, and other polysaccharides, thiol-ene elastomers, thiol-ene viscoelastic polymers, thiol-ene glassy polymers, terpene-derived poly(thioethers), poly(glycerol-co-sebacate), and derivatives of these polymers.

The articles or products formed from patterned structures can include, but are not limited to, microfluidic device, a bioprinted device, a medical device, a drug eluting device, a reactor, a bioreactor, a detector, a collimator, a valve, a microvalve, a pump, a micropump, a turbine for land, sea or air usage, a compressor airfoil, a turbine airfoil, a high-pressure compressor blade, a low-pressure compressor blade, a high-pressure turbine blade, a low-pressure turbine blade, a turbine vane segment, a turbine vane, a nozzle guide vane, a turbine shroud, turbine accessory gearbox components, a jet engine component, a mold, or a cast.

The solvent dissolvable/degradable structure (such as a mold) formed from curable formulations allow for manufacturing of multi-part systems, as exemplified below. In some instances, the molds made from the curable formulations describe allow for mult-part systems or components to be made in one mold rather than requiring multiple molds, as is common in normal manufacturing processes.

Sacrificial or non-sacrificial patterned structures formed from curable formulations are suitable for manufacturing ceramic, polymeric, metal or composite products or articles of manufacture for use in applications that include, but are not limited to, (a) microfluidics and 3D bioprinting; (b) medical and drug eluting device manufacturing; (c) investment casting processes; (d) non-sacrificial molding processes; and (e) urethane casting processes.

a. Microfluidic Devices and 3D Bioprinting

The curable formulations and cured formulations thereof, can be used in manufacturing processes for fabrication of microfluidic devices. Microfluidic devices may be single-layer, multi-layer, two-dimensional, three-dimensional, single-chip, multi-chip, modular device systems.

Microfluidics products manufactured using patterned structures formed from curable formulations include, but are not limited to, microfluidic products containing internal flow channels, fluid-logic enabled flow systems, arrays, and other products for drug toxicity screening and cell culture microfluidics.

The microfluidic devices may be formed from curable formulations described using methods of manufacture, such as by 3D printing. Patterned structures may also be used in the manufacture of microfluidics. Microfluidic devices are generally characterized as having at least one, preferably more than one interconnected channel therein.

In one non-limiting embodiment, the manufacture of microfluidic devices from curable formulations involves the creation of a cured three-dimensional (3D) pattern having one or more fluidic channels, inlets, outlets, or optional reservoirs. The channels, outlets, or inlets can be any arrangement, direction, and/or orientation. The angle between channels, outlets, or inlets may be 90 degrees or less than 90 degrees. In some embodiments, two or more channels, outlets, or inlets may join together at an angle of approximately 10 degrees, approximately 20 degrees, approximately 30 degrees, approximately 40 degrees, approximately 50 degrees, approximately 60 degrees, approximately 70 degrees, approximately 80 degrees, approximately 90 degrees, approximately 100 degrees, approximately 110 degrees, approximately 120 degrees, approximately 130 degrees, approximately 140 degrees, approximately 150 degrees, approximately 160 degrees, or approximately 170 degrees. The patterned structure may then be coated with composition or resin that is cured and subsequently the embedded patterned structure may be removed by dissolution or degradation under suitable conditions (such as, for example, by exposure to water at a certain pH).

In some embodiments, the patterned structure is embedded in silicon, metal, metal alloys, polymers, plastics, photocurable epoxy, ceramics, or combinations thereof. Upon removal or degradation of the patterned structure, the microfluidic device is formed having channels, inlets, outlets, and/or reservoirs which are composed of a metal and/or metal alloys (e.g. iron, titanium, aluminum, gold, platinum, chromium, molybdenum, zirconium, silver, niobium, nickel, cobalt, alloys thereof, including single crystal alloys, etc.), polymers and/or plastics, including, but not limited to, polycarbonate, polyethylene terephthalate (PET) polyethylene terephthalic ester (PETE), polytetrafluoroethylene (PTFE), polydimethylsiloxane (PDMS), polyurethane, bakelite, polyester, etc. In some embodiments, the microfluidic devices are composed of photocurable epoxy. In some embodiments, the microfluidic devices are composed of polydimethylsiloxane. In some embodiments, the microfluidic devices are composed of ceramics (e.g. silicon nitride, silicon carbide, titania, alumina, silica, zirconia, yttria-stabilized zirconia, lead zirconate titanate, yttrium aluminum garnet, tricalcium phosphate, hydroxyapatite etc.)

Microfluidic devices of suitable size which formed from curable formulations have features, such as the one or more channels, inlets, outlets, and optionally reservoirs therein, ranging in size where feature sizes may as small as 500 nm or less. The diameter of the channels can vary depending on a particular application and may be of uniform or non-uniform shape. The channels can have a diameter ranging from less than about 0.1 micron to 10000 microns, 10 microns to 1000 microns, 50 microns to 500 microns. The shape of the channels can also vary depending on a particular application. In one embodiment, the channels may be tubular in shape, wherein the cross-section of the channels is circular, elliptic, rounded, arched, parabolic, or otherwise curved. Fluids, such as liquids or gases, can be flowed in and out of the channels, inlets, outlets, and/or reservoirs. The microfluidic device may contain any number of channels, outlets, or inlets, such as at least 2, 3, 4, 5, 6, 7, 8, 9, 10, or more. The flow of fluids or gases into each inlet stream can be regulated use of different sources of fluids or gases, wherein the optional application of pressure to the source causes flow in the channel or inlet. Sources of fluids or gases can be attached to each inlet/channel, and the application of pressure to the source causes the flow in the channel.

Pressure may be applied by a syringe, a pump, and/or gravity. In some embodiments, the applied pressure is regulated (i.e. the applied pressure may be increased, decreased, or held constant). In some embodiments, the flow rate is regulated by adjusting the applied pressure. In some embodiments, the flow rate is regulated by adjusting the size (e.g. length, width, and/or height) of the channel(s). In some embodiments, the flow rate may range from about 0.001 μl/min to 1000.0 ml/min. The same amount of pressure is applied to all of the channel(s) and/or inlet(s) or different amounts of pressure are applied to different channel(s) and/or inlet(s).

In some embodiments, microfluidic devices may optionally contain an apparatus for controlling temperature which may be held at a constant temperature, such as room temperature (i.e., −25° C.) or at a temperature ranging from approximately 0° C. to approximately 50° C.

The channels of the microfluidic device can act as a vascular system to support cells, can be used for drug screening, drug efficacy, to study pharmacokinetics; can be used for toxin detection; can be used for drug delivery; can be used for filtrations; and/or can be used for bioseparations. In other cases, the microfluidic devices may be an organ-on-chip device capable of performing one or more functions of an organ, including, but not limited to, a heart, liver, kidney, colon, lung, a gastrointestinal tract, or other mammalian organ, such as a human organ. The surrounding material around the channels of the microfluidic device can act as a medium for cell culture or can be coated with a material that can act as a medium for cell culture for use in biomedical and pharmaceutical applications that include, for example, drug screening.

The microfluidic devices can be made to exhibit little to no leakage and/or are characterized as having leakage and interference free integration of one or more optical, biochemical, electronic, and/or physical sensors. In some instances, when used for cell culture the devices exhibit leakage and are selectively permeable membranes through which nutrients can flow. The microfluidic devices may exhibit reduced fluid residence time. The microfluidic devices may be characterized by high surface resolution and low surface roughness with no laser ablation or chemical smoothing.

The microfluidic or medical devices and manufactured according the methods can, but need not, include any manufacturing steps which include chemical treatments, micromilling, hot embossing, or thermoforming.

In other instances, the curable formulations or mixtures thereof can be used in processes such as 3D bioprinting, which is a promising tool to develop organs and tissue constructs for tissue engineering, stem cell biology, disease modeling, cell culture, and other applications. In order to bioprint structures, such as organs, and tissues, that mimic in vivo biology, vasculature and microvasculature can be incorporated into printed patterned structures or articles (products) formed therefrom.

b. Medical Devices

The curable formulations and cured formulations thereof, can be used in manufacturing processes for fabrication of medical devices.

Medical device products manufactured using patterned structures formed from curable formulations include, but are not limited to, products for use in applications that include implantable devices, pharmacological delivery, tissue regeneration or would healing, nerve regeneration, skin grafts or burn treatment, and topical, interventional, drug-eluting/pharmacological devices. In some instances, molds can be formed from curable formulations or using patterned structures thereof where the molds can be used for cell culturing, chemical synthesis, single cell analysis, disease detection, sequencing, reactor modeling, flow analyses, mixing, separations, and other applications. In some other instances, medical products or articles manufactured using patterned structures formed from curable formulations or formed from curable formulations per se can be used in the study angiogenesis, vasculogenesis, metastasis, and other biological phenomena.

Sacrificial patterned structures formed from curable formulations are suitable for use as dissolvable or degradable molds or sacrificial mold cores used in the manufacturing of injection moldable or thermoformable thermoplastics formed from polymers, such as, but not limited to, nylon, polycarbonate, ABS, and PEEK and thermosetting polymers, such as 1 and 2-part silicones, polyurethanes, poly(glycerol sebacate), implantable biomaterials, elastomeric, enzymatically degradable thiol-ene polymers, epoxies and other composites.

c. Investment Casting

The curable formulations and cured formulations thereof, can be used in manufacturing processes such as investment casting.

Investment casting manufacturing processes for which patterned structures formed from curable formulations are suitable include, but are not limited to, investment casting of stainless steel, nickel, chromium, aluminum, molybdenum, tungsten, niobium, tantalum, cobalt, and titanium superalloys and single crystal superalloys thereof, including nickel, chromium and titanium single crystal superalloys, as well as intermetallic superalloys, ceramic molds, ceramic overmolds, ceramic cores, and cast ceramics products of manufacture, including ceramics matrix composite (CMC) components suitable for the manufacture of or use in jet engines and specifically for the manufacture and/or use of metal or ceramic components including, but not limited to, compressor airfoils, a turbine airfois, high-pressure compressor blades, low-pressure compressor blades, high-pressure turbine blades, low-pressure turbine blades, turbine vane segments, turbine vanes, nozzle guide vanes, turbine shrouds, and combustor liners.

Investment cast components formed from curable formulations have features, such as the one or more channels, inlets, and outlets, where feature sizes may be as small as 400 microns or less. The size and structure of internal channels, inlets and outlets can vary depending on application and may be of uniform or non-uniform shape. Curable formulations can be used in the manufacturing process for currently existing parts to form monolithic metallic or ceramic components where current manufacturing of metallic or ceramic components requires the manufacturing of several smaller components that are assembled to form the larger final component. Curable formulations can be used to design future metallic or ceramic components, including ceramics used in the manufacture of single crystal metal superalloys and singly crystal metal superalloys including those of nickel, cobalt and titanium that currently are not achievable in the current investment casting process. Designs achievable with curable formulations that are not currently achievable in the existing investment casting process include, but are not limited to, advanced dual-walled core structures, assymetrically shaped internal and external pathways, non-linear internal and external pathways.

Curable formulation for the investment casting process can be formed as a die or a mold.
(a) Curable Formulation as a Die: Polymeric, composite, metallic and ceramic components referenced above can be produced from a curable formulation manufactured as a Die. If the process requires the use of a Die, the 3-D printed design of the curable formulation can be designed to include a negative cavity that is a replica of the desired final polymeric, composite, ceramic or metallic part. Curable formulations printed as a die with an internal cavity that is the negative of a final part can be used for, but not limited to, the production of ceramic core components for turbine blades, monolithic ceramic components for turbine blades, monolithic ceramic components for turbine vanes, etc. Curable formulations printed as a die offer design advantages including, but not limited to, dual-walled core structures, assymetrically shaped internal and external pathways, non-linear internal and external pathways.
(b) Curable Formulations as Mold: Polymeric, composite, metallic and ceramic referenced in the paragraphs preceding this section can be produced from a curable formulation manufactured as a Mold. If the process requires the use of a Mold, the 3-D printed design of the curable formulation will be designed as a replica (within acceptable +/−dimensional tolerances) that is a replica of the desired final ceramic or metallic part with the addition of pre-design channels that will enable the extraction of the curable formulation at the conclusion of the manufacturing process. Curable formulations printed as a die with an internal cavity that is the negative of a final part can be used for, but is not limited to, the production of ceramic core components for turbine blades, monolithic ceramic components for turbine blades, monolithic ceramic components for turbine vanes, etc. Curable formulations printed as a die offer design advantages including, but limited to, dual-walled core structures, assymetrically shaped internal and external pathways, non-linear internal and external pathways.

Ceramic components formed from a curable formulation of a die or mold for the investment casting process can be formed through the ceramic injection molding process.
(a) Ceramic Injection Molding Process with a Die: If the curable formulation is formed as a die, the ceramic will be injected into the negative cavity via an extrusion nozzle. Injection temperatures of the ceramic injection molding may range from ambient temperature to temperatures more than 200° C. Pressures exerted on the curable formulation are correlated with injection temperature and may range from about 100 kPa (14.5 psi) to pressures in excess of 300 MPa. Viscosities of the injected ceramic may range from about 1 to 100,000 centipoise.
(b) Ceramic Injection Molding Process with a Mold: If the curable formulation is formed as a mold, the ceramic will be injected around the mold. The curable formulation will be placed into a tool. The curable formulation will rest inside the tool in such a way that defined contact points between the tool and the curable formulation will place the entirety of the body of the curable formulation a pre-determined distance away from the wall of the tool. Once secured in the tool, ceramic will be injected into the space between the curable formulation and the walls of the tool. Injection temperatures of the ceramic injection molding may range from ambient temperature to temperatures more than 200 C. Pressures exerted on the curable formulation are correlated with injection temperature and may range from about 100 kPa (14.5 psi) to pressures in excess of 300 MPa. Viscosities of the ceramic injected may range from about 1 to 100,000 centipoise.

Ceramic components formed from a curable formulation of a die or mold for the investment casting process may be removed from the curable formulation through submersion in typically ambient temperature organic solvent(s) or water (or aqueous solutions), although higher temperatures can be used.
(a) Curable Formulation as a Die: If the curable formulation is formed as a Die, after ceramic is injected into the cavity and allowed to harden, the Die and ceramic can be submersed in a bath of room temperature organic solvent or water, including tap water, to remove the curable formulation material. Complete dissolution of the material in organic solvent or water will depend on thickness of the curable formulation Die and could range from less than 1 hour to greater than 48 hours. Agitation of solvent or water, including tap water, while the Die is submersed and/or changing of the water at standard intervals will increase the speed of dissolution.
(b) Curable Formulation as a Mold: If curable formulation is formed as a Mold, after ceramic is injected around the Mold and allowed to harden the Mold and ceramic can be submersed in a bath of organic solvent or room temperature water, including tap water, to allow the curable formulation to leach out of the ceramic shell through pre-designed pathways. Complete dissolution of the material in water will depend on thickness of the curable formulation Mold and could range from less than 1 hour to greater than 48 hours. Agitation of water while the Mold is submersed, increasing the temperature of the water and/or changing of the water at standard intervals will increase the speed of dissolution.

d. Non-Sacrificial Molding

The curable formulations and cured formulations thereof can be used in manufacturing processes to form non-sacrificial molds or mold cores for use in casting or injection molding processes.

Patterned structures formed from curable formulations are also suitable for use as non-sacrificial molds or mold cores in casting or injection molding processes to manufacture products comprised of injection moldable thermoplastics, such as, but not limited to, nylon, polycarbonate, ABS, and PEEK and thermosetting polymers such as 1 and 2-part silicones, polyurethanes, epoxies and other composites.

In a non-limiting example, curable formulations can include charge-transfer compositions and patterned structures formed from such charge-transfer compositions (for example, including maleimide/N-vinyl pyrrolidone and other charge transfer polymers) by processes such as SLA and DLP 3D printing or other UV, e-beam and other radiation cure processes, which exhibit superior dimensional stability and structural rigidity at temperatures greater than 100° C., as compared to other polymers that can be manufactured using SLA or DLP 3D printing and other UV and radiation processing techniques. These cured formulations can be shown by dynamic mechanical analysis to exhibit thermomechanical transitions from glassy to rubbery states quantified by dynamic mechanical analysis (DMA) tan delta peaks of 250° C. or higher.

e. Urethane Casting

The curable formulations and cured formulations thereof can be used in manufacturing processes such as Urethane Casting. Urethane casting manufacturing processes for which patterned structures formed from curable formulations are suitable include, but are not limited to, casting of polyurethane rubbers, polyurethane plastics, and polyurethane foams. Castings of these materials achieved through use of cured patterned structured form can be accomplished through, but is not limited to, open casting, centrifugal molding, compression molding, injection molding, or foaming.

Urethane casting components formed using negatives made from dissolvable curable formulations have features, such as the one or more channels, inlets, and outlets, ranging in size where feature sizes may be as small as 400 microns or less. The size and structure of internal channels, inlets and outlets can vary depending on application and may be of uniform or non-uniform shape. Curable formulations can be used in the manufacturing process for rapid iteration of part design and small to mid-volume component production where the production volume requirements do not support the creation of a specially designated tool to generate a specific urethane designed component.

In certain embodiments, preparing negatives for the urethane casting process includes the 3-D printing of a curable formulation as a Die or Mold. The 3-D printed design of the curable formulation can be designed to include a negative cavity that is a replica of the desired final urethane part and channels to allow for the injection of the urethane material. Curable formulations printed as a Die or Mold offer the design advantages of producing a monolithic urethane component where previously several urethane pieces would have to be produced independently and assembled as a large component.

Urethane components formed using a Die or Mold formed from a curable formulation in a urethane casting process may be formed through injection of the Urethane mixture directly into the cured formulation Die or Mold. Urethane mixtures may be injected at ambient temperature with minimal pressure. Certain urethane mixtures will cure to a solid state in 15 minutes or less, although longer times may be required. If the cavity in the curable formulation Die or Mold is of a significant size, injection of the urethane mixture may need to occur from multiple injection points to prevent the curing of the urethane prior to the filling of the negative cavity.

Urethane components formed using a Die or Mold formed from a curable formulation can also be used for an investment casting process and may be removed through submersion in ambient temperature, or higher, water or other suitable solvents. After urethane is injected into the cavity and allowed to harden, the Die or Mold and urethane can be submersed in a bath of room temperature solvent or water, such as tap water, to remove the curable formulation material. Complete dissolution of the material in water will depend on thickness of the curable formulation Die or Mold and could range from less than about 30 minutes, 1 hour to greater than 48 hours. Agitation of water while the Die or Mold is submersed, increasing the water temperature, and/or changing of the water at standard intervals will increase the speed of dissolution.

### EXAMPLES

### Example 1: Curable Compositions, Characterization, and Testing

In the following example the abbreviations listed below denote 4-MP=4-methoxyphenol, ACMO=4-acryloyl morpholine, A1Acr=Aluminum acrylate, AMPS=2-acrylamido-2-methylpropane sulfonic acid, BB Pigment=Bone black pigment, Ca2SO4=Calcium Sulfate; CaAcr=Calcium acrylate, CEA=2-carboxyethyl acrylate, 2-CEAO=2-carboxyethyl acrylate oligomers, n˜=1 to 3, Co(III)Acac=Cobalt(III) acetylacetonate, CRAH=Crotonic anhydride, DMACR=Dimethyl acrylamide, DMAPAA=N-dimethylaminopropyl acrylamide, DMSO=Dimethyl sulfoxide, Fe3Acac=Iron(III) Acetylacetonate, IBoA=Isobornyl acrylate, IOMP=Isooctyl 3-mercaptopropionate, LinA=Linoleic Acid, MAA=Methacrylic acid, MAAH=Methacrylic anhydride, MAH=Maleic anhydride; MAL=Maleimide, MgAcr=Magnesium acrylate; MPACR=3-methoxypropylacrylamide, MY=3-(4-Anilinophenylazo)benzenesulfonic acid sodium salt, NVF═N-vinyl formamide, NVP═N-vinyl pyrrolidone, OB+=2,2′-(2,5-thiophenediyl)bis(5-tert-butylbenzoxazole), PEGdiCOOH=Poly(ethylene glycol) bis(carboxymethyl) ether, PVP=poly(vinyl pyrrolidone), R-974=Medium surface area fumed silica additive, R016=Disodium 6-acetamido-4-hydroxy-3-[[4-[[2-(sulphonatooxy)ethyl]sulphonyl]phenyl]azo]naphthalene-2-sulphonate, TEDA=Triethylenediamine, TEMPIC=Tris[2-(3-mercaptopropionyloxy) ethyl]isocyanurate, TMPMP=trimethylolpropane tris(3-mercaptopropionate),

TPO=Diphenyl(2,4,6-trimethylbenzoyl)phosphine oxide, ZnAcr=zinc acrylate, ZnO=Zinc Oxide

The percentages listed below are weight percentages of the components listed for each respective composition prepared.
I. Composition I: CRAH: 36.00%; TMPMP: 62.04%; TPO: 1.96%
II. Composition II: CRAH: 19.77%; TEMPIC: 22.47%; MAA: 11.04%; MAAH: 42.23%; TPO: 3.82%; OB+: 0.15%; 4-MP: 0.05%; LinA: 0.48%;
III. Composition III: CRAH: 14.82%; TEMPIC: 33.70%; MAAH: 48.52%; TPO: 3.88%; OB+: 0.16%; 4-MP: 0.05%; LinA: 0.49%;
IV. Composition IV: MAAH: 30.72%; NVF: 22.26%; NVP: 34.81%; Co3Acac: 3.52%; TPO: 0.96%; BB: 0.97%; MgSO4: 1.96%
V. Composition V: During Photopolymerization: Mal: 32.93%; NVP: 37.70%; TPO: 0.99%; 4-MP: 0.10%; DMSO: 28.28% After DMSO removal: Mal: 45.92%; NVP: 52.57%; TPO: 1.38%; 4-MP: 0.14%;
VI. Composition VI: NVF: 35.1%; NVP: 13.76%; MAL: 29.80%; DHAQ: 0.13%; Co3Acac: 0.47%; OB+: 0.20%; Fe3Acac: 0.24%; MAAH: 13.01%
VII. Composition VII: NVF: 56.15%; MAAH: 31.30%; TPO: 3.41%; BB: 1.28%; R-974: 7.85%
VIII. Composition VIII: Mal: 44.76%; NVF: 32.78%; NVP: 20.50%; TPO: 1.96%
IX. Composition X: 2-CEAO: 10.69%; TEDA: 4.16%; ACMO: 84.16%; 4-MP: 0.10%; R016: 0.05%; OB+: 0.05%; TPO: 0.80%
X. Composition XI: AMPS: 28.25%; DMAPAA: 21.30%; DMACR: 49.55%; 4-MP: 0.10%; TPO: 0.79%
XI. Composition XI: DMAPAA: 85.25%; PEGdiCOOH: 13.20%; MY: 0.80%; TPO: 0.60%; 4-MP: 0.10%; OB+: 0.05%
XII. Composition XII: DMACR: 76.30%; Fe3Acr: 9.54%; CEA: 13.54%; TPO: 0.47%, 4-MP 0.10%
XIII. Composition XIII: MPACR: 62.93%; CEAO: 15.72%; ZnAcr: 15.69%; Co3Acac: 0.20%; TPO: 0.79%; 4-MP: 0.10%; OB+: 0.10%; IOMP: 4.47%
XIV. Composition XIV: DMACR: 80.18%; CaAcr: 5.03%; CEA: 14.29%; TPO: 0.50%
XV. Composition XV: DMACR: 72.29%; A13Acr: 9.17%; CEA: 18.14%; TPO: 0.43%

Preparation of Compositions I-XV:

Compositions I-XV were prepared using additive processes in which chemical constituents for various compositions were massed, subjected to high shear centrifugal mixing and/or heating for select process steps. For

Compositions I-XV, batches ranging from 10 g to 200 g in size were generally prepared by adding constituents in each composition to form homogeneous mixtures after subjection to “Mixing Cycles,” defined as a process segments in which a massed composition is subjected to centrifugal mixing at 1000 to 3500 RPM for 1 to 3 min and, optionally, subjected to subsequent heating at temperatures of 40 to 80° C. for times ranging 10 to 30 minutes per cycle unit. High shear centrifugal mixing was selectively employed using mixing speeds ranging from 1000 to 3500 RPM for mixing times ranging from 1 min to 3 min. Constituents used to prepare the curable compositions in Example 1 were stored at approximately 25 C in dry locations in containers with moisture prevention seals until further use.

To prepare Compositions I, II and III, combinations of thiol-ene and/or methacrylic photopolymerizable constituents were selected that enable the incorporation of water-reactive anhydride linkages into polymer networks during photopolymerization. To prepare Composition I, 17.236 g TMPMP and 0.545 g TPO were massed and added to an amber glass vial. TPO dissolved in TMPMP after one mixing cycle. TMPMP/TPO solutions were cooled to ambient temperature after TPO dissolution, and then 10.00 g CRAH was added, which was miscible with the solution to which it was added. Similar procedures as those used to prepare Composition I were used to prepare Compositions II and III, and resulting homogeneous compositions were stored in amber glassware and in desiccated environments at 25° C. until further use.

To prepare methacrylic/anhydride/N-vinyl olefinic and/or charge transfer/alternating constituents such as those in Compositions IV, V, VI and VII, processes representative of those used to prepare Compositions IV and V were used. To prepare Composition IV, 67.386 g NVF and 4.088 g TPO were added to a polypropylene FlackTek mixing cup and subjected to 1 mixing cycle, after which TPO was dissolved. 37.562 g MAAH was then added to NVF/TPO solutions at ambient temperature, and the resulting NVF/TPO/MAAH mixture was mixed for 1 min on a FlackTek speed mixer at 2000 RPM without heating, after which a homogeneous solution resulted. A total of 9.426 g of EVONIK medium surface area R-974 fumed silica was then added to the NVF/TPO/MAAH mixtures in two 4.173 g increments. 4.173 g R-974 was added and then the R-974-containing mixture was then mixed in a FlackTek speed mixer at 3000 RPM for 3 min, after which the fumed silica appeared to be well-dispersed. An additional 4.173 g of R-974 was added and the resulting mixture was again subjected to speed mixing at 3000 RPM for 3 min, after which it was stirred persistently using a spatula and then mixed again for 2 min at 3000 RPM. After the addition of R-974, 1.538 g BB pigment was added, and the mixtures were again mixed for 3 min at 3000 RPM, stirred using a spatula, and mixed once more at 3000 RPM for 3 min. The resulting mixture, thickened by the addition of fumed silica, was observed to be qualitatively stable for approximately 24 h with respect to BB pigment dispersion. This Composition IV mixture was then decanted into a flame dried glass bottle with a sealable cap after mixing and stored in a desiccated environment until use.

To prepare composition V, monomers predicted to be suitable for forming alternating copolymers through radical polymerization processes sometimes referred to as charge transfer polymerization, representative processes such as that used to prepare Composition V were used. In Composition V, electron poor and electron rich monomeric alkene constituents were added in 1.00:1.00 stoichiometric ratios to afford suffiecient monomer stoichiometries for forming charge transfer/alternating copolymers. 6.00 g of electron rich NVP, 5.24 g of electron poor MAL, 0.47 g TPO and 0.047 g 4-MP were massed and added in an amber glass vial. An additional 4.50 g DMSO solvent was then added in a 0.75:1.00 wt:wt ratio of DMSO:NVP to facilitate solibility of MAL in this 1:1 electron rich:electron poor NVP:MAL formulation. Homogeneous solutions of Composition V constituents were achieved after 2-3 Mixing Cycles, and Composition V mixtures were stored in dark and desiccated environments until further use. In the preparations of other compositions similar to Composition V, an NVP:MAL stoichiometric ratios of approximately 1.10-1.50 NVP:1.00 MAL were demonstrated to afford homogeneous NVP/MAL solutions.

To prepare Composition VI, 5.00 g MAL, 3.66 g NVF, 2.29 g NVP, and 0.22 g TPO were massed and added to an amber glass vial. Homogeneous solutions were achieved after 2-3 Mixing Cycles. Homogeneous Composition IV mixtures were stored in dark and desiccated environments until further use. Similar processes for preparing Composition IV and Composition VI were used to prepare Composition VIII.

To prepare Compositions IX, X and XI, constituents that contain functional groups suitable for photopolymerization and additional functional groups suitable for participating in chemical reactions without UV exposure were prepared. For Compositions IX, X and XI, monofunctioal UV curable chain growth co-monomers were selected that contain additional functional groups suitable for forming ion pairs or other reaction products in the presence of certain chemical environments, and in one embodiment, the effective monomeric functionality that results after associations or in situ groupings of mono- or poly fuctional curable constiuents may increase and afford reduced times to gelation of curable compositions used in photopolymerization processes.

To prepare Composition IX, 86.59 g ACMO and 0.051 g R016 were massed in a Max 100 g polypropylene FlackTek cup using a precision balance and subjected to 4 Mixing Cycles, after which RO16 appeared to be completely dissolved. 11.00 g 2-CEAO, which contains both carboxylic and acrylic functionalities, and 0.110 g 4-MP were then added to ACMO/RO16 mixture and shaken by hand, after which 2-CEAO and 4-MP also appeared to be completely dissolved. 4.28 g TEDA was then added, and resulting mixture was subjected to 1 mixing cycle and mixed at 80° C. at 15 RPM for an additional 15 min, after which the resulting mixture was allowed to cool to ambient temperature. 0.837 g TPO was then added, and resulting mixture was subjected to 1 Mixing Cycle. 0.056 g OB+ was then added and resulting mixture was subjected to 1 Mixing Cycle.

To prepare Composition X, 25.000 g AMPS, which contains both acrylamide and sulfonic acid groups, and 18.845 g DMAPAA, which contains both acrylamide and tertiary amine groups, 43.846 g DMACR, and 0.087 g 4-MP were massed in a Max 100 g polypropylene FlackTek cup using a precision balance and subjected to 3 Mixing Cycles, after which AMPS appeared to be completely dissolved. AMPS & DMAPAA were added in 1:1 stoichiometric ratios to provide equivalent acid and base groups to react with one another. After AMPS dissolution, 0.701 g TPO was added and was dissolved using another mixing cycle. Composition XI, in which a difunctional diacid and an excess of tertiary amine containing DMAPAA were added, was prepared using similar processes as those used in Composition IX and X. As paired amine and acid containing constituents in Compositions IX, X and XI were mixed and/or dissolved, temperature and viscosity increases were observed for each mixture. Each mixture was heated for 60 min at 80° C. after co-monomer pairs were dissolved to form homogeneous mixtures, after additional constituents were added upon cooling of each composition.

To prepare Compositions XII, XIII, XIV and XV, which contain various monofunctional radical chain growth polymerization constituents and metal diacrylate salts of Fe, Zn, Ca and Al, respectively, similar processes were used as those used to prepare Compisitions V and X, which each contain solid monomeric constituents were added to liquid monomeric constituents and subjected to multiple mixing cycles to form homogenious solutions. To prepare Composition XII, 9.99 g DMACR, 0.625 g FeAcr, 1.77 g CEAO and 0.10 g 4-MP were massed in a Max 20 g polypropylene FlackTek cup using a precision balance and subjected to 3 Mixing Cycles, after which FeAcr appeared to be dissolved. An additional 0.625 g FeAcr was then added, and the resulting mixture was subjected to an additional 3 mixing cycles, after which it appeared to be homogeneous, after which 0.062 g TPO was added in a final step, and the resulting mixture was then subjected to an additional mixing cycle. To prepare Compositions XII, XIV and XV, parallel processes to that used for Composition XII were used. In a first step, free radical inhibitor, all liquid monofunctional chain growth comonomers and approximately half of each formulation's total metal acrylate salt content was added to polypropylene FlackTek cups and then subjected to approximately 3 mixing cycles. In a second step, the remaining metal acrylate salt quanitities were added and then the mixtures were subjected to another three mixing cyclies. In a third step, remaining constituents in each formulation were added as specified in the list of Example 1 Composition formulations, and final resulting compositions were subjected to an additional mixing cycle. Compositions XII, XIII, XIV and XV were stored in desiccated environments in dark conditions and 25° C. temperatures after preparation.

Preparation & Assessment of Flood Cured Films:

0.4 mm to 1.0 mm thick films (the “Flood Cured Films”) were cast for Example 1 Compositions I to XV after preparation by casting prepared Compositions between Rain-X® coated glass slides (Rain-X® release agent was enabled Flood Cured Films delamination from glass slides). After injection, compositions were UV cured for four (4) total minutes—two (2) minutes on each side—using a 12 W UV-LED source (including 405 nm) at 30% power at a distance 15 cm below the UV diodes (the “Flood Curing”).

Flood Cured Films for Compositions II to X and XII to XV exhibited glassy thermomechanical behavior at 20° C. with toughnesses sufficient for removal of each Flood Cured Film from glass molds used during the Flood Curing. Composition I was optically clear and viscoelastic in nature. Composition V, which contained approximately 28.28 wt % DMSO solvent during flood curing was also observed to be rigid in the presence of DMSO and maintained sufficient mechanical integrity to be transferred from glass slides and washed free of DMSO by immersion in 250 mL of water changed out three times over a 5 day immersion peried. Formulation V after DMSO washing with water was then dried at 80° C. for 12 h under vacuum, approximately 200 mtorr. Composition XI was elastomeric/viscoelastic in nature and retained some trace odors of MAAH. BB Pigment prevented full UV penetration during Flood Curing. Composition VIII exhibited high toughness and exhibit slightly dectectable odors of NVP after Flood Curing. After Flood Curing, Composition VIII became rigid and increasingly translucent. After 30-60 min of UV cure, Composition VIII appeared completely white and opaque.

Atmospheric Moisture Uptake Studies on Flood Cured Films:

Flood Cured Films with a thickness of 0.4 mm from Example 1 Compositions were subjected to quantitative moisture uptake studies. For one Example 1 Composition, approximately 0.15 g, n=4 Flood Cured Films were massed, and initial masses were recorded. These Flood Cured Films were then exposed to ambient moisture conditions (approximately 22° C., 40% relative humidity) for varying amounts of time, and additional masses were taken at various time points. Moisture uptake results are provided in Tables 1 and 2 below.

TABLE 1
Moisture uptake studies at ambient conditions for Flood Cured
Films according to Example 1 Composition

| Mass, | Mass, t = | t = 1 day | Mass, t = | t = 7 days |
|---|---|---|---|---|
| t = 0 | 1 day | Uptake (g/g) | 7 days | uptake (g/g) |
| 0.148 | 0.147 | −0.007 | 0.150 | 0.014 |
| 0.098 | 0.098 | 0.000 | 0.102 | 0.041 |
| 0.162 | 0.160 | −0.012 | 0.164 | 0.012 |
| 0.115 | 0.115 | 0.000 | 0.119 | 0.035 |

TABLE 2
Moisture uptake studies at ambient conditions for additional Flood
Cured Films according to Example 1 Composition

| | mass, t = | Uptake, t = | mass, t = | Uptake, t = 48 |
|---|---|---|---|---|
| Mass, t = 0 | 24 h | 24 h, g/g | 48 h | h (g/g) |
| 0.155 | 0.155 | 0.0000 | 0.161 | 0.0387 |
| 0.180 | 0.182 | 0.0111 | 0.189 | 0.0500 |
| 0.204 | 0.205 | 0.0049 | 0.214 | 0.0490 |
| 0.189 | 0.194 | 0.0265 | 0.198 | 0.0476 |

Water Immersion & Dissolution Studies on Flood Cured Films:

Flood Cured Films of Example I Compositions I to XV with thicknesses ranging from 0.40 to 1.00 mm were subjected to water immersion studies in pH ˜5.5, 20° C. tap water for 0.5 to 24 h in approximately 1.0 g/40 mL ratios of cured composition to water. Other select compositions were subjected to modified aqueous conditions to accelerate dissolution/degradation. Modified aqueous conditions included acidic conditions, in which pH was adjusted or buffered to 2, 5 and 7, and to select basic conditions, in which pH was adjusted by adding 1.00 g of triethylenediamine to approximately 35 mL of tap water.

Flood Cured Example 1 Compositions I to XV subjected to water immersion & dissolution/degradation studies exhibited varying observed softening rates after immersion in pH 5.5 tap water at 20° C. in a concentration of approximately 1.0 g/40 mL. Immediately after immersion, each Example 1 Composition was closely examined, and each composition except for Composition V was observed to adhere to container walls after immersion in water, with wall adhesion occurring as quickly as 1.0 second after immersion and delaying in occurrence for as long as 2 h or more. Each Example 1 composition except for Compostion V was observed to exhibit dissolution or degradation behavior in water marked by (1) low volumetric increase during dissolution or degradation (i.e., low observable swelling) and (2) water dissolution kinetics comparable to those of commercially known water soluble polymers such as poly(vinyl alcohol). While a number of previously known photocurable polymers such as commercially available hydrogels exhibit volumetric increases of 100×, 1000× or more upon immersion in water or other solvents, the curable compositions exhibit notably different low-swelling behavior during dissolution or water degradation. This observed low swelling behavior in water can be viewed as surface erosion.

Composition V, a reaction product of 1:1 stoichiometric MAL:NVP comonomers, did undergo significant softening and geometric deformation after immersion in water at 80° C. for 24 hours but did not dissolve in water. Composition V was shown to dissolve in DMSO, however.

Water in containers used in dissolution/degradation studies for Compositions I-XV exhibited varying degrees of turbidity during dissolution, with final water solutions appearing completely transparent for select compositions and appearing clouded for other compositions.

Anhydride-containing Compositions I, II, III, IV, VI and VII were shown to exhibit accelerated water degradation in the presence of added secondary or tertiary amine additives to water in dissolution studies. For example, the addition of approximately 1 g of triethylenediamine to 35 mL of pH 5.5 tap water was shown to reduce average dissolution times of ˜1.0 g masses of Flood Cured Films of Compositions I-IV and V—VII from approximately 12-24 hours at 80° C. to approximately 0.1 to 2 hours at 80° C. and from approximately 24-48 h at 25° C. to approximately 2-8 hours at 25° C.

UV Light Studies: UV Cure Kinetics and UV Light Penetration Depth:

After preparation of Compositions I to XV, each composition was studied to determine UV cure kinetics and select samples were subjected to 360 to 420 nm UV light to determine UV light penetration depth at given exposure times (collectively, the “UV Light Studies”). UV Light Studies were used to assess composition suitability for advanced manufacturing processes. Several commercially available digital light processing/projection (DLP) or stereolithograpy (SLA) 3D printers (such as Formlabs Form2, Kudo3D Titan 2, Autodesk Ember, atum3D DLP Station, Asiga PICO2HD, B9 Creations Core 550 and any other 3D printer that uses vat photopolymerization and stereolithography) (the “SLA 3D Printers”) were used during the UV Light Studies to generate hardware and software settings unique to each Composition I to XV. In the UV Light Studies, approximately 10 mL of each composition was added to a Rain-X® coated glass slide to form a pooled droplet (together the “Prepared Slides”). The Prepared Slides were then placed directly above the UV projection area of each SLA 3D Printer. Individual Prepared Slides were exposed to UV light on the SLA 3D Printers, in which UV light intensity, dose and delivery profiles were varied to create UV irradiation profiles uniquely suitable for each Composition I to XV. UV Light Studies allowed for the creation of baseline UV penetration depths for each Composition at a range of varying UV exposure times. Corresponding rigidity, strength and toughness of UV cured films for Compositions I to XV were assessed relative to varying UV light profiles on various SLA 3D Printers. Optimal formulations are reported in Example 1, which were determined after iterative optimization of Composition constituent ratios in UV Light Studies. UV exposure times per projected layer on the SLA 3D Printers generally ranged from 0.80 s to 9.5 s, and UV irradiation doses per layer generally ranged from 10 mJ/cm² to 80 mJ/cm². UV penetration depths per projected layer for Compositions I to XV were adjusted to be approximately 10% to 80% greater than each printing layer slice thickness to ensure sufficient layer-by-layer adhesion on each of the SLA 3D Printers. UV Light Studies for Compositions I to XV also determined that certain SLA 3D Printers required specific settings for optimal printing of each Composition. The UV penetration depth at a given energy exposure of each Composition could be tuned by varying the concentration of light absorbing additives and photoinitiator.

SLA & DLP 3D Printing

Example 1 Compositions I to XV were optimized for printing on various SLA 3D Printers using UV Light Studies. SLA 3D Printers demonstrated suitability for use in the manufacture of 3D printed objects using Compositions I to XV. Select SLA 3D Printers exhibited specifications including, but not limited to, Z—build limits ranging from 134 mm to 300 mm, X×Y printing areas ranging from 64×40 mm to 90×90 mm and projection window surfaces including, but not limited to, polydimethylsiloxane (storage modulus approximately 4 to 10 MPa at 20° C.), polytetrafluoroethylene (PTFE)-coated glass (storage modulus approximately 30 to 60 GPa at 20° C.) and PTFE-coated siloxane gel (storage modulus approximately 500 kPa at 20° C.).

Seven total compositions selected from Compositions I to XV representative of the various chemistries represented in Compositions I to XV were used in 3D printing of various objects. Select Compositions from Compositions I to XV were demonstrated to be suitable for use with SLA 3D Printers to manufacture objects with outer dimensions on the order of 22.0×7.0×7.0 cm and internal passages approximately 1.0 mm thick and 10 mm long. Additional select compositions from Compositions I to XV were demonstrated to be suitable for use with SLA 3D Printers' processes to manufacture objects with outer dimensions approximately 1.0 cm×1.0 cm×1.0 cm and surface channels approximately 0.15 cm wide and 1.0 cm long. Additional select compositions from Compositions 1 to XV were demonstrated to be suitable for use SLA 3D Printers' processes to manufacture objects with outer dimensions approximately 3.0×2.0×0.1 cm and internal through running channels, holes and/or passages approximately 0.15 cm wide and 0.25 to 0.75 cm long.

Cleaning & UV Post-Curing of Example 1 3D Printed Samples

After printing of select Example 1 compositions into 3D printed objects (the “3D Printed Samples”), the 3D Printed Samples were processed using a two-stage process involving the removal of all uncured polymer resin from internal & external superficies of the 3D Printed Samples (referred to as “Cleaning”) and the post-Cleaning utilization of UV-wavelength light to continue polymer cross-linking process of the 3D Printed Samples (referred to as “UV Post-Curing”). NOTE: 3D Printed Samples subjected to both Cleaning and UV Post-Curing are referred to as “Processed 3D Printed Samples”.

Following the printing of 3D Printed Samples possessing protrusions or holes 1 mm or less in size (the “Intricate Features”), 3D Printed Samples were both placed inside a fume hood and affixed to a surface surrounded by aluminum foil and paper towels. Thereafter, 3D Printed Samples were subjected to pressurized air (between 1 and 100 PSI) (“Air Removal”) to remove residual uncured resin from Intricate Features. Following Air Removal, 3D Printed Samples were immersed in 100 mL sealable polypropylene containers in approximately 90 mL of methyl acetate or other organic cleaning solvents, and, after sealing of containers, were agitated for 30 s (“Solvent Agitation”). After Solvent Agitation, 3D Printed Samples were subjected to additional Air Removal for 5-20 seconds, followed by an additional 10 seconds of Solvent Agitation. Air Removal and Re-Immersion were repeated as needed until uncured polymer resin was no longer visible on the surface of the 3D Printed Samples. Thereafter methyl acetate or other organic cleaning solvents were allowed to evaporate for 10 minutes off the surface(s) of the 3D Printed Samples. 3D Printed Samples not possessing Intricate Features could be cleaned by immersion in solvents including, but not limited to, acetonitrile, acetone, bis(2-methoxyethyl ether), butyl acetate, 1-butanol, chloroform, cyclohexanol, cyclopentanol, D-limonene, dibutyl ether, dichloromethane, diethyl ether, dimethyl formamide, dimethyl sulfoxide, dipentene, dipropyl ether, ethanol, ethyl acetate, farnesol, farnesene, geraniol, hexamethyldisiloxane, hexanes, methanol, methyl acetate, pentane, propyl acetate, supercritical CO₂, N₂ and other supercritical solvents, tert-butanol, tert-butyl acetate, tert-butyl methyl ether, terpineol, tetrahydrofuran, toluene, and other organic solvents and combinations thereof with boiling points ranging from −20° C. or lower to 200° C. or higher.

After Cleaning, 3D Printed Samples were subjected to UV Post-Curing by UV irradiation using the same UV irradiation procedures used to prepare Flood Cured Films. 3D Printed Samples were then optionally heated to 60-130° C. for 10 min to 12 h (the “Thermal Post-Curing”) to remove residual internal polymer matrix stress from the 3D Printed Samples. 3D Printed Samples were then stored in sealed, desiccated containers until use.

Mechanical Characterization

Rectangular specimens 30.0 mm×0.9 mm×6.0 mm were manufactured using SLA and DLP 3D printing techniques as described in Example 1. Dynamic mechanical analysis (DMA) experiments were run in tension at 1 Hz from 20° C. to 150° C. at 2° C./min on 3D printed specimens for select Example 1 Compositions using a TA Instruments Q800 DMA. Each Example Cmposition subjected to DMA testing appeared to be amorphous in the temperature ranges tested, with DMA tangent delta peaks ranging from approximately 45° C. to approximate1 225° C. At approximately 30° C., glassy storage moduli at 1 Hz and 0.075% strain ranged from approximately 400 MPa to 3000 MPa or higher. At approximately 100° C., storage moduli ranged from approximately 4 MPa to greater than 1500 MPa, and at approximately 150° C., storage moduli ranged from approximately 1 MPa to greater than 1000 MPa. The highest heat deflection temperature measured for any Example 1 compositions was approximately 186° C. at 0.45 MPa.

### Example 2: Sacrificial Negative Dies for Advanced Molding

Several Example 1 Compositions were optimized for use on SLA 3D Printers, as discussed in Example 1. These same Example 1 Compositions were used in coordination with SLA 3D Printers for the fabrication of a geometrically complex die (“the Pattern A Mold”), which was designed as a mold for thin-walled shunt devices with narrow internal cavity features and complex internal lattices achievable only via additive manufacturing processes. Pattern A Molds were printed using SLA 3D Printers and were comprised of multiple Compositions in Example 1. Pattern A Molds were designed with external planes that form a right rectangular prism with dimensions approximately L=5.0 cm, W=0.70 cm, H=0.70. Within the bounds of the right rectangular prism, Pattern A Molds show a 4.5 cm long cylindrical negative shunt shape with a closed cylindrical hollow base section (ID=0.30 cm; OD=0.60 cm), a patterned mesh-like midsection with lattice struts approximately 0.40 mm thick and internal pore diameters of approximately 0.30 mm, and a rounded conical tip on one end.

A Pattern A Mold, or any mold, die or pattern that is designed with similar uses and/or processes in mind (collectively, a “3D Printed Negative Mold”), is suitable for advanced injection of several materials, including platinum-catalyzed two-part silicone elastomeric resins, two-part thermosetting urethane materials, carbon fiber/epoxy composites, or flowable, non-acqueous ceramics.

Multiple Pattern A Molds were printed on SLA 3D Printers and subjected to Cleaning, UV Post-Curing and Thermal Post-Curing. Thereafter, a platinum-catalyzed commercially available two-part siloxone elastomeric resin with a final storage modulus at 20° C. of approximately 3 MPa was injected into into multiple Pattern A Molds using vacuum drawing with the goal of achieving a monolithic, geometrically complex shunt device using a two-part siloxone elastomers (the “Silicone Shunt”).

Vacuum levels suitable for use in vacuum filling of Pattern A Molds or 3D Printed Negative Molds comprised of curable compositions range from 1 Torr or lower to atmospheric pressure. For vacuum filling of both Pattern A Molds and 3D Printed Negative Mold printed objects, a vacuum hose was attached to one end of the Pattern A Molds and/or the 3D Printed Negative Molds and other end of the patterned structure was immersed in a pre-mixed two part silicone resin. Once silicone was drawn into the Pattern A Molds, the silicone-filled mold assembly was cured under 25° C. and 80° C. conditions in an upright position for 8 hours and 4 hours, respectively. The 25° C. for 8 hour cure assembly and the 80° C. for 4 hour cure assembly were immersed in separate 100 mL water baths having a pH 5.5 in sealed polypropylene containers. After 6 hours, ˜90% of the Pattern A Mold was dissolved into the pH 5.5 water bath. At that time, the original water was decanted and a new 100 mL of pH 5.5 water was added. Full dissolution of Pattern A Mold occurred in under 24 hours. The resulting manufactured Silicone Shunt exhibited desired modulus, mechanical integrity and feature.

### Example 3: One-Part Positive Sacrificial Pattern for Advanced Casting

Approximately n=10 three dimensional ringlike circular patterns, “Pattern B” positive molds were fabricated using Example 1 curable compositions as described above. Pattern B patterns were approximately 2 cm in diameter, 0.75 cm thick and exhibited conical protrusions less than 1 mm in length. After being fixed inside 10 cm×10 cm×10 cm molds, Pattern B rings were subjected to overmolding processes in which (B.1), a platinum catalyzed, two part curable siloxane resin with a storage modulus of approximately 30 to 70 MPa at 20° C. after curing, and (B.2), a water-based alumina ceramic investment slurry, was injected after coating of a pattern B positive pattern with a sprayable layer of titanium dioxide approximately 20 microns in thickness to prevent water damage of the aqueous ceramic slurry to the Pattern B positive pattern. After curing of B. 1. siloxane investment and solidification of B.2. ceramic slurry, Pattern B/siloxane and Pattern B/ceramic mold assemblies were then immersed in water at 20° C. for 24 h and subjected to mixing at 15 RPM to leach away the printed article prototype (Water Leaching). After Water Leaching, the hollow solidified investments remained with the negative image of the printed article prototype (“Pattern B Negative Molds”).

To prepare cast metal prototypes of identical or near-identical geometries as the printed article (“Cast Metal Article 1D Prototypes), Metal solder (60/40 Sn/Pb) was heated to 350° C., after which it melted. It was poured into Pattern B Negative Molds and allowed to cool. After cooling, the Cast Metal Positive Images of Pattern B Prototypes were removed from ceramic and silicone molds and were observed to exhibit the form of the sacrificial, dissolvable 3D printed polymeric Pattern B geometries.

### Example 4. Manufacturing of a Hollow Vascular Channel for Medical Device and Microfluidics Applications

A positive geometric image of a human brain arterial vascular system with vascular diameters and other features ranging in thickness from approximately 0.40 to 5.00 mm was SLA/DLP 3D printed using a curable Example 1 composition and thereafter subjected to post-print cleaning and post-processing as described in Examples 1-3. This positive vascular pattern, “Pattern C,” was coated with an optically transparent two-part platinum curable silicone (Dow Corning Sylgard 184 resin) using a continuous drip process in which mixed Sylgard 184 siloxane resin was dripped onto a constantly rotating vascular pattern. After application of uncured siloxane resin, this coated vascular assembly was subjected to thermal curing at temperatures between 60 and 120° C. and then subjected to water immersion for 24 h in approximately 1000 mL of pH 5.5 tap water to dissolve the internal 3D printed positive vascular patterned structure to afford a negative, hollow vascular flow series of channels. The 3D manufacturing of this positive brain artery Pattern C geometry and its use in an advanced manufacturing process that enabled an industrially established siloxane product (Dow Corning Sylgard 184) to be fabricated into complex and difficult-to-achieve geometries suitable for a number of applications that benefit from the fabrication of complex flow systems.

### Example 5. Manufacturing of a Urethane Multi-Part Hinge Using One Dissolvable Mold Structure Prepared by SLA/DLP 3D Printing

A dissolvable “Pattern E” negative mold was formed using SLA/DLP 3DP processes as described in Examples 1-4 from an Example 1 composition for the purpose of casting a multi-part hinge using a single injection process. The article used to manufacture the negative mold was a hinge consisting of three components manufactured separately under current manufacturing processes and assembled by hand/machine: Pattern D, Part 1 was approximately 1.5 inches, ending in a U-shape with transverse holes at the end; Part 2 was approximately 1 inch long with a transverse hole at its end; Part 3 a 0.75-inch rod with caps on the end connecting the first 2 parts. When fully assembled, Pattern D Parts 1 and Part 2 could spin freely 360° around the center rod.

This Pattern D mold design includes three parts that are interlocking, yet separated by a thin barrier made from a curable Example 1 composition. This Pattern D negative mold was filled with a pre-mixed two-part polyurethane casting resin (commercially available urethane: FASTCAST™) using a 3 mL polypropylene pipette.

After injection, the polyurethane resin in this Pattern D mold was cured at 25° C. with the mold in an upright position for approximately 20 minutes. Subsequently, the mold/injected urethane assembly was immersed in 25° C. water to dissolve away the mold comprised of an Example 1 curable composition. During the dissolution process the water was refreshed at standard intervals but was not agitated. The part dissolved in approximately 24 hours. Upon complete dissolution of the mold, the three parts were removed from the water as a complete and functional hinge. The dissolvable mold structure formed allowed for a multi-part hinge to be made using one mold rather than requiring the use of multiple molds.

### Example 6. Manufacturing of High-Pressure Turbine Blade Prepared by SLA/DLP 3D Printing Process

A dissolvable “Pattern F” negative mold for a non-proprietary high-pressure turbine blade was formed using a UV-based digital light projection 3D printing process as described in Examples 1-5. The mold was designed with openings on each end. Once the dissolvable negative mold was printed, post-processed and post-cured, the negative mold was filled with a 2-part polyurethane resin (commercially available FASTCAST™). The mold was placed vertically on a glass slide to minimize the amount of urethane that leached out during the filling process. After filling, a second glass slide was placed on top of the mold and the glass slides were clamped together as seen in the image below.

The urethane was left to cure at 25° C. for about 20 minutes. After curing, the glass slides on the top and bottom of the negative mold were removed with the assistance of a chisel. Subsequently, the part was placed in 25° C. water to dissolve away the mold. During the dissolution process, the water was refreshed at standard intervals but was not agitated. The part dissolved in approximately 18 hours to dissolve. The part demonstrated the ability to manufacture a high-pressure turbine blade with complex geometry and cooling passageways.

### Example 7: One-Part Sacrificial Negative Molds for Manufacturing of Hydrogels and Silicones for Biomedical Applications

A number of Example 1 curable compositions were subjected to SLA and/or DLP manufacturing processes using 380 to 420 nm light to form one-part, removable negative microfluidic mold patterns approximately 6.0 mm by 8.0 mm by 12.0 mm in size and subjected to post-print cleaning and post-processing as described in Examples 1-3. These one-part negative mold patterns with surface features of 200-micron resolution (“Pattern G molds”) were used to manufacture positive patterns of hydrogel and siloxane materials with known/previously demonstrated biomedical relevance.

Polyvinyl alcohol (PVA) hydrogels were prepared using a combination of PVA, deionized (DI) water, dimethyl sulfoxide (DMSO), and phosphate-buffered saline (PBS) using multiple heating cycles for hydrogel synthesis and freeze/thaw cycles for hydrogel cure filled into Pattern G molds. For certain hydrogel formulations, PVA, DI water and DMSO were mixed in 3:17:80 ratio and heated for two cycles of 24 h at 98° C. Pattern G molds were cast with the PVA solvent mixture and left to rest at 20° C. for 3 h. Filled Pattern G molds were frozen from 20° C. to −20° C. and maintained at −20° C. for 20 h, then thawed, comprising one freeze/thaw cycle. Freeze/thaw cycle was repeated twice. Filled Pattern G molds were then placed in 10 mL tap water for 1 to 6 h to remove Pattern G molds. Solvent soaks of 15 s to 6 h in tap water, DI water, DMSO, PBS, or combination thereof afforded hydrogels of various stiffness with patterned surface features (those of the Pattern G molds).

Pattern G molds were also filled with optically transparent two-part platinum curable silicone (Dow Corning Sylgard 184 resin) using gravity filling and/or a polypropylene syringe. After filling of Pattern G molds, uncured siloxane resin patterns were subjected to ambient curing at 20° C. or thermal curing at temperatures between 60 and 120° C. for 1 to 24 h. Cured patterns were removed by subjecting cured silicone-filled Pattern G molds to water immersion for 2 to 6 hours in approximately 30 mL of pH 5.5 tap water to dissolve the external structure.

The 3D manufacturing of Pattern G molds, and similar molds with sub-millimeter features, and their use in manufacturing of PVA hydrogels and commercially available silicones could facilitate complex design and enabling capabilities in drug delivery systems, pharmaceuticals, tissue engineering, and related biomedical applications, amongst others.

### Example 8: Curable High Performance Compositions

Curable compositions with unique performance and processing capabilities suitable for use in advanced manufacturing processes, including additive manufacturing of ceramics, were made. The addition of low-viscosity polymeric binders to ceramic or other inorganic or organic powders can afford processable blends that harden after curing of polymeric binders. Low-viscosity, mechanically robust, curable compositions exhibit unique stability in comparison with analogous curable compositions in the class of thiol-ene polymers and exhibit UV cure kinetics sufficient for UV-based 3D printing techniques. These materials were shown to exhibit good mechanical integrity and good chemical resistance in the presence of pH 14 environments and organic solvent environments. The curable compositions and other analogous compositions described are suitable for use in applications including, but not limited, to SLA/DLP 3D printing processes, as binders for ceramic 3D printing techniques that may include burnout processes, and for corrosion or solvent-resistant coatings applications for oil and gas pipeline and other markets.

In the following example the abbreviations listed below denote 4-MP=4-Methoxyphenol, DPDM=Dipentene dimercaptan, Fe(III)Acac=Iron(III) acetylacetonate, OB+=2,2′-(2,5-Thiophenediyl)bis(5-tert-butylbenzoxazole), PE1=Pentaerythritol tetrakis (3-mercaptobutylate), PVCS=Pentavinylpentamethyl-cyclopentasiloxane, TAIC=Triallyl isocyanurate, TPO=Diphenyl(2,4,6-trimethylbenzoyl)phosphine oxide, TPO-819=Bis(2,4,6-trimethylbenzoyl)-phenylphosphineoxide, TVCS=Tetravinyltetramethylcyclotetrasiloxane, TVCZ=1,3,5-Trivinyl-1,3,5-trimethylcyclotrisilazane.

Preparation of Compositions XVI-XXIII

To prepare the Compositions discussed below, 6.14 g DPDM, 0.235 g TPO-819, 0.012 4-MP and 0.012 g OB+ were massed in an amber colored 40 mL glass vial, subjected to speed mixing at 3000 RPM for 3 min in a FLACKTEK™ DAC 150 speed mixer and heated at 80° C. with vortexing at 15 RPM for 20 min until all solids were dissolved/dispersed in DPDM. After cooling of dissolved DPDM/TPO-819/4-MP/OB+ mixture to 20° C., 5.376 g PVCS was then added, and resulting mixture was again subjected to speed mixing at 3000 RPM for 3 min in a FLACKTEK™ 150 speed mixer and stored at 20° C. in a dark environment until desired use.

Similar procedures were used to prepare Compositions XVI-XXIII, in that all solids in each composition were first dissolved in DPDM, after which vinyl siloxane or vinyl silazane constituents were added (“Prepared”). Chemical compositions for Compositions XVI-XXIII are provided in Table 4.

TABLE 4
UV curable thiol/vinyl siloxane and thiol/vinyl silazane compositions, time-dependent viscosity
assessments of uncured mixtures and thermomechanical descriptions of cured mixtures

| | | | Viscosity, | Viscosity, | Viscosity, |
|---|---|---|---|---|---|
| Composition | Description | Photoinitiator | t = 0 days | t = 1 day | t = 12 days |
| XVI | DPDM-co-PVCS | TPO | Low, not | Negligible, not | Negligible, not |
| | | | measured | measured | measured |
| XVII | DPDM-co-TAIC | TPO | Low, not | Negligible, not | Negligible, not |
| | | | measured | measured | measured |
| XVIII | DPDM-co-PVCS | TPO-819 | Low, not | Negligible, not | Negligible, not |
| | | | measured | measured | measured |
| XIX | DPDM-co-TAIC | TPO-819 | 15.2 cP | Negligible, not | Negligible, not |
| | | | | measured | measured |
| XX | DPDM-co-TVCZ | TPO | Low, not | High (est. 400), not | Solidified, not |
| | | | measured | measured | measured |
| XXI | DPDM-co-TVCS | TPO | 51.4 cP | 59.0 cP | Negligible, not |
| | | | | | measured |
| XXII | DPDM-co-TVS | TPO | 3.0 cP | Negligible, not | Negligible, not |
| | | | | measured | measured |
| XXIII | PE1-co-TAIC | TPO-819 | High (est. 400), | Negligible (est. 400), | Not measured |
| | | | not measured | not measured | |

| Composition | Description | Thermomechanical, Cured Film, 20° C. | Toughness, Cured Film, 20° C. |
|---|---|---|---|
| XVI | DPDM-co-PVCS | Viscoelastic to Glassy | High, Cuttable with Scissors |
| XVII | DPDM-co-TAIC | Glassy | High, Cuttable with Scissors |
| XVIII | DPDM-co-PVCS | Viscoelastic to Glassy | High, Cuttable with Scissors |
| XIX | DPDM-co-TAIC | Glassy | High, Cuttable with Scissors |
| XX | DPDM-co-TVCZ | Glassy | High, Cuttable with Scissors |
| XXI | DPDM-co-TVCS | Glassy | High, Cuttable with Scissors |
| XXII | DPDM-co-TVS | Glassy | High, Cuttable with Scissors |
| XXIII | PE1-co-TAIC | Glassy | High, Cuttable with Scissors |

Compositions: 1.00:1.00 C═C:SH stoichiometric ratio|2.00 wt % photoinitiator, 0.10% 4-MP, 0.10% OB+

Characterization of Compositions XVI-XXIII:

Time-Dependent Viscosity-Based Stability Assessments:

Viscosity of Prepared Compositions XVI-XXIII immediately after addition of vinyl siloxane or vinyl silazane constituents was assessed by visual inspection and determined to be “water-like,” in that, after hand shaking each 40 mL vial in which samples were contained (“Hand Shaking”), bubbles introduced to sample immediately rose to top of mixture and did not persist for more than 30 seconds. Changes in viscosity over time was assessed for samples stored at 20° C. in amber vials and were assessed at 1 day and 12 days. “Negligible” increases in viscosity were reported when after Hand Shaking, bubbles introduced to sample immediately rose to top of mixture and did not persist for more than 60 seconds. Other viscosity assessments were recorded as estimates of viscosity as determined by visual inspection after Hand Shaking. For example, for an estimated viscosity of 400 cP (est. 400 cP), bubbles remained throughout sample after Hand Shaking and did not rise to top of vial immediately after shaking. For a sample to be classified as solidified, no flow of sample was observed after inversion of sample for 60 s while in glass vials. Time-dependent viscosity assessments of Compositions XVI-XXIII are provided in Table 4 above.

Temperature-Dependent Viscosity Assessments:

Temperature dependence of viscosity was examined for Prepared Compositions XIX and XXI at 0 days. Experiments were conducted using a TA Instruments Discovery Hybrid Rheometer (DHR-2) with a 50 mm 1.0080 Peltier plate Steel cone. The large diameter 50 mm cone was chosen for higher torque as compared to smaller diameter cones. Prior to experimental runs, environmental temperature was set to 24° C., and gap was zeroed. Samples were loaded onto the bottom plate using a polypropylene pipette, and temperature was ramped from 24 to 80° C. at a ramp rate of 2.0° C./min. Shear rate was 6.28 s⁻¹, and sampling interval was 10.0 s/point. For Composition XIX, viscosity decreased with increasing temperature following a second order decay (R²=0.9971), with values ranging from 15.2 cP at 25° C. to 5.1 cP at 80° C. For Composition XXI, viscosity had a second order dependence on temperature (R²=0.9944), with values ranging from 51.4 cP at 25° C. to 18.2 cP at 80° C. The viscosities of some of Compositions XVI-XXIII are suitable for various 3D printing technologies referenced previously, including, but not limited to, SLA, DLP and inkjet printing at ambient temperatures.

Cure Kinetics and Penetration Depth Assessments:

Compositions XVI-XXIII were subjected to proprietary cure kinetics and UV penetration depth assessments to evaluate each composition for 3D printing using the SLA and DLP printers used to print Composition I in Example 1. Each Composition was found to exhibit “PASSING” cure kinetics and UV penetration depth under various UV energy settings. In comparison with the other compositions, Compositions XVI, XIX, XXI and XXII exhibited low tackiness at controlled penetration depths of 50 to 250 microns after subjection to UV energy doses needed to 3D print resins on the commercially available SLA and DLP printers utilized in Examples 1 and 2.

Preparation of Flood Cured Films:

0.4 mm and 1.1 mm thick films of Composition XVI-XXIII were cast immediately after preparation after by injecting mixture between RAIN-X® coated glass slides separated by 0.4 mm and 1.1 mm thick spacers (RAIN-X® facilitated delamination from glass). After injection between glass slides separated by spacers, Compositions XVI-XXIII were UV cured using a 12 W UV-LED source (including 405 nm) at 30% power for 4 total min (2 min on each side) (UV curing as described here is designated “Flood Curing.”) Flood Cured samples exhibited no odor after Flood Curing.

Thermomechanical and Toughness Assessments:

After preparation of 0.4 mm and 1.1 mm thick films of Compositions XVI-XXIII by flood curing, each sample was subjected to fast, qualitative thermomechanical and toughness assessments. For thermomechanical assessments, each sample was placed on a laboratory bench top at 20° C. and allowed to thermally equilibrate to 20° C. Each sample exhibited glassy or mostly glassy behavior at 20° C. when assessed qualitatively. Each sample was then picked up and rubbed vigorously between hands for 30 seconds. Samples that softened after exposure to 37° C. body temperatures were designated “Viscoelastic to Glassy,” and samples that did not soften after exposure to 37° C. body temperatures were designated “Glassy.” For toughness assessments, each sample was placed on a laboratory bench top at 20° C. and allowed to thermally equilibrate to 20° C. Each sample was then subjected to cutting by three different scissors products to assess each material's ability to dissipate energy while being cut without shattering. If a sample did not shatter during cutting, it was designated as having “High” toughness.

Dynamic mechanical analysis (DMA) was run in tension on 1 mm thick UV flood cured films of Compositions XIX and XXI. Samples of approximately 1.0×6.0×12.0 mm dimensions were subjected to DMA experiments at 1 using a TA Instruments Q800 DMA from approximately 20 to 120. Composition XIX exhibited a loss modulus peak at 62° C., a tan delta peak at 69° C. and storage modulus values of approximately 1990 MPa at 28° C., 1230 MPa at 60° C. and 7 MPa at 100° C. Composition XXI had a loss modulus peak at 47° C., a tan delta peak of 53° C., and storage modulus values that ranged from 1300 MPa at 28° C., to 706 MPa at 45° C., to 15 MPa at 80° C., to 16 MPa at 100° C.

Refractive Index Assessments:

Each sample containing vinyl siloxane and vinyl silazane constituents exhibited notably less yellowing and more pronounced optical clarity than samples comprised of non-vinyl siloxane or vinyl silazane alkene constituents.

DLP and SLA 3D Printing of Compositions XVI-XXIII:

Composition XVI was shown to exhibit excellent thermal stability and was subjected to 3D printing in SLA and DLP printers. Composition XVII exhibited suitable cure kinetics and adhesion/lack of adhesion to be printed, and 3D printed objects were made from Compositions XXI and XXII.

Post-Print Processing of Printed Objects Made from Compositions XVI-XXIII:

After printing of Compositions XVI, XXI and XXII into prototypes, prototypes were processed using a two-stage process involving “Cleaning” and “Post-Curing,” as described in Example 1, with isopropanol being a good solvent for washing (Cleaned and Post-Cured prototypes are referred to as “Processed” prototypes). Processed prototypes made from Composition XXI exhibited extremely tough material behavior and appeared to be well-suited for engineering polymer applications.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention. Such equivalents are intended to be encompassed by the following claims.

1. A curable formulation, the formulation comprising a reaction product of:
one or more electron-poor monomers;
optionally one or more electron-rich monomers;
one or more catalysts and/or accelerators; and
optionally one or more capping and/or chain transfer agents.

2. The curable formulation of claim 1, wherein the one or more electron-poor monomers are selected from the group consisting of maleimide, N-ethylmaleimide, N-methylmaleimide, N-phenylmaleimide, N-butanoic acid maleimide, other maleimides, maleic anhydride, dimethylmaleate, dimethylfumarate, 1,2-dicyanoethylene, vinylphosphonic acid, vinylsulfonic acid, and combinations thereof.

3. The curable formulation of claim 1, wherein the one or more electron-rich monomers are selected from the group consisting of N-vinylformamide, N-vinyl pyrrolidone, N-methyl-N-vinylacetamide, N-vinylacetamide, N-vinylcaprolactam, N-vinylpthalimide, N-vinylimidazole, butyl vinyl ether, 2,3-dihydrofuran, 3,4-Dihydro-2H-pyran, vinyl ethers, vinyl acetate, benzofuran, indole, 1-Methylindole, styrene, styrene derivitaves, 4-hydroxystyrene, stilbene, stilbene derivatives, hydroxylated stilbene compounds, 1-Pyrrolidino-1-cyclohexene, 1-Pyrrolidino-1-cyclopentene, 1-(Trimethyl silyloxy)cyclopentane, Vinylidene carbonate, 1-Morpholinocyclohexene, 1-Morpholinocyclopentene, 1-Pyrrolidino-1-cyclohexene, Phenyl vinyl sulfide, 9-Vinylcarbazole, Trimethyl(vinyloxy)silane, and combinations thereof.

4. The curable formulation of claim 1, wherein the one or more catalyst and/or accelerators are selected from the group consisting of aluminum(III) acetylacetonate, ammonium cobalt(II) sulfate hexahydrate, bis(acetylacetonato) dioxomolybdenum, cadmium acetylacetonate, cobalt(II) acetate tetrahydrate, cobalt(III) acetylacetonate, copper(II) acetylacetonate, iron(III) acetylacetonate, manganese(III) acetylacetonate, tetrabutyl orthotitanate, tetraethylammonium tetrachlorocobaltate, tetrabutylammonium dichromate, magnesium acetylacetonate dihydrate, zinc acetylacetonate hydrate, gallium acetylacetonate, titanium diisopropoxide bis(acetylacetonate), titanium(IV) isopropoxide, tributylborate, triethylborate, triethylphosphite, N-dodecyl-N,N-dimethyl-3-ammonium-1-propanesulfonate, 3-mercapto-1-propanesulfonic acid, sodium salt, 3-pyridinio-1-propanesulfonate, citric acid, triethylene diamine, piperazine, tetrabutylammonium hydrogensulfate, tetraethylammonium toluene sulfonate, tetrabutylammonium bromide, tetraethylammonium bromide, lithium acetylacetonate, lithium iodide, lithium perchlorate, lithium tetraphenylborate, and combinations thereof.

5. The curable formulation of claim 1, wherein the one or more capping and/or chain transfer agents are selected from the group consisting of isooctyl 3-mercaptopropionate, dodecyl 3-mercaptopropionate, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, monofunctional aliphatic linear thiols, monofunctional aliphatic branched thiols, 1,8-dimercapto-3,6-dioxaoctane, n-dodecyl mercaptan, n-octyl mercaptan, pentaerythritol tetrakis(3-mercaptobutylate), 1,4-bis (3-mercaptobutylyloxy) butane, 1,3,5-Tris(3-mercaptobutyloxethyl)-1,3,5-triazine-2,4,6(1H,3H,5H)-trione, tertiarydodecyl mercaptan, ethyl mercaptan, isopropyl mercaptan, dipentene dimercaptan, methyl mercaptan, n-propyl mercaptan, sec-butyl mercaptan, tert-nonyl mercaptan, tert-dodecyl mercaptan, tertiary mercaptan blends, tert-butyl mercaptan, grapefruit mercaptan, thioglycolic acid, thiolactic acid, 3-mercaptopropionic acid, ammonium thioglycolate, monoethanolamine thioglycolate, sodium thioglycolate, potassium thioglycolate, 2-ethylhexyl thioglycolate, isooctyl thioglycolate, iso-tridecyl thioglycolate, glyceryl thioglycolate, glyceryl dimercaptoacetate, pentaerythritol tetramercaptoacetate, butyl-3-mercaptopropionate, 2-ethylhexyl-3-mercaptopropionate, iso-tridecyl-3-mercaptopropionate, octadecyl 3-mercaptopropionate, ethoxylated trimethylolpropane tris(3-mercaptopropionate), monoethanolamine thiolactate, thiodiglycolic acid, diammonium dithioglycolate, di(2-ethylhexyl) thiodiglycolate, methylene bis(butylthioglycolate), thiodipropionic acid, dithiobis(stearylpropionate), thioglycerol, dithioglycerol, triphenylsilane, triethylsilane, triisopropylsilane, tributylsilane, triisobutylsilane, trioctylsilane, tert-butyldimethylsilane, tetrabromomethane, tetrachloromethane, bromotrichloromethane, bromotrifluoromethane, dichloromethane, chloroform, bromoform, iodoform, iodine, 1,1,2,2-tetrachloroethane, trichloroethylene, tetrachloroethylene, trichlorotrifluoroethane, hexachloroethane, chlorocyclohexane, chlorocyclopentane, butylchloride, 1,4-dichlorobutane, toluene, diphenylmethane, diphenylmethanol, bis(diphenylmethyl) ether, diphenylmethyl benzoate, 1,1-diphenylacetone, 2,2-diphenylethanol, diphenylacetic acid, triphenylmethane, 9,10-dihydroanthracene, xanthene, fluorene, fluorene-9-carboxylic acid, 9-phenyl-9-H-fluorene, and combinations thereof.

6. The curable formulation of claim 1, wherein the curable formulation further comprises acryl-based co-monomers selected from the group consisting of acrylic acid, methacrylic acid, 2-carboxyethylacrylate, 2-hydroxyethylacrylate, 2-hydroxyethyl methacrylate, acrylamide, dimethylacrylamide, 2-hydroxyethyl acrylamide, 2-acrylamido-2-methyl-1-propanesulfonic acid, diacetone acrylamide, N-[3-(dimethylamino) propyl]methacrylamide, N-(isobutoxymethyl)acrylamide, N-(3-methoxypropyl)acrylamide, N-(3-ethoxypropyl)acrylamide, N-(3-ethoxypropyl)acrylamide, tetrahydrofuryl acrylate, 2-[[(butylamino)carbonyl]oxy]ethyl acrylate, poly(propylene glycol) acrylate, poly(ethylene glycol) methyl ether acrylate, 2-carboxyethyl acrylate oligomers, hydroxypropyl acrylate, 4-acryloylmorpholine, 3-sulfopropyl acrylate potassium salt, methoxymethyl acrylamide, methoxyethyl acrylamide, methoxybutyl acrylamide, ethoxyethyl acrylamide, ethoxymethyl acrylamide, ethoxypropyl acrylamide, propoxymethyl acrylamide, propoxyethyl acrylamide, diethyl acrylamide, dimethyl acrylamide, alkyl acrylamides, tert-butyl acrylamide, neopentyl glycol diacrylate, glycerol diacrylate, glycerol triacrylate, ethylene glycol diacrylate, tetraethylene glycol diacrylate, trimethylolpropane triacrylate, tris[2-(acryloyloxy)ethyl]isocyanurate, pentaerithritol tetraacrylate, pentaerithritol triacrylate, ethoxylated trimethylolpropane triacrylate, ethyoxylated pentaerithritol triacrylate, ethoxylated pentaerithritol tetraacrylate, poly(dimethylsiloxane) diacrylate, poly(isoprene) diacrylate, poly(butadiene-co-nitrile) diacrylate, polyethyleneglycol diacrylate, tricyclodecantedimethanol diacrylate, bisphenol A diacrylate, ethoxylated bisphenol A diacrylate, and combinations thereof.

7. The curable formulation of claim 1, wherein the curable formulation further comprises 0.01 to 10 wt % of a photoinitiator, 0.01 to 1.0% a free radical inhibitor, or combinations thereof.

8. A curable formulation, the formulation comprising a reaction product of
one or more ionic/salt containing monomers;
one or more monomers capable of forming solvent soluble or solvent degradable polymers;
optionally one or more catalysts and/or accelerators; and
optionally one or more capping and/or chain transfer agents.

9. The curable formulation of claim 8, wherein the one or more ionic/salt containing monomers are selected from the group consisting of sodium acrylate, sodium methacrylate, and its hemihydrate, potassium acrylate, potassium methacrylate and its hemihydrate, silver (I) methacrylate, lithium acrylate, lithium methacrylate, 3-sulfopropyl acrylate potassium salt, [2-(acryloyloxy) ethyl]trimethylammonium chloride, 2-acrylamido-2-methyl-1-propanesulfonic acid sodium salt, and 3-acrylamidopropyl trimethylammonium chloride, nickel(II) acrylate, hafnium(IV) acrylate, zinc(II) acrylate, zirconium(IV) carboxyethyl acrylate, zirconium(IV) acrylate, zirconium(IV) methacrylate, copper(II) acrylate, barium(II) acrylate, aluminum(III) acrylate, iron(III) acrylate, strontium(II) acrylate hydrate, magnesium(II) acrylate, calcium(II) acrylate, hafnium(IV) carboxyethyl acrylate, zirconium bromonorbornanelactone carboxylate triacrylate, zirconium methacrylate, zinc(II) methacrylate, zirconium(IV) oxo hydroxy methacrylate, lead(II) methacrylate, calcium methacrylate, neodymium methacrylate trihydrate, barium methacrylate, copper(II) methacrylate, copper(II) methacrylate monohydrate, europium(III) methacrylate, yttrium(III) methacrylate, iron(III) methacrylate, chromium(III) dichloride hydroxide-methacrylic acid aqua complex, magnesium methacrylate, copper(II) methacryloxyethylacetoacetonate, aluminum(III) methacrylate, and combinations thereof.

10. A curable formulation of claim 8, wherein the one or more monomers capable of forming solvent soluble or solvent degradable polymers are selected from the group consisting of acrylic acid, methacrylic acid, itaconic acid, itaconic anhydride, citraconic anhydride, maleic acid, fumaric acid, maleic anhydride, 1,2,3,6-Tetrahydrophthalic anhydride, 2-carboxyethylacrylate, 2-hydroxyethyl acrylate, 2-hydroxyethyl methacrylate, acrylamide, dimethylacrylamide, 2-hydroxyethyl acrylamide, 2-hydroxypropyl acrylamide, 2-hydroxypropyl methacrylamide, 2-acrylamido-2-methyl-1-propanesulfonic acid, diacetone acrylamide, 2-(methacryloyloxy)ethyl acetoacetate, mono-2-(acryloyloxy)ethyl succinate, mono-2-(methacryloyloxy)ethyl succinate, N-[3-(dimethylamino) propyl]acrylamide, 2-(dimethylamino)ethyl acrylate, N-[3-(dimethylamino)propyl]methacrylamide, N-(butoxymethyl)acrylamide, N-(isobutoxymethyl)acrylamide, N-(3-methoxypropyl)acrylamide, N-(3-ethoxypropyl)acrylamide, 2-(diethylamino)ethyl acrylate, hydroxy propyl acrylate, hydroxypropyl methacrylate, 2-hydroxy-3-phenoxypropyl acrylate, ethylene glycol phenyl ether acrylate, di(ethylene glycol) ethyl ether acrylate, di(ethylene glycol) 2-ethylhexyl ether acrylate, tetrahydrofurfuryl acrylate, 2-[[(butylamino)carbonyl]oxy]ethyl acrylate, poly(propylene glycol) acrylate, poly(ethylene glycol) methyl ether acrylate, dodecyl acrylate, 2-carboxyethyl acrylate oligomers, hydroxypropyl acrylate, 2-ethylhexyl acrylate, isobornyl acrylate, N-isopropylacrylamide, N-vinylformamide, N-vinyl pyrrolidone, N-methyl-N-vinylacetamide, N-vinylacetamide, 4-vinylpyridine, 4-acryloylmorpholine, N-vinylcaprolactam, N-vinylpthalimide, N-vinylimidazole, 3-sulfopropyl acrylate potassium salt, methoxymethyl acrylamide, methoxyethyl acrylamide, methoxybutyl acrylamide, ethoxyethyl acrylamide, ethoxymethyl acrylamide, ethoxypropyl acrylamide, propoxymethyl acrylamide, propoxyethyl acrylamide, N,N-diethyl acrylamide, dimethyl acrylamide, alkyl acrylamides, tert-butyl acrylamide, 2-(methacryloyloxy)ethyl acetoacetate, di(ethylene glycol) methyl ether methacrylate, 2-N-morpholinoethyl methacrylate, cyclohexyl methacrylate, ureido methacrylate, N-succinimidyl methacrylate, butyl methacrylate, isobutyl methacrylate, tert-butyl methacrylate, sec-butyl methacrylate, 2-(tert-butylamino)ethyl methacrylate, 2-(diethylamino)ethyl methacrylate, ethylene glycol methyl ether methacrylate and triethylene glycol methyl ether methacrylate, monomers derived from the reaction of hydroxylated acrylates or methacrylates with organic anhydrides, and combinations thereof.

11. The curable formulation of claim 8, wherein the one or more catalyst and/or accelerators are selected from the group consisting of aluminum(III) acetylacetonate, ammonium cobalt(II) sulfate hexahydrate, bis(acetylacetonato) dioxomolybdenum, cadmium acetylacetonate, cobalt(II) acetate tetrahydrate, cobalt(III) acetylacetonate, copper(II) acetylacetonate, iron(III) acetylacetonate, manganese(III) acetylacetonate, tetrabutyl orthotitanate, tetraethylammonium tetrachlorocobaltate, tetrabutylammonium dichromate, magnesium acetylacetonate dihydrate, zinc acetylacetonate hydrate, gallium acetylacetonate, titanium diisopropoxide bis(acetylacetonate), titanium(IV) isopropoxide, tributylborate, triethylborate, triethylphosphite, N-dodecyl-N,N-dimethyl-3-ammonium-1-propanesulfonate, 3-mercapto-1-propanesulfonic acid, sodium salt, 3-pyridinio-1-propanesulfonate, citric acid, triethylene diamine, piperazine, tetrabutylammonium hydrogensulfate, tetraethylammonium toluene sulfonate, tetrabutylammonium bromide, tetraethylammonium bromide, lithium acetylacetonate, lithium iodide, lithium perchlorate, lithium tetraphenylborate, and combinations thereof.

12. The curable formulation claim 8, wherein the one or more capping or chain transfer agents are selected from the group consisting of isooctyl 3-mercaptopropionate, dodecyl 3-mercaptopropionate, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, monofunctional aliphatic linear thiols, monofunctional aliphatic branched thiols, 1,8-dimercapto-3,6-dioxaoctane, n-dodecyl mercaptan, n-octyl mercaptan, pentaerythritol tetrakis(3-mercaptobutylate), 1,4-bis (3-mercaptobutylyloxy) butane, 1,3,5-Tris(3-mercaptobutyloxethyl)-1,3,5-triazine-2,4,6(1H,3H,5H)-trione, tertiarydodecyl mercaptan, ethyl mercaptan, isopropyl mercaptan, dipentene dimercaptan, methyl mercaptan, n-propyl mercaptan, sec-butyl mercaptan, tert-nonyl mercaptan, tert-dodecyl mercaptan, tertiary mercaptan blends, tert-butyl mercaptan, grapefruit mercaptan, thioglycolic acid, thiolactic acid, 3-mercaptopropionic acid, ammonium thioglycolate, monoethanolamine thioglycolate, sodium thioglycolate, potassium thioglycolate, 2-ethylhexyl thioglycolate, isooctyl thioglycolate, iso-tridecyl thioglycolate, glyceryl thioglycolate, glyceryl dimercaptoacetate, pentaerythritol tetramercaptoacetate, butyl-3-mercaptopropionate, 2-ethylhexyl-3-mercaptopropionate, iso-tridecyl-3-mercaptopropionate, octadecyl 3-mercaptopropionate, ethoxylated trimethylolpropane tris(3-mercaptopropionate), monoethanolamine thiolactate, thiodiglycolic acid, diammonium dithioglycolate, di(2-ethylhexyl) thiodiglycolate, methylene bis(butylthioglycolate), thiodipropionic acid, dithiobis(stearylpropionate), thioglycerol, dithioglycerol, triphenylsilane, triethylsilane, triisopropylsilane, tributylsilane, triisobutylsilane, trioctylsilane, tert-butyldimethylsilane, tetrabromomethane, tetrachloromethane, bromotrichloromethane, bromotrifluoromethane, dichloromethane, chloroform, bromoform, iodoform, iodine, 1,1,2,2-tetrachloroethane, trichloroethylene, tetrachloroethylene, trichlorotrifluoroethane, hexachloroethane, chlorocyclohexane, chlorocyclopentane, butylchloride, 1,4-dichlorobutane, toluene, diphenylmethane, diphenylmethanol, bis(diphenylmethyl) ether, diphenylmethyl benzoate, 1,1-diphenylacetone, 2,2-diphenylethanol, diphenylacetic acid, triphenylmethane, 9,10-dihydroanthracene, xanthene, fluorene, fluorene-9-carboxylic acid, 9-phenyl-9-H-fluorene, and combinations thereof.

13. A curable formulation, the formulation comprising a reaction product of:
one or more alkene monomers;
one or more polythiol monomers; and
one or more capping and/or chain transfer agents;
wherein the one or more alkene monomers, the one or more polythiol monomers,
or both comprise solvent soluble or solvent degradable anhydride linkages.

14. The curable formulation of claim 13, wherein the one or more alkene monomers are crotonic anhydride, methacrylic anhydride, or a combination thereof.

15. The curable formulation of claim 13, wherein the one or more polythiol monomers selected from the group consisting of linalool dimercaptan, terpinolene dimercaptan, terpinene dimercaptan, geraniol dimercapan, citral dimercaptan, dicyclopentadiene dimercaptan, norbornadiene dimercaptan, retinol dimercaptan, retinol trimercaptan, retinol tetramercaptan, beta-carotene polymercaptans, mercaptan-containing cyclic alkenes, tertiary mercaptans, cycloaliphatic mercaptans, polyfunctional tertiary mercaptans, mixed secondary and tertiary mercaptans, mercaptan-containing secondary cycloaliphatic alkenes, mercaptan containing polycyclic alkenes, trivinylcyclohexene dimercaptan, trivinylcyclohexene trimercaptan, polymercaptans, cycloaliphatic mercaptans, vinylcyclohexene dimercaptan, triallylisocyanurate dimercaptan, triallyl isocyanurate trimercaptan, dipentene dimercaptan, 1,5-cyclooctadiene dimercaptan, cyclooctyl, cycodecyl-, and cyclooctadodecyl polymercaptans, phenylhepta-1,3,5-triyne polymercaptans, 2-butyne-1,4-diol dimercaptan, propargyl alcohol dimercaptan, dipropargyl sulfide polymercaptans, dipropargyl ether polymercaptans, propargylamine dimercaptan, dipropargylamine polymercaptans, tripropargylamine polymercaptans, tripropargyl isocyanurate polymercaptans, tripropargyl cyanurate polymercaptans, arachidonic acid dimercaptan, arachidonic acid trimercaptan, arachidonic acid tetramercaptan, eleostearic acid dimercaptan, eleostearic acid trimercaptan, linoleic acid dimercaptan, linolenic acid dimercaptan, linolenic acid trimercaptan, mercaptanized linseed oil, mercaptanized tung oil, mercaptanized soybean oil, mercaptanized peanut oil, mercaptanized walnut oil, mercaptanized avocado oil, mercaptanized sunflower oil, mercaptanized corn oil, mercaptanized cottonseed oil, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, Pentaerythritol tetrakis(3-mercaptobutylate), 1,4-bis (3-mercaptobutylyloxy) butane, 1,3,5-Tris(3-mercaptobutyloxethyl)-1,3,5-triazine-2,4,6(1H,3H,5H)-trione, ethylene glycol bis(3-mercaptoethyl ether), poly(ethylene glycol) dithiols, and combinations thereof.

16. The curable formulation of claim 13, wherein the one or more capping and/or chain transfer agents are selected from the group consisting of isooctyl 3-mercaptopropionate, dodecyl 3-mercaptopropionate, trimethylolpropane tris(3-mercaptopropionate), pentaerithritol tetrakis(3-mercaptopropionate), dipentaerithritol hexakis(3-mercaptopropionate), tris[2-(3-mercaptopropionyloxy)ethyl]isocyanurate, tetraethylene glycol bis(3-mercaptopropionate), 1,10-decanedithiol, ethylene glycol bis(3-mercaptopropionate), 1,2-ethanedithiol, 1,3-propanedithiol, 1,4-butanedithiol, 1,6-hexanedithiol, 1,8-octanedithiol, 2-mercaptoethanol, monofunctional aliphatic linear thiols, monofunctional aliphatic branched thiols, 1,8-dimercapto-3,6-dioxaoctane, n-dodecyl mercaptan, n-octyl mercaptan, pentaerythritol tetrakis(3-mercaptobutylate), 1,4-bis (3-mercaptobutylyloxy) butane, 1,3,5-Tris(3-mercaptobutyloxethyl)-1,3,5-triazine-2,4,6(1H,3H,5H)-trione, tertiarydodecyl mercaptan, ethyl mercaptan, isopropyl mercaptan, dipentene dimercaptan, methyl mercaptan, n-propyl mercaptan, sec-butyl mercaptan, tert-nonyl mercaptan, tert-dodecyl mercaptan, tertiary mercaptan blends, tert-butyl mercaptan, grapefruit mercaptan, thioglycolic acid, thiolactic acid, 3-mercaptopropionic acid, ammonium thioglycolate, monoethanolamine thioglycolate, sodium thioglycolate, potassium thioglycolate, 2-ethylhexyl thioglycolate, isooctyl thioglycolate, iso-tridecyl thioglycolate, glyceryl thioglycolate, glyceryl dimercaptoacetate, pentaerythritol tetramercaptoacetate, butyl-3-mercaptopropionate, 2-ethylhexyl-3-mercaptopropionate, iso-tridecyl-3-mercaptopropionate, octadecyl 3-mercaptopropionate, ethoxylated trimethylolpropane tris(3-mercaptopropionate), monoethanolamine thiolactate, thiodiglycolic acid, diammonium dithioglycolate, di(2-ethylhexyl) thiodiglycolate, methylene bis(butylthioglycolate), thiodipropionic acid, dithiobis(stearylpropionate), thioglycerol, dithioglycerol, triphenylsilane, triethylsilane, triisopropylsilane, tributylsilane, triisobutylsilane, trioctylsilane, tert-butyldimethylsilane, tetrabromomethane, tetrachloromethane, bromotrichloromethane, bromotrifluoromethane, dichloromethane, chloroform, bromoform, iodoform, iodine, 1,1,2,2-tetrachloroethane, trichloroethylene, tetrachloroethylene, trichlorotrifluoroethane, hexachloroethane, chlorocyclohexane, chlorocyclopentane, butylchloride, 1,4-dichlorobutane, toluene, diphenylmethane, diphenylmethanol, bis(diphenylmethyl) ether, diphenylmethyl benzoate, 1,1-diphenylacetone, 2,2-diphenylethanol, diphenylacetic acid, triphenylmethane, 9,10-dihydroanthracene, xanthene, fluorene, fluorene-9-carboxylic acid, 9-phenyl-9-H-fluorene, and combinations thereof.

17. The curable formulation of claim 1, wherein the curable formulation is cured.

18. The curable formulation of claim 1, wherein the curable formulation has been cured by ultraviolet light.

19. The curable formulation of claim 1, wherein the curable formulation has been cured and wherein the cured formulation is water degradable, water soluble, water degradable and water soluble, solvent degradable, solvent soluble or solvent degradable and solvent soluble.

20. (canceled)

21. A method of printing a curable formulation, the method comprising the steps of:
(a) printing a curable formulation of claim 1; and
(b) curing the printed curable formulation;
wherein the curing step can be performed during the printing of the curable formulation of step (a) to at least partially cure the curable formulation.

22.-26. (canceled)

27. The method of claim 21, wherein the printing step is performed by a stereolithographic additive printing, a digital light processing/projection printing, an inkjet printing, a photojet printing, or a direct write process.

28. The method of claim 21, wherein the curing step includes exposure of the curable formulation to ultraviolet light and/or heat.

29.-42. (canceled)
